(19) United States
(12) Patent Application Publication
(10) Pub. No.: US 2006/0290691 A1
(43) Pub. Date: Dec. 28, 2006

(54) Display device and information display system

(75) Inventors: Osamu Sato, Shinjuku-ku (JP); Kaoru Ota, Shinjuku-ku (JP); Masayuki Iwasaki, Shinjuku-ku (JP); Masaki Kuge, Shinjuku-ku (JP); Satoshi Niiyama, Chiyoda-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 11/441,127

(22) Filed: May 26, 2006

(30) Foreign Application Priority Data
May 27, 2005 (JP) 2005-156285

(51) Int. Cl. G09G 5/00

(52) U.S. Cl. 345/211

(57) ABSTRACT

There is provided a display device, which is capable of easily changing display information and of reducing power consumption.

The control system of the display device is divided into a power supply control system, a main control system and a liquid crystal display panel driving system. When a main power switch 192 is turned on, only a sub-control circuit 170 as the power supply control system is supplied with power in a normal state. When an event relating to control of the display device 80 occurs, a power supply circuit 172 is set in an energized state to supply power to the main control system, setting the main control system in an active state. When the event relating to control of the display device 80 is accompanied by rewriting of display on a liquid crystal display panel, a liquid crystal power supply circuit 193 is set in an energized state to supply power to the liquid crystal display panel driving system.

### BACKGROUND OF THE INVENTION

1. Field of the Invention

The present invention relates to a display device and an information display system, which are capable of displaying information thereon to provide many people with information, in particular, a display device and an information display system, which are capable of easily changing displayed information.

2. Discussion of Background

An example of information media, which are capable of providing many people with information, is a timetable at a station of a railroad company. FIG. 17 is a schematic view showing an example of a timetable put in a station of a railroad company. In general, such a timetable shows, in a limited display area, many kinds of information, such as differences in departure times depending on days in one week, and differences in destinations, in addition to the departure times of all trains in one day. Such a timetable includes different figures or symbols, depending on railroad lines or stations, in many cases. For this reason, it is difficult for passengers to find out the departure time of a desired train in many cases.

Stations of transportation, such as railroads, have provided passengers with time display showing when a passenger can get on a train at the current station in order to reach his or her destination. An example of such time display is a timetable for last trains. However, the methods for displaying the last trains have not been unified among railroad companies, which is difficult for passengers to read such a timetable for last trains.

The departure time for a last train is changed because of the occurrence of an accident or another reason in some cases. In general, the information medium for time display comprises a printed medium, such as a sheet or resin plate with information printed thereon. In other words, it is difficult to promptly cope with a temporary change in the timetable for a last train. It is not easy to change information, depending on a change in the departure times because of a train delay, with respect to not only a temporary change in the timetable for a last train but also a change in the departure times.

When the information medium comprises a printed medium, it is necessary to rewrite portions to change a timetable containing a wide variety of information, in order to change the timetable. In some cases, when such a timetable is changed, a white strip of paper, which has an adhesive agent coated on the rear surface and changed information described on the front surface, is partially stuck on the timetable to cope with a change in the timetable.

There has been proposed a timetable for last trains, wherein a route map is combined with a timetable for last trains to make it easy for passengers to visually recognize required information (e.g., see Patent Document 1). There has also been proposed a timetable display system, which is configured so that timetables for last trains for different stations to get off, with times required for transfer of trains contained therein, and information required for a station yard or a platform can be timely displayed (e.g., see Patent Document 2).

There has also been proposed a service utilizing a cellular phone network and the Internet. For example, there has been proposed a service wherein on demand from an advertiser, an advertising agency substantially simultaneously transmits an e-mail advertisement to all registered members at the advertiser's desired timing via the Internet. By utilizing a connection service named PacketOne or the SMS network boot service provided by KDDI CORPORATION, equipment with a communication module incorporated therein can be operated in a certain range from a remote location (e.g., see Non-Patent Document 1).

Patent Document 1: JP-A-11-249561

Patent Document 2: JP-A-7-302283

Non-Patent Document 1: NIKKEI ELECTRONICS, NikkeiBusiness Publications Inc., issued Aug. 4, 2003, No. 853, Pages 100 to 103

### SUMMARY OF THE INVENTION

As described above, it is difficult to utilize prior art to promptly provide information. More specifically, when the information medium comprises a printed medium, it takes much time to inform passengers of a change in information since it is necessary to manually rewrite a portion of the information or to stick a strip of paper with changed information printed thereon, in order to change the information. The cost required for a change in the information is high since the change is manually made.

The system disclosed in Patent Document 2 is configured so that a host computer is installed to collectively control the departure times of the trains at stations and to distribute information, such as a changed timetable, from the host computer to terminal devices put at the respective stations. Although such a structure can be fully utilized in a closed environment, such as one railroad company, it is difficult to promptly distribute information over a plurality of railroad companies. Even if a single host computer is installed to distribute information over a plurality of railroad companies, it is difficult to promptly deal with a change since it is necessary to collect information on a change from individual railroad companies when the timetables at the stations in the respective railroad companies are temporality changed because of the occurrence of, e.g., an earthquake.

In the system disclosed in Patent Document 2, the terminal devices need to be constantly supplied with power in order that passengers can make use of the terminal devices as display devices for displaying a timetable. As a result, the power consumption of the terminal devices increases. Additionally, the installation cost increases since it is necessary to install power supply equipment, such as power supply lines, in order to supply power to the respective terminal devices from a power source. Further, the installation cost is further increased since it is necessary to install a LAN, via which the terminal devices need to be connected to the host computer with timetable data stored therein.

It is an object of the present invention to provide a display device and an information display system, which are capable of easily changing displayed information, of decreasing the cost relating to a change in the information, the cost relating to system construction and the cost relating to operation, and of promptly changing the displayed information.

The present invention provides a display device comprising a power supply unit, a display panel having a memory effect, a driving circuit for driving the display panel, an interface unit for acquiring a command and a display data input from outside, a main control unit for activating the driving circuit based on the command and the display data acquired by the interface unit, and a power supply control unit for controlling power supply from the power supply unit to the driving circuit; wherein the power supply control unit (a) starts power supply from the power supply unit to the driving circuit when the driving circuit rewrites display information on the display panel, and (b) stops power supply from the power supply unit to the driving circuit after the display information on the display panel has been updated.

In one mode of the present invention, the power supply unit includes a secondary cell and a solar cell for charging the secondary cell.

In one mode of the present invention, the interface unit includes a local interface unit for reading out a data from a memory medium and a wireless communication interface unit for receiving the command and the display data via a wireless transmission channel.

In one mode of the present invention, the power supply control unit includes a timer circuit, which outputs a signal demanding to start power supply to the main control unit when reaching a preset time-up time or when receiving a start code by infrared light communication.

In one mode of the present invention, the display panel comprises a chiral nematic liquid crystal display panel.

In one mode of the present invention, the display data comprise a data relating to a timetable for transportation.

In one mode of the present invention, the display panel comprises plural display panels, which are connected to one another in series.

The present invention also provides a display device comprising a power supply unit, a display panel having a memory effect, a driving circuit for driving the display panel, a first wireless communication unit for performing communication of a command and a display data via a first wireless communication network, a second wireless communication unit for performing communication of a command and a display data via a second wireless communication network, a main power supply control unit for activating the driving circuit based on the command and the display data received by the first and/or second wireless communication unit, and a sub-power supply control unit for controlling power supply from the power supply unit to the respective units; wherein the sub-power supply control unit is constantly powered on and supplies power or stop power supply to the first and/or second wireless communication unit according to an operation mode.

In one mode of the present invention, the first wireless communication unit has a higher output than the second wireless communication unit.

In one mode of the present invention, the operation mode includes (a) a normal operation mode wherein the display panel, the driving circuit, the main power supply control unit, and the first and second wireless communication units are powered on; (b) a standby mode wherein the display panel, the driving circuit, the main power supply control unit, and the first wireless communication unit are powered off while the second wireless communication unit is powered on; and (c) a narrow area communication mode wherein the display panel, the driving circuit and the first wireless communication unit are powered off while the main power supply control circuit and the second wireless communication unit are powered on.

Further, the present invention provides an information display system comprising display devices defined above and an information distribution server for distributing a command and a display data to the display devices via the first wireless communication network; wherein a first display device can communicate with a second display device through the second wireless communication network to realize communication with the information distribution server through the second display device when being difficult to communicate with the information distribution server via the first wireless communication network.

### BRIEF DESCRIPTION OF THE DRAWINGS

FIG. 1 is a block diagram showing a typical example of the structure of an information display system;

FIG. 2 is a front view schematically showing a display device;

FIG. 3 is a partial cross-sectional view taken along line P-Q;

FIG. 4 is a schematic cross-sectional view of a liquid crystal display panel using CL-LCDs;

FIG. 5 is a block diagram showing a typical example of the functional structure of a server;

FIG. 6 is a block diagram showing a typical example of the structure of a distribution server;

FIG. 7 is a block diagram showing a typical example of the circuit configuration of the electric circuit blocks in a display device;

FIG. 8 is a flowchart showing an example of the operation of a sub-CPU;

FIG. 9 is a flowchart showing an example of the operation of a main control unit;

FIG. 10(A) and (B) are lists showing commands as examples;

FIG. 11 is a flowchart showing an example of the control corresponding to a command;

FIGS. 12(A) to (D) are schematic views showing an example of a Web page;

FIG. 13 is a schematic view showing Example 1;

FIG. 14 is a front view showing Example 2;

FIG. 15 is a cross-sectional view taken along line A-A′;

FIG. 16 is a cross-sectional view taken along line B-B′;

FIGS. 17(A) and (B) are schematic view showing an example of a departure timetable;

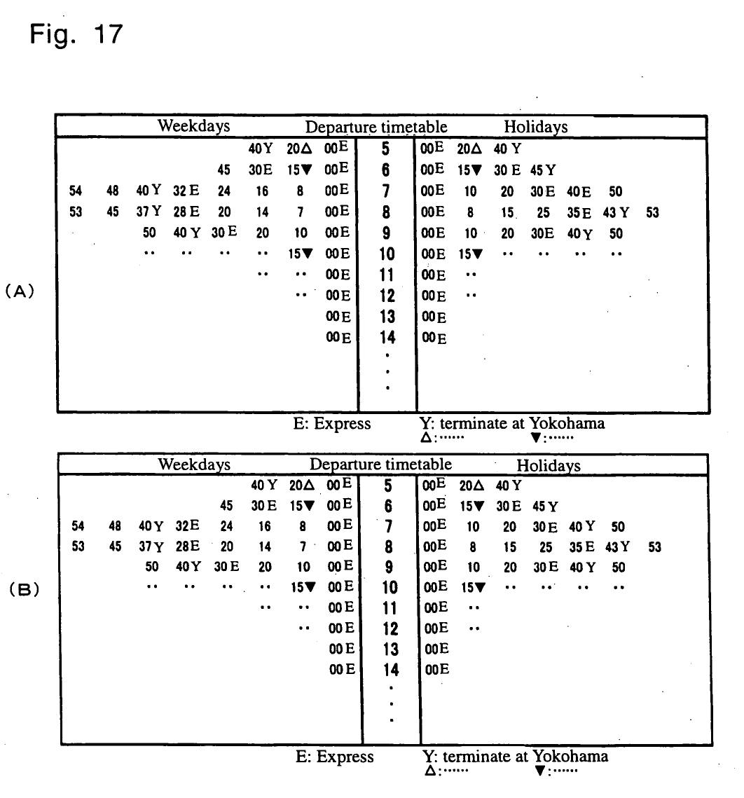

FIG. 18 is a block diagram showing an example of the structure of the information display system according to Example 3;

FIGS. 19(A) and (B) are a front view and a cross-sectional view taken along line C-C′, which schematically shows a display device;

FIG. 20 is a schematic cross-sectional view of a liquid crystal display panel using CL-LCDs;

FIG. 21 is a block diagram showing an example of the structure of an information distribution server;

FIG. 22 is a block diagram showing an example of the structure of a server in a cellular phone network;

FIG. 23 is a block diagram showing a display device in a normal operation mode;

FIG. 24 is a block diagram showing the display device in a standby mode;

FIG. 25 is a block diagram showing the display device in a narrow area communication mode;

FIG. 26 is a flowchart showing an example of the operation of a sub-CPU;

FIG. 27 is a flowchart showing an example of the operation of a main CPU;

FIGS. 28(A) and (B) are lists showing commands as examples;

FIG. 29 is a schematic view showing an example of the structure of the information display system according to Example 4;

FIG. 30 is a sequence diagram showing the operation 15 of the information display system according to Example 4;

FIG. 31 is an schematic view showing an example of the structure of the information display system according to Example 5; and

FIG. 32 is a sequence diagram showing the operation of the information display system according to Example 5.

### EXPLANATION OF REFERENCE NUMERALS

1A to 1H chiral nematic liquid crystal display panel

71, 80 and 81 display device

100 terminal unit

170 sub-control circuit

171 sub-CPU

171 power supply circuit

173 clock circuit

174 infrared light receiving circuit

182 PDC adapter

183 main control unit

187 voltage sensor

188 memory circuit

189 driving circuit

192 main power switch

193 liquid crystal power supply circuit

194 power switch for main control unit

195 USB interface

196 CF card interface

200 Internet

310 server

320 database

410 distribution server

600 base station

### DETAILED DESCRIPTION OF THE PREFERRED EMBODIMENTS

In accordance with the present invention, it is possible to realize a display device, which is capable of easily change displayed information, of deceasing the cost relating to a change in the information, the cost relating to system construction and the cost relating to operation, and of promptly changing the displayed information. It is also possible to realize a versatile system, which is capable of transmitting display data from a single display control server to many display devices.

In the present invention, it is possible to utilize a conventional communication technology, such as a wireless LAN or PHS. It is also possible to use, as the cellular phone, a cellular phone with a Ferica system mounted therein.

When a narrow band wireless communication unit, which is constantly supplied with power, is disposed to communicate with a separate information display device via a local communication system, it is possible to request, e.g., the display control server to inform the separate information display device, via narrow range wireless communication, that an unusual situation has occurred. It is also possible to promptly inform a control department of the occurrence of an unusual situation in a case wherein the unusual situation has occurred while the server is standby.

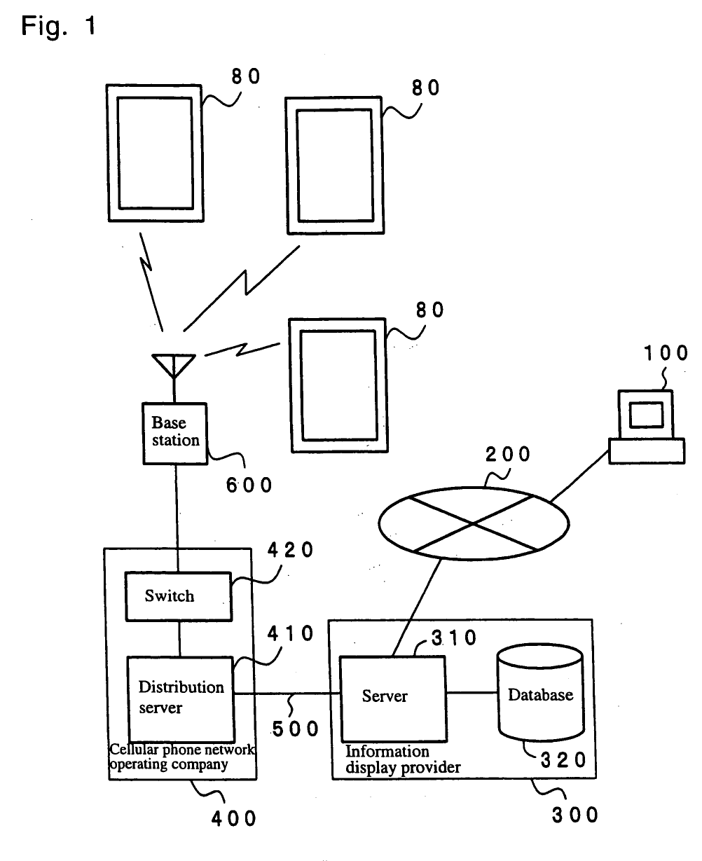

Now, an embodiment of the present invention will be described, referring to the accompanying drawings. FIG. 1 is a block diagram showing a typical example of the information display system according to the present invention. In the information display system shown in FIG. 1, a terminal unit 100, such as a personal computer, is connectable with a server 310 via the Internet 200 (first communication network) as a wide range of communication network, the server serving as a display control server installed in an information provider for display 300, a company working as an agent for the information provider or another company. FIG. 1 shows a case where the server 300 is installed in the information display provider 300.

The server 310 stores display data in a database 320 based on information transmitted from the terminal unit 100 and changes a display data stored in the database 320. The terminal unit 100 has a Web browser installed therein to browse a Web page. The terminal unit 100 is not limited to a personal computer. The terminal unit may comprise a PDA or a cellular phone. In the latter case, a user may access the server 310 via a telephone network instead of the Internet 200. In this case, a user may reset the timing for display change or make a decision to select a plurality of data for displayed information, which have been preliminarily prepared.

The server 310 is connectable, through a dedicated line 500, with a distribution server 410 as a distribution unit for transmitting a display data received from the server 310, to a display device via a wireless communication network (second communication network). The distribution server 410 is installed in a cellular phone network operating company 400, a company working as an agent for the cellular phone network operating company 400, or another company. FIG. 1 shows a case where the distribution server 410 is installed in the cellular phone network operating company 400.

The distribution server 410 is connected to a packet switch (hereinbelow, referred to as the switch) 420 in a digital public cellular phone network (in particular, a packet network). The switch transmits and receives data between itself and a base station 600 in the digital public cellular phone network. The distribution server 410 may be configured so as to be connected directly to the packet network, not through the switch 420. Although FIG. 1 shows only one base station 600, there are many base stations in the system. Although FIG. 1 shows only three display devices 80, more display devices may be disposed in the system. For example, in the case of a railroad company, 100 to 4,000 railroad stations are included in a single control area.

The database 320 stores data (display data) corresponding to the information currently displayed on the respective display devices so that the respective data are associated with the respective display devices. The display data in the database 320 may be of a bitmap format or a data compression format, such as JPEG or GIF. The display data may be of a file format, which is used by specific imaging application software. The system may be configured so that the database 320 stores only text data, the server 310 stores data written in a certain display format (such as titles or borders), and display data are prepared based on the text data stored in the database 320 and the data for display formats. Since display data are transmitted to the terminal unit 100, being contained in a Web page, on change request from the terminal unit 100, it is preferred that the database 320 stores display data in the HTML format or the XML format along with the display data written in any one of the above-mentioned data formats or only display data written in the HTML format or the XML format, instead of the display data written in any one of the above-mentioned data formats.

The server 310 and the distribution server 410 form a display control system, which prepares changed display data in response to a display information change command received from the terminal unit 100 and transmits the changed display data to the display devices 80 via the wireless communication network. Each of the display devices 80 has a PDC (Personal Data Cellular) adapter or a GSM (Global System for Mobile Communications) adapter incorporated therein so as to be communicable with the distribution server 410 through the base station 600 by wireless communication.

Now, explanation will be made in a case where each of the display devices 80 comprises a timetable display device installed at, e.g., a station of a railroad company to display a timetable. The railroad company may purchase the display devices 80 from the information display provider 300, rent the display devices from the information display provider 300 or rent the display devices from a third party, who has purchased the display devices from the information display provider 300. An example of the terminal unit 100 is a personal computer existing in the railroad company. Although explanation of this embodiment will be made about the timetable display devices, the information display system according to the present invention is not limited to the system having the purpose of displaying a timetable.

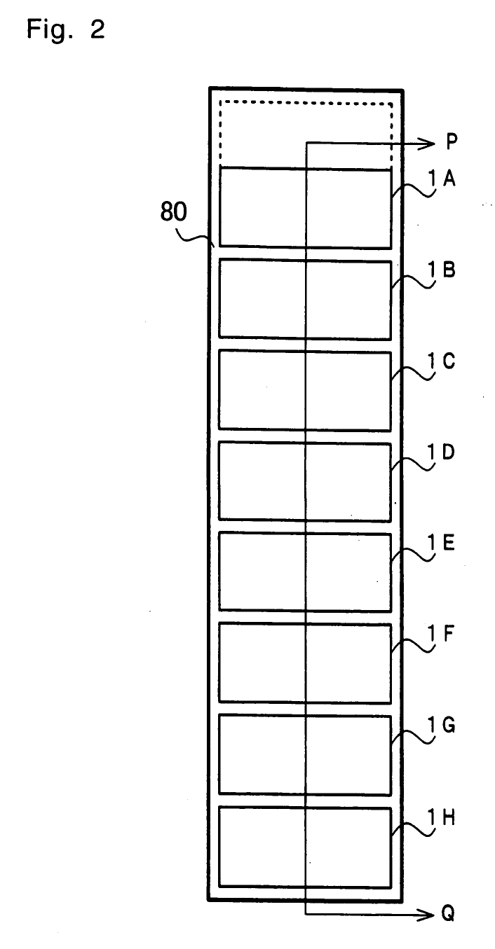

FIG. 2 is a front view schematically showing a display device 80. The display device 80 comprises a display panel having a memory effect. The memory effect is a property of being capable of holding display information with the driven voltage being set at substantially 0 V. An example of the display panel having a memory effect is a cholesteric or a chiral nematic liquid crystal display panel (hereinbelow, referred to also as CL-LCD). The display device 80 shown as an example in FIG. 2 includes eight chiral nematic liquid crystal display panels 1A, 1B, 1C, 1D, 1E, 1F, 1G and 1H (hereinbelow, referred to as the chiral nematic liquid crystal display panels 1A to 1H), which are connected in series with one another.

It should be noted that an example of the display panel having a memory effect other than a CL-LCD is an antiferroelectric liquid crystal display panel (hereinbelow, referred to as AF-LCD). When monochromatic display having about four gray scales is acceptable instead of color display, a microcapsule electrophoretic display panel may be utilized. However, it is preferred that the display device 80 comprise CL-LCDs, which can reduce power consumption and provide a multi-color image.

Each of the chiral nematic liquid crystal display panels 1A to 1H has dimensions of 440 mm in width and 68 mm length, for example. The chiral nematic liquid crystal display panels 1A to 1H are disposed so as to leave a spacing of about 25 mm between adjacent chiral nematic liquid crystal display panels. In one typical example, seven display panels among the eight chiral nematic liquid crystal display panels 1A to 1H show the departure times for the train for three hours. The remaining display panel is used to display advertisement. In order to display all timetables for the up trains on weekday, the down trains on weekday, the up trains on holiday and the down trains on holiday, four display devices, each of which comprises the display device 80 shown in FIG. 2, may be disposed so as to be adjacent one after another, or a pair of the display devices may be disposed so as to be adjacent to each on the front side while the other pair of display devices are disposed so as to be adjacent to each other on a rear side.

In this case, although a single wireless communication interface unit (such as a PDC module) is disposed in each of the display devices, it is preferred in terms of simplicity that the four display devices form one group with a single wireless communication interface unit disposed in the group.

In a display device 80, an information display area, where information is provided by, e.g., printing, may be disposed on a portion other than the portion for displaying the timetables as indicated by a dotted line in FIG. 2. Although the information display area is disposed on an upper portion of the display device 80 in FIG. 1, the information display area may be disposed in a different portion. In general, fixed information, such as information on the name of the railroad company or the station, information for advising passengers that the displayed information is the timetables, or advertising information, is displayed on the information display area.

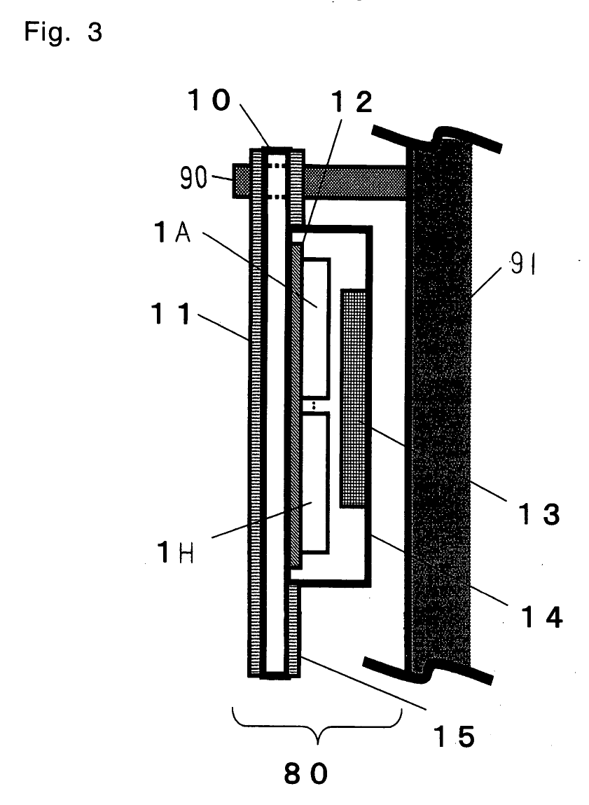

FIG. 3 is a partial cross-sectional view of the display device taken along line P-Q. In FIG. 3, only two chiral nematic liquid crystal display panels 1A and 1H among the chiral nematic liquid crystal display panels 1A to 1H are shown. In FIG. 3, a transparent resin layer 12 having a shock-absorption property is sandwiched between a front plate 10 made of, e.g., tempered glass and the chiral nematic liquid crystal display panels 1A and 1H. In this way, soft resin is disposed so as to prevent stress from being applied to the display screens of the display panels having a large size. The transparent resin layer 12 is disposed for the purpose of preventing a change from occurring in the display state of the chiral nematic liquid crystal display panels 1A to 1H even if a person applies a normal degree of strike to the front plate 10.

The chiral nematic liquid crystal display panels 1A and 1H have an electric circuit block 13 provided on a rear side to house an electronic circuit for driving the chiral nematic liquid crystal display panels 1A and 1H, a built-in power source and the like. The display panels have a casing 14 to be fixed so as to have close contact with the front plate 10 in order to protect these members. The casing 14 may have terminals for operation testing, power terminals for charging the built-in power source, a cover for maintenance and the like formed therein. In the structure shown in FIG. 3, the display device 80 is fixed to a wall surface 91 at two upper corners by threaded posts 90. Instead of being fixed to the wall surface 91, the display device 80 may be installed so as to be suspended from a ceiling or the like, or to be fitted into a recess formed on the wall surface or the like.

The front plate 10 has a transparent antireflection film 11 formed on the entire front side. It is preferred that the transparent film 11 comprise a transparent fluororesin film, such as a film commercially available under the name ARCTOP (trademark). The transparent film 11 also serves as a protective film. It is preferred that the front plate 10 have a translucent film 15, like frosted glass, put on an outer surrounding area of the casing (frame portion) on the rear side in order to prevent a passenger from seeing the rear portion of the front plate from the front side. Thus, a passenger who watches the screen area from the front side can visually recognize the display screen of the display device 80, easily and accurately understanding his or her desired information.

As the method for preparing the transparent resin layer 12, the technique that has been disclosed in US-A-2005-0083465 in the name of the applicants is applicable.

Specifically, the transparent resin layer 12 may be made of a transparent elastic resin. In order to restrain the stress applied to the chiral nematic liquid crystal display panels as much as possible, it is preferred that the transparent resin layer 12 be made of a material having a low elastic modulus. The transparent resin having a low elastic modulus has a glass transition temperature of preferably 0° C. or below, more preferably −20° C. or below. The tensile elasticity at a temperature that the display panels are normally used (25° C.) is preferably 100 MPa or below, or preferably 10 MPa or below. In particular, the tensile elasticity is more preferably 1 MPa or below.

Examples of the material for the transparent elastic resin include silicone, acryl and urethane. One of preferred materials for the transparent elastic resin is a silicone resin. A preferred example of the silicone resin is a two-component thermosetting silicone “SE1740 (A/B)” manufactured by Dow Corning Toray Silicone Co., Ltd. Although it is preferred to use a resin having a crosslinked molecular structure in terms of property stability at a high temperature, it is acceptable to use a slightly mobile transparent resin in a gel state. Additionally, a particularly preferred material for the transparent resin layer 12 is a transparent resin in a gel state. The resin in a gel state is significantly good at stress absorption in comparison with a hard elastic resin, such as a resin in a rubber state. For example, a residual stress, which is applied to the chiral nematic liquid crystal display panels 1A to 1H by a difference in thermal expansion created by a heat cycle test, or a stress, which is caused by deformation of the front plate 10 created by fixing the front plate 10 to the wall surface 91 with jigs, can be effectively absorbed to effectively restrain the occurrence of chrominance non-uniformity in the chiral nematic liquid crystal display panels 1A to 1H.

When using a transparent resin in a gel state, the consistency of the transparent resin layer 12 made of a transparent resin in a gel state is set at an adequate value in order to effectively fix the front plate 10 to the chiral nematic liquid crystal display panels 1A to 1H. In particular, in determination of the consistency of the transparent resin layer 12 made of a transparent resin in a gel state, it is important to consider the suppression of a stress applied to the chiral nematic liquid crystal display panels 1A to 1H or positional shift of the chiral nematic liquid crystal display panels. In order to restrain the stress applied to the chiral nematic liquid crystal display panels 1A to 1H as much as possible, it is preferred to set the consistency at a greater value. However, when the consistency is too great, the positional shift of a display panel occurs since the chiral nematic liquid crystal display panels 1A to 1H cannot be held appropriately. From this point of view, it is preferred that the transparent resin layer 12 made of a transparent resin in a gel state have a ¼ consistency of from 5 to 800 (JIS K2220). It is more preferred that the transparent resin layer have a ¼ consistency of from 10 to 500 (JIS K2220). Examples of the material for the transparent resin layer 12 made of a transparent resin in a gel state 250 include silicone, acryl and urethane. From the viewpoint of restraining the occurrence of bubbles in a fabricating process, it is preferred to use a silicone resin, which is a material having a small surface tension. A preferred example of the silicone resin in a gel state is a two-component curable silicone, which has a gel state after being cured. Since the cured resin layer is formed in a closed space, it is preferred to use a two-component curable silicone containing no volatile solvent instead of a one-component curable resin containing a volatile solvent. For example, it is possible to form the transparent resin layer 12 by using a two-component thermosetting silicone “SE1885 (A/B)” manufactured by Dow Corning Toray Silicone Co., Ltd.

A CL-LCD is driven, having a phase transition mode. The phase transition mode means that a display device is stable in at least two phases of a planar state wherein incident light is partly selectively reflected (hereinbelow, referred to as the PL state) and a focal conic state wherein incident light is scattered (hereinbelow, referred to as the FC state), and that a liquid crystal can be selectively transformed into the PL state or the FC state by applying a certain voltage across opposite electrodes.

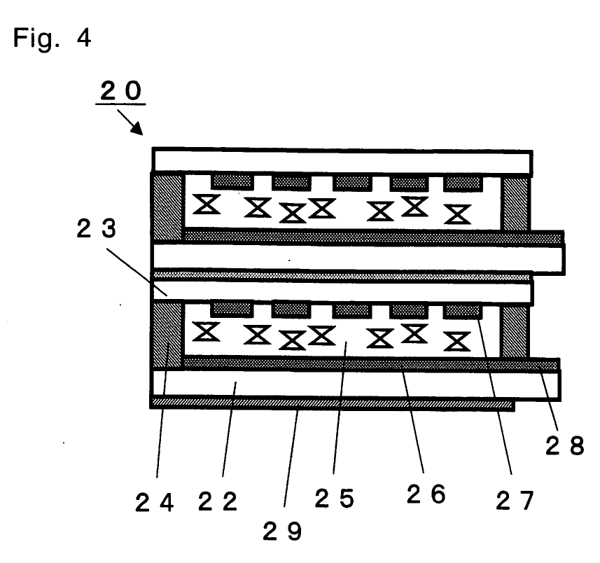

FIG. 4 is a schematic cross-sectional view of a liquid crystal display panel 20 which comprises two layers of CL-LCDs laminated therein. The liquid crystal display panel 20 is an example of each of the chiral nematic liquid crystal display panels 1A to 1H shown in FIG. 2. In order to drive a CL-LCD, it is usual to use passive matrix addressing. A first substrate 22 with row electrodes 26 formed thereon and a second substrate 23 with column electrodes 27 confront each other so that the electrode surfaces on one of the substrates orthogonally overpass the electrode surfaces on the other substrate. The first substrate 22 and the second substrate 23 are press-bonded together through a peripheral seal 24 to form a cell gap therebetween. The cell gap has a chiral nematic liquid crystal layer 25 injected therein.

The second substrate 23 has a group of lead electrode 28 disposed thereon. Although the column electrodes 27 on the second substrate 23 are directly connected to respective related electrodes in the group of lead electrodes 28, the row electrodes 26 on the first substrate 22 are connected to respective related electrodes in the group of lead electrodes 28 through transfer materials, such as conductive beads, contained in the peripheral seal 24. The group of lead electrodes 28 may be formed on each of the first substrate 22 and the second substrate 23 without use of transfer materials. The first substrate has a colored layer 29 formed on a rear side thereof, the colored layer comprising applied lusterless black paint.

By applying a voltage across a row electrode 26 and a column electrode 27 disposed so as to confront each other, the chiral nematic liquid crystal layer 25 is driven to control the transition of its phase state, displaying information. A CL-LCD can display information without the use of a polarizer. The CL-LCD can hold a certain display state even if power is turned off after being set in the displayed state by applying a voltage to the group of lead electrodes 28 of the second substrate 23 once. An AF-LCD needs to have a holding voltage applied to hold a display state. As described above, the display panel having a memory effect may comprise an electrophoretic display panel (see JP-A-2001-500172).

In the CL-LCD, it is possible to transfer a held display state to the other display state by applying a certain voltage again. In this time, it is preferred that a voltage required for next information be applied after having deleted all the latest display information. In other words, it is preferred from the viewpoint of practical use that the latest display information be rewritten into new displayed information after the latest display information has been completely deleted. It is usual to display desired information by bringing the entire active area into the PL state to display a selective reflection color, and by bringing the entire active area into the FC state to set the active area in a slightly scattering state to display a lusterless color (black paint) on the rear side (see, e.g., JP-A-2001-337314). In this embodiment, the CL-CLD has a two-layer structure, which uses chiral nematic liquid crystal display panels having selective reflective wavelengths in a complimentary color relationship.

This embodiment is configured so that the respective selective reflective wavelengths of the liquid crystal cells in the two-layer structure are determined so as to emit four colors of white, black, blue and orange in this order from the front side. The embodiment may be configured so as to display, e.g., other four colors of brown, dark blue, gray and light blue in addition to the above-mentioned four colors. The pixels corresponding to the dot matrix of the liquid crystal panels can freely modify display. The color data of the respective pixels of a color image may be preliminarily subjected to software processing to be transformed so as to produce image data suited to certain multi-color display in the chiral nematic liquid crystal display panel.

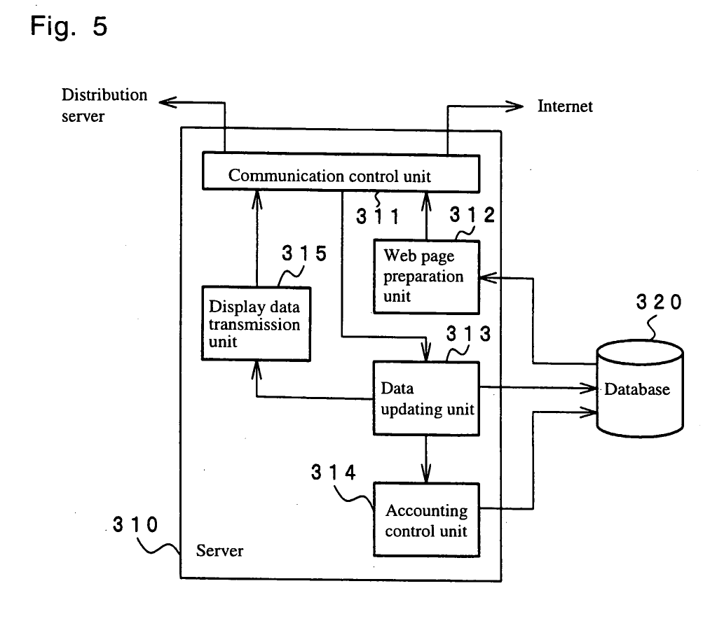

FIG. 5 is a block diagram showing the functional structure of the server 310 along with the database 320. The database 320, which serves as a memory unit, may be incorporated in the server 310. In the structure shown in FIG. 5, a communication control unit 311 performs not only protocol control and the like in communication via the Internet 200 but also protocol control and the like in communication with the distribution server 410 through the dedicated line 500.

A Web page preparation unit 312 prepares a Web page so that an operator at the terminal unit 100 shown in FIG. 1 can input information indicating a change in the display information and amended data, and the Web page preparation unit outputs the Web page to the communication control unit 311. Description will be made, taking a timetable as the display information as an example. For example, the Web page preparation unit 312 prepares a Web page containing the data of the relevant timetable already stored in the database 320 and provides the Web page to the terminal unit 100 through the communication control unit 311, for example.

When the Web browser of the terminal unit 100 accepts a change command (a changed portion and amended data on the changed portion) in the Web page displayed on the display screen of the terminal unit 100, the change command transmitted by the Web browser is received by a data updating unit 313 through the communication control unit 311. The data updating unit 313, which serves as a means for changing displayed information, changes the display information stored in the database 320, according to the change command. The amended display data are output to a display data transmission unit 315.

The display data transmission unit 315 converts the data format of the display data into a data format acceptable to the display devices 80, if needed. For example, when the display devices 80 are configured to receive display data in the JPEG format, i.e., when the display devices have a function of converting data in the JPEG format into bitmap data, the display data transmission unit 315 converts the data format of display data input from the data updating unit 313, into the JPEG format. The display data, which has been subjected to data format conversion, are output to the communication control unit 311. The communication control unit 311 transmits the display data to the distribution server 410 through the dedicated line 500 shown in FIG. 1.

When the data updating unit 313 has changed display data, the data updating unit notifies an accounting control unit 314 of the change. The database 320 contains a memory area as a means for storing accounting information in order to store accounting data for each group wherein one group comprises each display device 80 or a plurality of display devices. For example, one group may comprise the respective display devices installed in a station in a railroad company or all display devices in a single railroad company. Obviously, is the database may have respective memory areas allotted to the respective display devices in a single railroad company to store accounting data therein.

The accounting system may comprise a system with basic charge and volume-based charge combined, for example. Specifically, the basic charge for one month or one year is fixed, and a certain amount of charge is added to the charge whenever a change in display data is made. The memory area for storing the accounting data stores the accounting data showing the total charge for a certain period of time (such as one month or one year). When the accounting control unit 314 is notified by the data updating unit 313 that a change in display data has been made, a value corresponding to a certain charge is added to the accounting data in the memory area. A person in charge in the information display provider 300 outputs the accounting data stored in the memory area, from the memory area whenever a certain period of time has passed. The person charges the owner of the display device or the renter of the display device for a fee corresponding to the accounting data.

It should be noted that in the structure shown in FIG. 5, the Web page preparation unit 312, the data updating unit 313, the accounting control unit 314 and the display data transmission unit 315 may be realized by the CPU of the server 310, which operates according to a program. The communication control unit 311 may be realized by the CPU of the server 310 operating according to a program, and a transmission unit made of hardware. The Web page preparation unit 312 and the communication control unit 311 form a Web page transmission means for transmitting a Web page to the terminal device 100. The data updating unit 313 is an example of the means for changing display information, which prepares amended display data. The display information thus amended is transmitted to the distribution server 410 by the display data transmission unit 315 and the communication control unit 311.

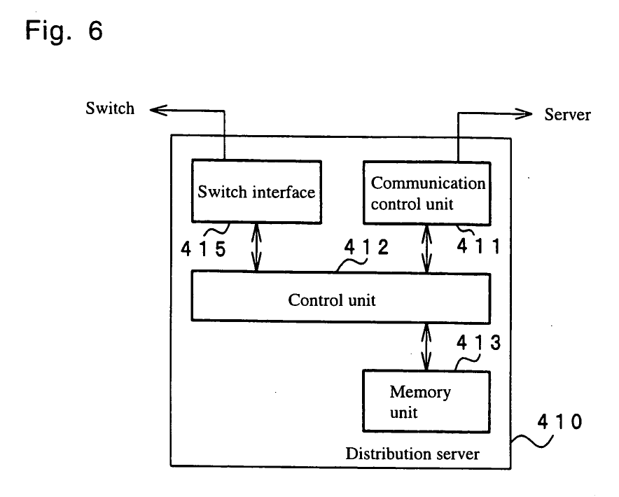

FIG. 6 is a block diagram showing an example of the structure of the distribution server 410. In the structure shown in FIG. 6, a communication control unit 411 performs, e.g., protocol control in communication with the server 310 through the dedicated line 500 shown in FIG. 1. A control unit 412 receives, through the communication control unit 411, the amended display data transmitted from the server 310, and temporarily stores the received display data in a memory unit 413. The memory unit 413 has memory areas allotted therein so as to correspond to the plural display devices 80. The control unit 412 stores the amended display data transmitted from the server 310, in the memory area corresponding to the display device to display the amended display data. The memory unit 413 also stores a command to designate what processing should be preformed by the control unit of that display device. Such a command is transmitted from the terminal unit 100 to the distribution server 410 through the server 310, for example.

A switch interface 415 performs, e.g., protocol control in transmission of data to the switch 400. The switch interface 415 serves as a gateway for connecting the distribution server 410 to the digital public cellular phone network.

In the structure shown in FIG. 6, the control unit 412 may be realized by the CPU of the distribution server 410, which operates according to a program. The communication control unit 411 and the switching interface 415 may be realized by the CPU of the distribution server 410 operating according to a program, and a communication unit of hardware.

The respective display devices 80, which exist in the network system, may be configured so that when the respective display device access to the distribution server 410 via the public cellular phone network at a preset time, the respective display devices download a command or display data stored in the memory unit 413 of the distribution server 410. In that case, the respective display devices 80 may be configured so as to modify the preset time after have been put into service.

When the respective display devices 80 are configured so as to access the distribution server 410 at a fixed time, a user may set up a time window for performing preset communication. There is no limitation to the number of time windows per day. In a normal state, each of the display devices 80 transmits its own information (such as a cell voltage and a temperature measured by a built-in data logger) to a management system (display management system) once a day, for example. When the occurrence of an unusual situation is detected, a system administrator is notified of it in order to take appropriate measures. When a user wants to amend display information, the user can output the information from the server 310. It is acceptable to charge a user for a fee corresponding to additional operation based on the number of communication through the dedicated line 500. The system is configured so that no display data are transmitted in a normal state. The system is configured so that display data are transmitted to the display devices 80 only at the situation set by the user.

When there are too many display devices 80 installed, the time windows for allowing the respective display devices to effect a display change (the time zones for the respective display devices to be allowed to access the distribution server 410) may be preliminarily shifted one after another so that the respective display devices can receive display data from the distribution server one after another.

The display devices 80 can transmit information to and receive information not only from the server side through a communication channel but also an external device interface attached to the respective devices 80 (such as an interface according to the USB (Universal Serial Bus) or Bluetooth (trademark)). In other words, the display devices may receive various kinds of commands from an external device connected to the display devices through the interface or transmit various kinds of data to the external device through the interface.

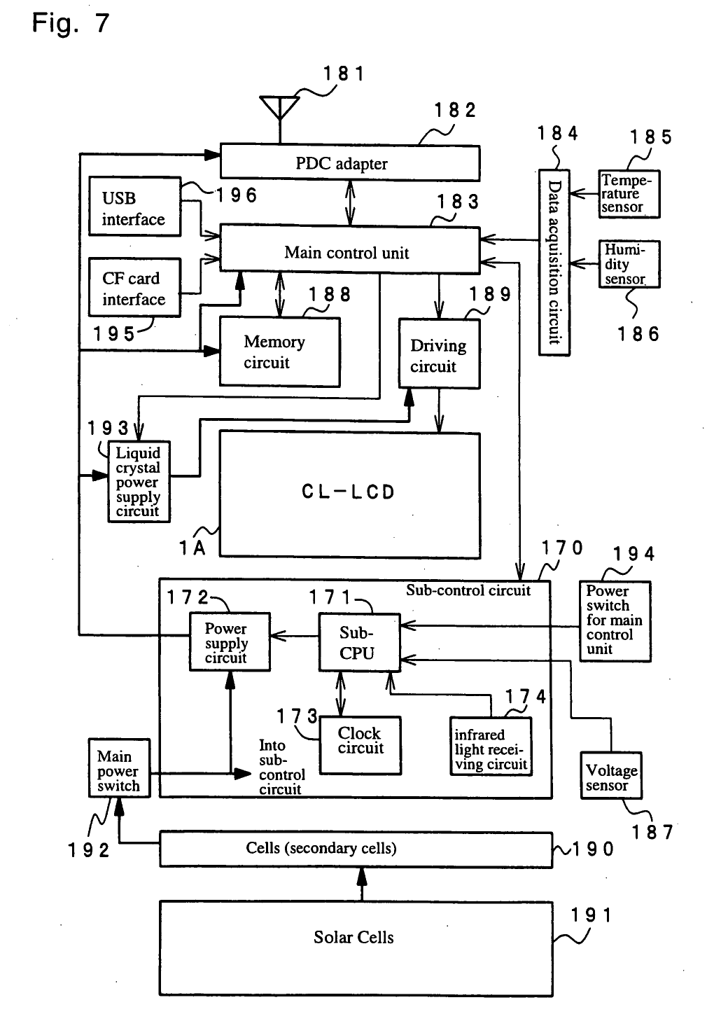

In order to reduce the power required for running each of the display devices 80, the control system is divided into a power control system, a main control system and a liquid crystal display panel driving system. When the main power switch (FIG. 7) disposed in a display device 80 is turned on, only the power control system is energized (is supplied with power) in a normal state (information is displayed without any event occurring in connection with the control for the display device 80). In other words, when the main power switch disposed in the display device 80 is turned on, the power control system is constantly energized. If an event occurs in connection with the control for the display device 80, the main control system is energized to be set in an active state. If an event in connection with the control for the display device 80 also needs to rewrite display information on a liquid crystal display panel, the liquid crystal display driving system is also energized.

Each of the display devices 80 includes secondary cells in order that each of the display devices 80 can semipermanently operate even without being fed with power from outside. Solar cells, which charge the secondary cells one by one, may be installed so as to have cell surfaces facing outward. The solar cells may comprise ones having an efficiency of 0.5 A/1,000 lux. In this case, it is preferred that the maximum consumption current in the power source control system constantly energized, be 500 μA or below and that the maximum consumption current be 1 A or below when the liquid crystal display panel driving system is also energized.

The power source may adopt either one of two systems of a first system where only primary cells are used and a second system where secondary cells are combined with solar cells with the secondary cells being charged by the solar cells. The primary cells may comprise one pack of (three cells connected in series)×(nine cells connected in parallel)=27 cells, each cell being rated at 2.2 A (3 V) for example. One pack has dimensions of about 142 mm×156 mm×19 mm. The cells connected in series and parallel totally serve as a power source rated at 19.8 Ah (an output of 9 V).

In a case where each of the display devices comprises eight successively disposed panels with such a primary cell arrangement, when rewriting of information is started by a semiautomatic timer once a day, the display devices can continuously run for about one year. After one year has passed, the display devices can continue automatic operation by exchanging a power pack for a new one. The power pack may be easily exchanged through a cover, which is formed in, e.g., a top surface of the casing of each of the display devices 80. Evidently, consecutive operating days are determined by the power source capacity used and the frequency of rewriting information. It is preferred from the viewpoint of being capable of having maintenance-fee operation in fact for, e.g., a half year or longer that the frequency of rewriting be once a day. The type of and the number of the primary cells may be determined according to a desired use condition in consideration of the nominal voltage, the discharge capacity, the output density, the self-discharge and variable factors under use environment.

On the other hand, the system that the secondary cells are combined with solar cells is performed as stated below. If power is supplied only by secondary cells, it is difficult to maintain a required working voltage since a voltage drop is caused by self-discharge. For this reason, the display devices are configured so as to use the secondary cells with the secondary cells being charged by the solar cells. For example, the secondary cells comprise lithium polymer cells having an output of about 1,200 mAh at 7.4 V or about 3,450 mAh at 7.4 V. The rated output voltage is 7.4 V.

On the other hand, the specifications for the solar cells are set to have a rated output of 500 mA. When outdoor light has about 1,000 lux, the nominal maximum output voltage (Vpm) is 10.0 V, and the nominal maximum operating current is 4.5 mA (both values are estimated values). Accordingly, when the frequency of rewriting is once a day, the display devices can substantially continuously run. For example, in a case where each of the display devices comprises eight successively disposed panels, when rewriting is automatically done once a day by a timer, the display devices can continuously run. This is a continuous automatic operation from the practical viewpoint. The display devices are operated with a built-in program preset therein. It should be noted that it is possible to easily obtain about 1,000 lux even with general outdoor light.

If it is possible to more positively replenish the secondary cells with power by outdoor light, it is possible to increase the frequency of rewriting the display devices 80. In other words, the display devices can continuously run with display information being rewritten more frequently without being supplied power supply from the commercial power supply.

When it is necessary to rewrite display information more frequently, it is acceptable to use a local memory, such as a USB memory, or wireless communication to input new display information into a display device 80 from outside in order to rewrite the information displayed on a display panel. When wireless communication is used, power is consumed in an amount corresponding to the number of communication, the time period for communication and the data volume to download. If the secondary cells are replenished with power by the electromotive force of the solar cell, the display devices can be caused to continuously run. If it is possible to obtain light having about several thousands of luces, it is possible to perform the operation management using wireless communication in a substantially continuous way.

FIG. 7 is a block diagram showing a typical example of the circuit configuration of the electric circuit block 13 along with a chiral nematic liquid crystal display panel in a display device 80. In FIG. 7, among the chiral nematic liquid crystal display panels 1A to 1H shown in FIG. 2, only the chiral nematic liquid crystal display panel 1A as well as a driving circuit 189 for driving the panel is shown as an example. A PDC adapter 182 serves as a circuit to communicate with the base station 600 of FIG. 1 through an antenna 181 in the PDC system. A main control unit 183 is realized by, e.g., a microcomputer (MPU), which makes data format conversion if necessary and stores display data in the memory circuit 188 when the PDC adapter 182 receives the display data. An example of the memory circuit 188 is a nonvolatile flash memory (flash ROM). For this reason, the memory circuit 188 does not need to be supplied with power in the other time periods than the time period where display data to store are updated.

The main control unit 183 provides the display data to the driving circuit 189 at a certain timing to rewrite the display information on the chiral nematic liquid crystal display panel 1A based on the display data. Rewriting is done as already described. It should be noted that in a case where the information displayed on the chiral nematic liquid crystal display panels 1A to 1H is updated, when the driving circuit corresponding to a chiral nematic liquid crystal display panel serves to rewrite the chiral nematic liquid crystal display panel, the main control unit 183 effects control of the driving circuits for the other chiral nematic liquid crystal display panels so as not to activate these driving circuits. In other words, in a case where there are a plurality of display panels having a memory effect (for example, four or more of display panels, or eight display panels as in this embodiment), when the information displayed on one of the display panels is updated, the voltages, which are applied to display electrodes of all other display panels, are turned off, and the information displayed on the respective display panels is rewritten one by one. The display panels may be configured so that when the information displayed on a display panel is rewritten, the information displayed on the other display panels can be held because of the presence of a display function having a memory effect, with the result that the other display panels can be set to be practically prevented from being driven to perform rewriting operation accompanied by power consumption. The power sources, the driving signals and the control signals of the respective display panels may be arbitrarily designed in terms of system configuration. Among these factors, the operation of the circuit systems, which consume much power, is adequately controlled to reduce the entire power consumption.

It is preferred that the display devices 80 have several kinds of sensors incorporated therein. In FIG. 7, a temperature sensor 185, a humidity sensor 186 and a voltage sensor 187 are shown as examples of the sensors. The temperature sensor 185 and the humidity sensor 186 are disposed in the vicinity of the chiral nematic liquid crystal display panel 1A to detect the temperature and the humidity around the chiral nematic liquid crystal display panel 1A. The voltage sensor 187 detects the output voltage of the cells 190. In this embodiment, the outputs from the temperature sensor 185 and the humidity sensor 186 are input into the main control unit 183 through a data acquisition circuit 184. The output of the voltage sensor 187 is input into a sub-control circuit 170.

In each of the display devices 80, the main control unit 183 is connected to one or more interfaces for external devices (local interfaces). In the structure shown in FIG. 7, the main control unit is connected to a CF card interface 195 including a socket for plugging a CF (Compact Flash) card therein, and a USB interface 196 including a USB connector. These two interfaces are examples of the interfaces for external devices. Each of the display devices 80 may have a Bluetooth (trademark) interface, a wireless LAN interface and other interfaces mounted thereon. In Description, the word “interface” means an interface circuit.

In this embodiment, a CF card or a USB memory can be connected to each of the display devices 80 since the CF card interface 195 and the USB interface 196 are incorporated in each of the display devices 80. For this reason, it is possible to provide various kinds of commands or display data to the main control unit 183 from not only the distribution server 410 shown in FIG. 1 but also a CF card or a USB memory. The commands and the display data provided to the main control unit 183 are stored in the flash ROM in the memory circuit 188.

In this embodiment, the main control system contains the PDC adapter 182, the main control unit 183, the memory circuit 188, and a circuit portion connected to the main control unit 183 (excluding the driving circuit 180). When the main control system is supplied with power, the data acquisition circuit 184, the CF card interface 195 and the USB interface 196 are also energized. The driving circuit 189 is contained in the liquid crystal display panel driving system.

In the structure shown in FIG. 7, the cells (secondary cells 190), which generate an electromotive force by chemical reaction and are capable of being charged, are used as the power source. There are also provided the solar cells 191, which receive light to generate power to charge the secondary cells one by one.

Each of the display devices 80 includes the sub-control circuit (power source control circuit) 170, which serves as a power source control system. Each of the display devices 80 includes a main power switch 192. When the main power switch 192 is operated to be turned on, the power from the cells is supplied to the sub-control circuit 170. When a power supply circuit 172 disposed in the sub-control circuit 170 is set in a state to be capable of supplying power (energized state), the power from the cells 190 is also supplied to the main control system.

The sub-control circuit 170 includes a sub-CPU 171 for controlling the power supply circuit 172. The sub-CPU 171 receives an output signal from a power switch for the main control unit 194, an output signal from a clock circuit (timer IC) 173, an output signal from an infrared light receiving circuit 174 and a signal from the voltage censor 187, which are disposed in the relevant display device 80.

When the power switch for the main control unit 194 is manually operated with the sub-control circuit 170 being energized by the cells 190, an output signal, which is generated based on the manual operation, is input into the sub-CPU 171. When the output signal is inputted from the power switch for the main control unit 194 into the sub-CPU 171, the sub-CPU sets the power supply circuit 172 in the energized state (in such a state that current is fed from the cells 190 to the main control system). The main control system can be thus controlled to be set in an operating state by operation of the power switch for the main control unit 194.

The clock circuit 173 not only measures a current time but also outputs a time-up signal, as an output signal, to the sub-CPU 171 when the current time coincides with a preset time-up time. Also, when the sub-CPU 171 receives the time-up signal from the clock circuit 173, the sub-CPU also sets the power supply circuit 172 in the energized state. The main control system can be thus controlled to be set in the operating state at the preset time in one day.

The infrared light receiving circuit 174 is a circuit, which has a function of receiving an infrared signal according to, e.g., the IrDA (Infrared Data Association) standard. When the infrared light receiving circuit receives a preset start code from an infrared light transmission circuit (not shown), which is activated through direct communication (communication using no public communication network) by the operation of, e.g., a person in charge, the infrared light receiving circuit outputs an output signal to the sub-CPU 171. Also, when the sub-CPU 171 receives the output signal from the infrared light receiving circuit 174, the sub-CPU sets the power supply circuit 172 in the energized state. The main control system can be thus controlled to be set in the operating state when, e.g., a maintenance person operates a unit with the infrared ray transmission circuit incorporated therein. It should be noted that the infrared light receiving circuit 174 may comprise a light-electricity converter circuit and that the sub-CPU 171 may be configured to recognize the start code based on an output signal from the infrared light receiving circuit 174.

The voltage sensor 187 detects the output voltage of the cells 190. When the output voltage of the cells 190 drops to a predetermined voltage, the voltage sensor outputs an alarm signal. When the voltage sensor 187 outputs the alarm signal, the sub-CPU 171 sets the power supply circuit 172 in the energized state. The sub-CPU 171 may be configured so that the sub-CPU monitors an output voltage value of the cells 190 through the voltage sensor 187 and that when the output voltage value of the cells 190 drops to the predetermined voltage, the sub-CPU sets the power supply circuit 172 in the energized state. By performing such control, when the output voltage of the cells 190 has lowered, the main control unit 183 can display warning information on the chiral nematic liquid crystal display panel 1A, for example.

The main control unit 183 also sets a liquid crystal feeding circuit 193 only when the information on the chiral nematic liquid crystal display panel 1A is updated. When the liquid crystal feeding circuit 193 is set in the energized state, the driving circuit 189 is fed with power.

In this embodiment, each of the display devices 80 can hold display information even without being fed with power, since each of the display devices uses the chiral nematic liquid crystal display panel 1A, as a display panel, which has a memory effect. In other words, when using a display panel having a memory effect, the display devices 80 can be made practical because of being substantially maintenance-free in connection with power supply.

Although the chiral nematic liquid crystal display panel 1A can hold display information without rewriting the display data for a long period of time, it is preferred that the display data be rewritten (refreshed) every certain period of time, such as once a day or once a week. For example, even when the PDC adapter 182 has received no amended display data, the main control unit 183 provides the driving circuit 189 with display data currently stored in the memory circuit 188, rewriting the display information on the chiral nematic liquid crystal display panel 1A based on the display data. Although it is supposed that the display information does not change after rewriting unless the PDC adapter receives no amended display data, it is possible to perform such operation to return the information on the chiral nematic liquid crystal display panel 1A to the correct one if the display information has been incorrectly changed for some reason.

Although it is preferred that the antenna 181 be incorporated in each of the display devices 80, the antenna is exposed from each of the display devices 80 when the casing 14 shown in FIG. 3 is made of metal. In this case, it is preferred that the antenna 181 be protected with a cover made of, e.g., a resin.

The main control unit 183 may be configured that when a USB memory or a CF card plugged into the socket, and when power supply is started, the main control unit receives detection signals of the temperature sensor 185 and the humidity sensor 186 from the data acquisition circuit 184 and writes the detection signals in the USB memory or the CF card immediately after acquiring display data or a command from the USB memory or the CF card. The main control unit may be configured so that status information, which corresponds to a detection value of the voltage sensor 187 and is transmitted from the sub-control circuit 170, is written in the USB memory or the CF card.

Although only the chiral nematic liquid crystal display panel 1A is shown as an example in FIG. 7, the other chiral nematic liquid crystal display panels 1B to lH include their own driving circuits. The respective driving circuits are connected to the main control unit 183, and the main control unit 183 provides the respective driving circuits with display information to be displayed on the respective chiral nematic liquid crystal display panels 1A to 1H.

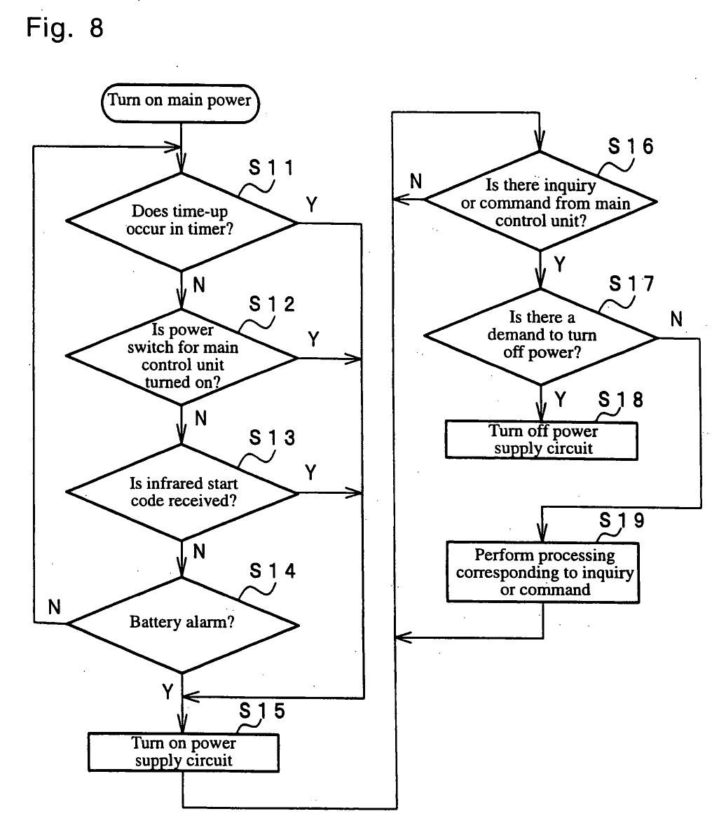

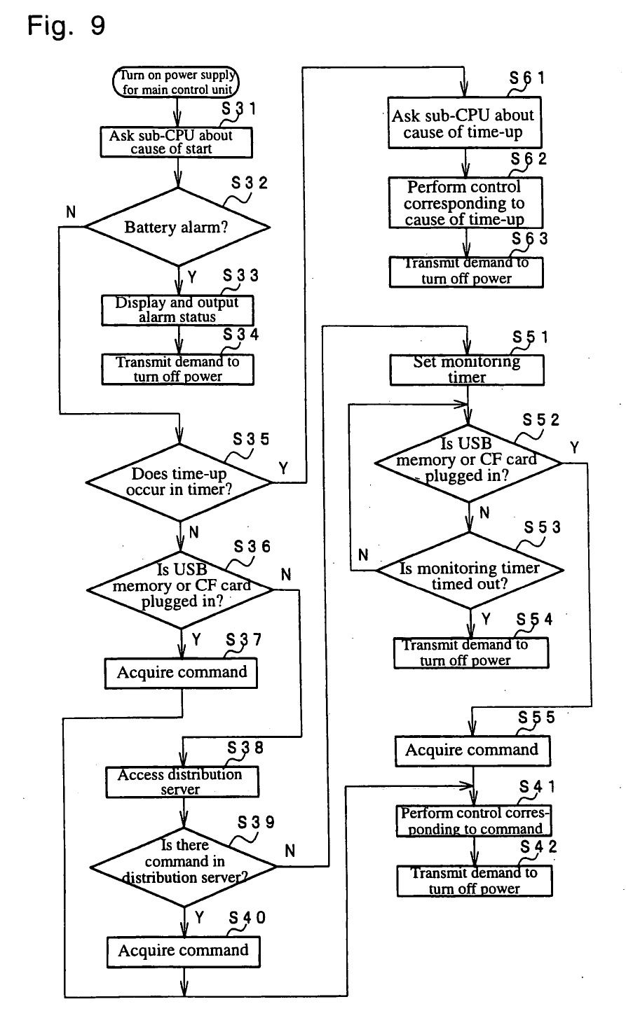

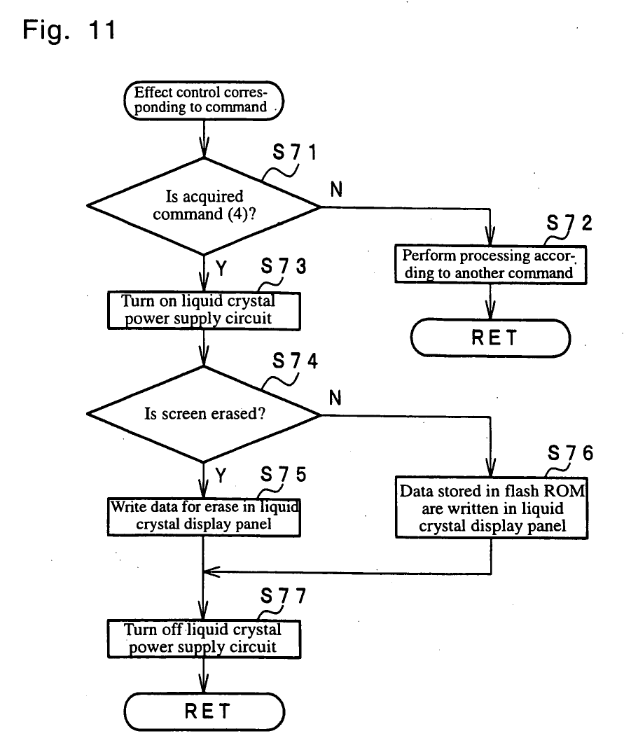

Now, an operation example of the power source control system and the main control system will be described, referring to the flowcharts shown in FIG. 8, FIG. 9 and FIG. 11. FIG. 8 is a flowchart showing an operation example of the sub-CPU 171. In the example shown in FIG. 8, when the clock circuit 173 notifies the sub-CPU 171 of time up after power supply has been started by the main power switch 192 (Step S11), the sub-CPU turns on the power supply circuit 172 (sets the power supply circuit in the energized state) (Step S15). Also when an output signal is output from the power switch for the main control unit 194 (Step S12), the sub-CPU 171 turns on the power supply circuit 172 (Step S15). Also when the sub-CPU has recognized through the infrared light receiving circuit 174 that the infrared ray transmission circuit has transmitted the start code (Step S13), the sub-CPU turns on the power supply circuit 172 (Step S15). Also when the voltage sensor 187 outputs the alarm signal (Step S14), the sub-CPU 171 turns on the power supply circuit 172 (Step S15). It should be noted that when the sub-CPU 171 has recognized, based on the output voltage value of the cells 190 obtained through the voltage sensor 187, that the output voltage value of the cells 190 has dropped to the predetermined voltage, the sub-CPU turns on the power supply circuit 172. In that case, the sub-CPU 171 holds an alarm status showing that the output voltage value of the cells 190 has lowered.

After that, in a case where the sub-CPU 171 receives an inquiry or a command from the main control unit 183 (Step S16), when the command is a command to turn off the power (Step S17), the sub-CPU 171 turns off the power supply circuit 172 (sets the power supply circuit in the deenergized state) (Step S18). The main control system is set in a state without power supply by the processing of Step S18.

When the sub-CPU receives an inquiry from the main control unit 183, or when the command received from the main control unit 183 is not the command to turn off the power, the sub-CPU 171 performs processing so as to correspond to the received inquiry or command (Step S19). Then, the process returns to Step S16. Examples of the inquiry include an inquiry on the cause of start, an inquiry on the alarm status and an inquiry on the cause of time-up in the clock circuit 173. Examples of the processing to correspond to the command include processing to transmit the cause of start to the main control unit 183, processing to transmit the alarm status to the main control unit 183, processing to set the current time in the clock circuit 173 and processing to set the time-up time in the clock circuit 173.

FIG. 9 is a flowchart showing the operation of the main control unit 183, which is executed since power supply starts in the main control system. In the example shown in FIG. 9, the main control unit 183 inquires the sub-CPU 171 on the cause of start, i.e., why power supply has started in the main control system (Step S31). The sub-CPU 171 transmits the cause of start in Step S19.

When the sub-CPU 171 notifies the main control unit 183 that the start is caused by an alarm signal (containing the drop in the output voltage value of the cells 190 to the predetermined voltage), i.e., that the start is caused by a battery alarm (Step S32), the main control unit displays an alarm status or certain warning information in characters as warning on a chiral nematic liquid crystal display panel. The main control unit also transmits the alarm status to the distribution server 410 through the PDC adapter 182 and outputs the alarm status to the USB memory or the CF card (Step S33). Then, the main control unit provides the sub-CPU 171 with the command to turn off the power (Step S34).

Even in cases other than the case where power supply has started in the main control system because the voltage sensor 187 has output the alarm signal or the output voltage value of the cells 190 has dropped to the predetermined voltage, it is preferred that the main control unit 183 inquire the sub-CPU 171 about the alarm status.

When the sub-CPU 171 has notified the main control unit 183 that the start is caused by a time-up signal from the clock circuit 173 (Step S35), the main control unit executes the processing of Step S61.

When the sub-CPU 171 has notified the main control unit 183 that the start is not caused by a time-up signal from the clock circuit 173, i.e., when the start is caused by an output signal input from the power switch for the main control unit 194, or when the start code is transmitted from the infrared ray transmission circuit (Step S35), the main control unit executes the processing of Step S36.

In Step S36, the main control unit 183 checks, through the USB interface 196 and the CF card interface 195, whether a USB memory or a CF card is plugged therein or not. When a USB memory or a CF card is plugged in, the main control unit 183 reads out a command from the USB memory or the CF card (Step S37). If the main control unit fails to read out a command, it is supposed that the determination of Step S36 is “N”. When the main control unit has read out a command, the main control unit executes control according to the command read out (Step S41). Then, the main control unit transmits the command to turn off the power, to the sub-CPU 171 (Step S42).

When neither a USB memory nor a CF card has been plugged in, or when no command is read out from the USB memory or the CF card plugged, the main control unit 183 commands the PDC adapter 182 to access the distribution server 410 (Step S38). As commanded, the PDC adapter 182 performs communication according to the PDC system with the base station 600 through the antenna 181 to acquire a command stored in the memory unit 413 in the distribution server 410. When no command is stored in the memory unit 413 in the distribution server 410, the PDC adapter 182 cannot acquire a command. When the PDC adapter 182 has acquired a command, the PDC adapter outputs the acquired command to the main control unit 183. When the PDC adapter cannot acquire a command, the PDC adapter notifies the main control unit 183 of it.

When the main control unit 183 receives a command, the main control unit executes control according to the acquired command (Steps S39, S40 and S41). Then, the main control unit transmits a command to turn off the power, to the sub-CPU 171 (Step S42).

In Step S51, the main control unit 183 first sets a monitoring timer (Step S51). When the main control unit attempts to effect processing to read out a command from the USB memory or the CF card until a time-up occurs in the monitoring timer (Steps S52 and S53). When the main control unit has read out a command from the USB memory or the CF card before a time-up occurs in the monitoring timer and after the USB memory or the CF card has been plugged in (Steps S52 and S55), the main control unit executes control according to the read-out command (Step S41). Then, the main control unit transmits the command to turn off the power, to the sub-CPU 171 (Step S42). When a time-up has occurred in the monitoring timer, the main control unit transmits the command to turn off the power, to the sub-CPU 171 (Step S54). Since the processing of Steps S51 to S54 allows a maintenance person or the like to plug a USB memory or a CF card in the main control unit after operation of the power switch for the main control unit when the main control unit 183 is caused to read out a command from the USB memory or the CF card, maneuverability is improved. The processing of Steps S51 to S54 can prevent the main control system from being supplied with power for a long period of time in, e.g., a case where the power switch for the main control unit 194 is erroneously operated.

In Step S61, the main control unit 183 inquires the sub-CPU 171 why a time-up has occurred. Then, the main control unit 183 executes control according to the cause of the time-up transmitted from the sub-CPU 171 (Step S62). In this embodiment, the clock circuit 173 includes a plurality of timers (such as five timers). In the clock circuit 173, different time-up times may be set in the respective timers. For example, the timers may be used so that when a time-up occurs in a first timer, first processing (such as processing to refresh the chiral nematic liquid crystal display panels) is performed, and that when a time-up occurs in a second timer, second processing (such as processing to output an alarm status) is performed.

When the start is caused by reception of a time-up signal from the clock circuit 173, the main control unit 183 performs processing according to the processing contents stored in the memory circuit 188, unlike the case where the start is caused by reception of an output signal from the power switch for the main control unit 194 or by transmission of a start code from the infrared ray transmission circuit. In other words, when the start is caused by a time-up signal from the clock circuit 173, the main control unit 183 does not perform processing to read out data from a USB memory or a CF card or to access the distribution server 410. The processing content, which are executed when a time-up occurs in each of the timers in the clock circuit 173, are stored in the flash ROM contained in the memory circuit 188. Examples of the processing contents stored in the memory circuit 188 will be described later.

After that, the main control unit 183 transmits the command to turn off the power, to the sub-CPU 171 (Step S63).

The main control system can be caused to perform predetermined processing at preset times in one day by the above-mentioned control. In accordance with operation by a maintenance person or the like, the main control system can be set in the operating state to capture a command from a USB memory, a CF card or the distribution server 410. As is clear from the above-mentioned description, when the maintenance person or the like wants to capture a command from the distribution server 410, he or she may operate the power switch for the main control unit 194 without plugging a USB memory or a CF card in the display device 80 or may provide the display device 80 with the start code from a unit with the infrared ray transmission circuit incorporated therein.

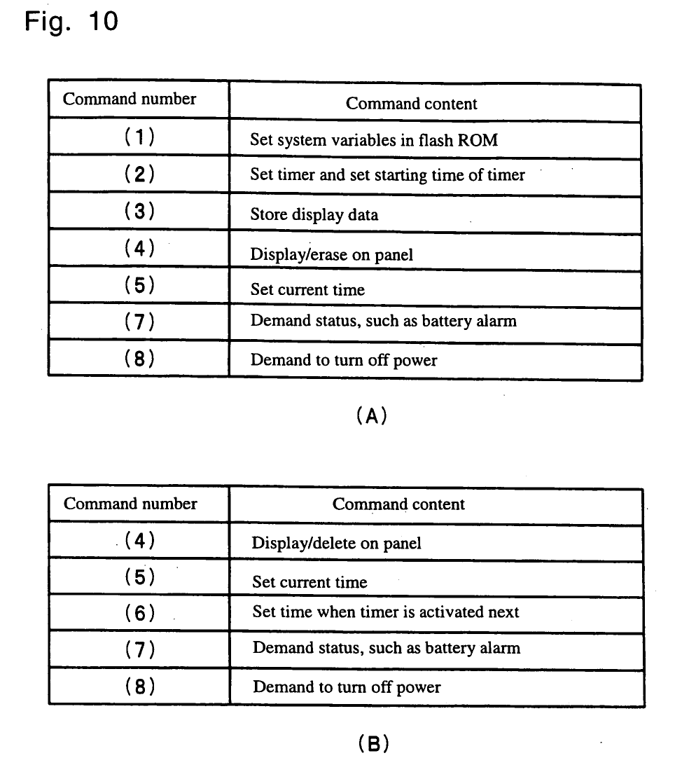

Now, examples of the commands, which are used in this embodiment, will be described. FIG. 10(A) shows examples of the commands, which are used when the start of the main control system is caused by an output signal from the power switch for the main control unit 194 or an output signal from the infrared light receiving circuit 174. Specifically, the commands that are listed as examples in FIG. 10(A) are given to the main control unit 183 from the distribution server 410, a USB memory or a CF card.

(1) A command to “Set system variables in flash ROM” is a command to set, e.g., the number of chiral nematic liquid crystal display panels and the numbers of dots. When the main control unit 183 receives the command in item (1), the data designated by the command are written in the flash ROM in the processing of Step S41.

(2) A command to “Activate timer and set time-up time” is a command to activate a timer contained in the clock circuit 173 disposed in the sub-control circuit 170 or designate the time-up time to set in the activated timer. When the main control unit 183 receives the command in item (2), the main control unit transmits the command to the sub-CPU 171 in the processing Step S41. The sub-CPU 171 activates the designated timer or sets the designated time-up time in the activated timer in the processing time of Step S19.

(3) A command to “Store display data” is a command to store display data in the memory circuit 188. When the main control unit 183 receives the command in item

(3), the main control unit stores the display data in the flash ROM in the memory circuit 188 in the processing of Step S41. The command in item (3) is accompanied with the display data.

(4) A command to “Display/erase display data” is a command to update information on a chiral nematic liquid crystal display panel based on display data stored in the memory circuit 188 or erase information on the chiral nematic liquid crystal display panel. When the main control unit 183 receives the command in item (4), the main control unit not only supplies power to the liquid crystal display panel driving system but also causes the driving circuit 189 to perform driving to update or erase information on the chiral nematic liquid crystal display panels in the processing of Step S41.

(5) A command to “Set current time” is a command to reset a current time to be measured by the clock circuit 173 disposed in the sub-control circuit 170. When the main control unit 183 receives the command in item (5), the main control unit transmits the command to the sub-CPU 171 in the processing of Step S41. The sub-CPU 171 resets the current time of the clock circuit 173 in the processing of Step S19. The command in item (5) is accompanied by a time data.

(7) A command to “Demand status, such as battery alarm” is a command to demand transmission of a status. When the main control unit 183 receives the command in item (5), the main control unit not only receives detection signals of the temperature sensor 185 and the humidity sensor 186 from the data acquisition circuit 184 but also inquires the sub-CPU 171 about a status, such as an alarm status in the processing of Step S41. The sub-CPU 171 transmits its held status to the main control unit 183 in response to the inquiry in the processing of Step S19. The main control unit 183 acquires detection values based on detection signals of the temperature sensor 185 and the humidity sensor 186, and the status in the processing of the Step S41. When the main control unit receives the command from a USB memory or a CF card, the main control unit writes the detection values and the status in the USB memory or the CF card. When the main control unit receives the command from the distribution server 410, the main control unit transmits the detection values and the status to the distribution server 410 through the PDC adapter 182.

When the distribution server 410 has received the respective detection values and the status from a display device 80, the distribution server transmits the respective detection values to the server 310 as the display control server. The server 310 stores the detection values in the memory area allotted to the respective display devices in the database 320. Detection values stored in the memory area are output from the memory area by a person in charge in the information display provider 300. In other words, the person in charge in the information display provider 300 displays information in a display unit connected to the server 310 or prints out information by a printer. When it is shown that a detection value is abnormal, a maintenance person is sent to a place where the related display device is stored.

When the detection values and the status have been written in the USB memory or the CF card, a maintenance person or the like, who has plugged the USB memory or the CF card in a display device 80, removes the USB memory or the CF card. Then, he or she plugs the USB memory or the CF card in his or her wireless terminal unit to transmit the data in the USB memory or the CF card to the server 310 from the wireless terminal unit. Or, he or she brings back the USB memory or the CF card to a place where the server 310 is installed, and he or she inputs the data in the USB memory or the CF card to the server 310. Also, when the detection values and the status are input through the USB memory or the CF card, the server 310 performs the same processing as the case where the detection values and the status have been received from the related display device 80 through the distribution server 410.

A command to “Turn off power” in item (8) shown in FIG. 10(A) is not a command input from the distribution server 410, a USB memory or the CF card but is independently issued to the sub-CPU 171 by the main control unit 183. The processing relating to the command to “Turn off power” in item (8) is performed as already described.

FIG. 10(B) shows commands, which are used when the start of the main control system is caused by a time-up signal from the clock circuit 173. When-the start is cause by a time-up signal from the clock circuit 173, a proper command among the commands in items (4) to (8) is used. A command to “Set time when timer is activated next” is a command, which sets a timer in the clock circuit 173 when a time-up should occur after the current time.

When the start is caused by a time-up signal from the clock circuit 173, the main control unit 183 performs processing based on the processing contents stored in the memory circuit 188 according to the cause of time-up. In the memory circuit 188, the processing contents, which correspond to the commands in items (4) to (7), are stored so as to be mapped to the causes of time-up. The phrase “mapped to the causes of time-up” specifically means that the processing contents are mapped to the respective timers in the clock circuit 173. A command to “Turn off power” does not need to be stored in the memory circuit 188 since this command is independently issued by the main control unit 183.

Although in this embodiment, the main control unit 183 neither reads out data from a USB memory or a CF card nor access the distribution server 410 when the start is caused by a time-up signal from the clock circuit 173, the main control unit may be configured so as to perform such processing. In that case, a command to “Access server” may be defined, and the processing contents corresponding to this command may stored in the memory circuit 188, for example.

The commands listed in FIG. 10 are examples. It is definitely acceptable to define commands other than the listed commands.

FIG. 11 is a flowchart showing an example of the control corresponding to the command in Step S41. When an acquired command is a command to “Display/erase display data” in item (4) in the control corresponding to the command, the main control unit 183 turns on the liquid crystal power supply circuit 193 (sets the liquid crystal power supply circuit in the energized state to supply power to the driving circuit 180) (Steps S71 and S73). When the command to “Display/erase display data” indicates “erase”, the driving circuit 189 is caused to update the display data on the chiral nematic liquid crystal display panel 1A with data for erasure (Steps S74 and S75). When the command to “Display/erase display data” indicates “display”, the driving circuit 189 is caused to update the display data on the liquid crystal display panel 1A with display data stored in the memory circuit 188 (Steps S74 and S76). Then, the liquid crystal power supply circuit 193 is turned off (set in the deenergized state to supply no power to the driving circuit 180) (Step S77). When the acquired command is any one of commands other than the command to “Display/erase display data”, the main control unit 183 performs the processing as already described, referring FIG. 10 (Step S72).

In accordance with the above-mentioned control, it is possible to use the display devices as described below. Specifically, with the main power switch 192 being turned on, a maintenance person or the like plugs a USB memory or a CF card with commands stored therein, in a display device 80, and he or she depresses the power switch for the main control unit 194 to supply power to the main control system. Or, he or she plugs a USB memory or a CF card with the commands stored therein, in a display device 80, and he or she transmits the start code to the display device 80 from a unit with an infrared ray transmission circuit incorporated therein, thereby supplying power to the main control system. Then, the main control unit 183 is caused to effect the control according to a command stored in the USB memory or the CF card. By using the display device in that way, it is possible to instantly change display information when a change in the display information is suddenly sought.

Now, a method for updating display information on each of the display devices 80 through the distribution server 410 will be described. When it is necessary to rewrite display information on each of the display devices 80, a person in charge in a railroad company connects the terminal unit 100 to the server 310 via the Internet 200. The Web browser in the terminal unit 100 downloads the Web page in order that an operator at the terminal unit 100 is caused to input a change command. The first page is a page for entering an ID or a password, for example. The ID and the password have been issued to the operator for the terminal unit 100 in order to allow the operator to change display information on a display device 80. The ID and the password are stored so as to be mapped to each of the display devices 80 in the server 310. When a specific ID and a specific password have been entered into the terminal unit 100, and when the ID and the password are transmitted to the server 310 from the terminal unit 100, the operator for the terminal unit 100 is allowed to change display information on only a specific display device 80.

The ID and the password may be mapped to a plurality of display devices. For example, a single ID and a single password may be issued to the plural display devices installed in a single station, or a single ID and a single password may be issued to a single railroad company. In these cases, an operator for the terminal unit 100 is allowed to change display information on plural display devices.

The Web page preparation unit 312 in the server 310 reads out from the database 320, display data for the display device corresponding to the ID and the password transmitted from the terminal unit 100. The Web page preparation unit prepares a Web page containing the read-out display data and transmits the Web page to the terminal unit 100. When a single ID and a single password have been issued to the plural display devices, the Web page preparation unit 312 transmits a Web page to the terminal unit 100 in order that an operator is made to specify on which display device the operator wants to change display information.

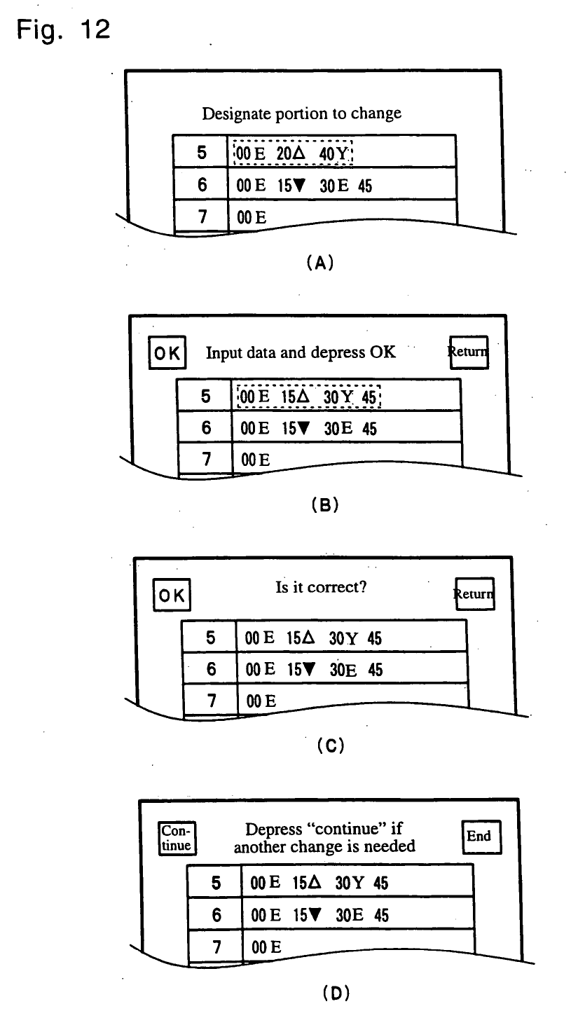

FIGS. 12(A) to (D) are schematic views showing an example of the Web page (specifically, screens displayed on the display portion of the terminal unit 100 by the Web browser). It should be noted that these figures show only a portion of each of the screens. A screen, which encourages the operator to designate a changed portion as shown in FIG. 12(A), is displayed on the display portion on the terminal unit 100. When the operator at the terminal unit 100 designates the changed portion by an input unit, such as a mouse, the Web browser in the terminal unit 100 provides the server 310 with information indicating that the changed portion has been designated. When the Web page preparation unit 312 transmits a Web page to the terminal unit 100 in order to encourage the operator to input updated data (data with the changed portion updated) as shown in FIG. 12 (B). The Web browser in the terminal unit 100 displays a screen as shown in FIG. 12(B), on the display portion.

When the operator at the terminal unit 100 has input the updated data, and when the operator has verified the operation on a verification screen as shown in FIG. 12(C), i.e. when the operator has clicked or made another action on the position of “OK” by the mouse, the Web browser in the terminal unit 100 transmits the data indicating the amended portion and the updated data to the server 310 (Step S1 in FIG. 8). In the server 310, the data updating unit 313 receives the data indicating the amended portion and the updated data through the communication control unit 311 and rewrites with the updated data, the relevant portion of the display data stored in the database 320 (Step S2). In other words, the data updating unit prepares the amended display data and stores the amended display data in the database 320 (Step S3). The Web page preparation unit 312 further transmits a Web page as shown in FIG. 12(D), to the terminal unit 100. If the operator at the terminal unit 100 has declared to-make another change, i.e., when the operator has clicked or made another action on the portion of “Cont.”, the Web page preparation unit transmits the Web page as shown in FIG. 12(A), to the terminal unit again. When the Web page preparation unit 312 transmits the Web page as shown in FIG. 12(A) again, the amended data in the already amended portion are reflected in the transmitted Web page.

Although the updated data are transmitted from the terminal unit 100 to the server 310 in order to update the display information on a display device 80 as described above, the Web page shown in FIG. 12(A) to (D) is only an example.

After the data updating unit 313 has prepared the amended display data and stored the amended display data in the database 320, the data updating unit outputs the amended display data to the display data transmission unit 315. The display data transmission unit 315 outputs the amended display data along with data indicating which display device should be displayed the amended data (data specifying the display device) to the communication control unit 311. The communication control unit 311 transmits the display data and the data specifying the display device to the distribution server 410 through the dedicated line 500. The data updating unit 313 also notifies the accounting control unit 314 that the display data have been changed. The accounting control unit 314 performs accounting processing to add the value corresponding to the fee predetermined for a change in the display data, to the accounting data in the memory area.

Although explanation has been made about a case where the accounting control unit 314 in the server 310 performs the accounting processing when display data are transmitted, the timing for performing the accounting processing is not limited to the timing when display data are transmitted. For example, the server may be configured so that after the relevant display device 80 has received display data and to store the display data in the memory circuit 188, the data stored in the memory circuit 188 are returned to the server 310 via the data public cellular phone network and the distribution server 410. When the server 310 is thus configured, the server 310 may perform the accounting processing when it is verified based on the returned display data that the display data have been correctly transmitted.

In the distribution server 410, the control unit 412 receives, through the communication control unit 411, the amended display data transmitted from the server 310. The control unit temporarily stores the received display data in a memory area in the memory unit 413 corresponding to the display device specified by the data for specifying the display device. When the control unit 412 is accessed, via the data public cellular phone network, by the relevant display device 80, the control unit transmits the display data stored in the memory area in the memory unit 413 along with the command to “Store display data” and the data indicating the display device 80 as the addressee of the display data, to the switch 420 through the switch interface 415. The switch 420 transmits the command to “Store display data” and the display data to the base station 600 in the area where the display device 80 as the addressee for the display data exists. The base station 600 transmits the command to “Store display data” and the display data to this display device 80 by wireless communication.

As described above, the main control system of the display device 80 has started at the time that the base station 600 transmits the display data to this display device 80. When the PDC adapter 182 receives the command to “Store display data” in item (3) through the antenna 181, the control unit 183 stores the display data attached to the command in the memory circuit 188. In other words, the control unit updates the memory contents of the memory circuit 188 with the newly received display data. When the control unit 183 receives a command to “Display/erase on panel” in item (4), the control unit provides the driving circuit 189 with the display data in order to rewrite the display information on the relevant chiral nematic liquid crystal display panel based on the display data stored in the memory circuit 188.

As described above, in this embodiment, the display control system comprising the server 310 and the distribution server 410 transmits amended display data to a relevant display device 80 via the data public cellular phone network in response to access from the relevant display device 80. Accordingly, it is possible to easily change the information displayed on the relevant display device 80 and to reduce the cost involved in a change in the information. Further, it is possible to realize a versatile system, which is capable of transmitting display data to a plurality of display devices from a single display control system.

Since each of the display devices 80 is equipped with the infrared light receiving circuit 174 and the power switch for the main control unit 194, the power supply to the main control system can be started by operation made by a maintenance person or the like. Thus, the maintenance person or the like can plug a USB memory or a CF card with the commands stored therein, into a display device 80 to promptly rewrite the display information on the display device. Accordingly, even if a change in the display information is suddenly sought, it is possible to immediately change the display information.

Although the above-mentioned embodiment has been described about a case where the server 310 and the distribution server are connected to each other through the dedicated line 500, another line, such as a general communication line (public line), instead of the dedicated line 500, may be used as long as required security and required transmission rate are insured.

Although the above-mentioned embodiment has been described about a case where the first communication network comprises the Internet 100, the first communication network, instead of the Internet 100, may comprise another communication network as long as change commands can be transmitted, through the first communication network, to a display control system wherein the terminal unit 100 also has a function as the server 310 or both functions as the server 310 and the distribution server 410 (which is constituted by a single server unit, for example). Although explanation has been made about a case where the second communication network comprises a public cellular phone network, the second communication network, instead of the public cellular phone network, may comprise another communication network as long as the display control system, which has both functions as the server 310 and the distribution server 410, can transmit display data to the plural display devices 80 through the second communication network.

The display control system, which has a function as the server 310 or both functions as the server 310 and the distribution server 410, may provide the display devices 80 with display data in an encrypted form.

### EXAMPLES

### Example 1

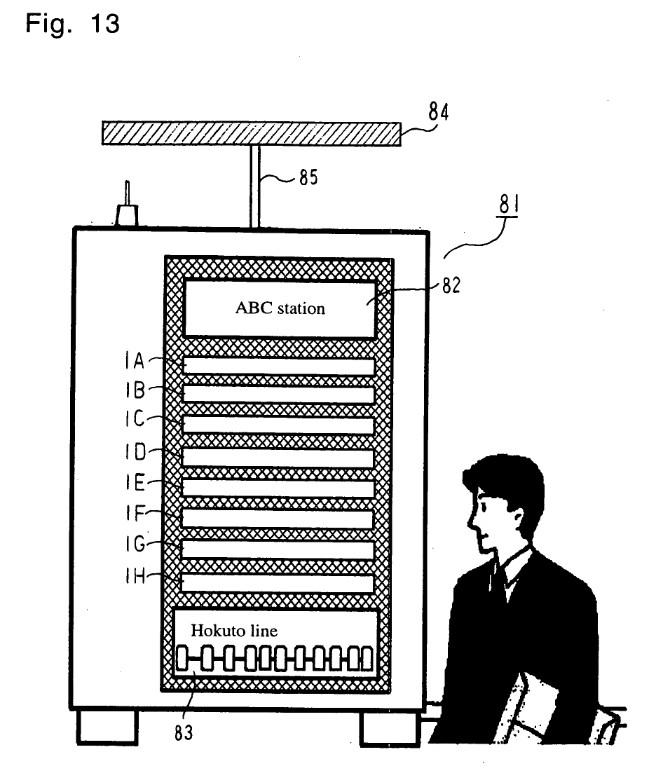

Now, a first example will be described, referring to FIG. 13. The chiral nematic liquid crystal display panels 1A to 1H (LCD panels) in the display device 81 shown in FIG. 13 are the same as the ones described in connection with the above-mentioned embodiment. The control system has a similar structure as the one shown in FIG. 7. In this example, the LCD panels are vertically disposed. A station sign 82 and a route map 83 are displayed above and under the LCD panels. The station sign 82 and the route map 83 may comprise printed matters or easy-to-change fixed display members since the station sign and the route map are fixed information and since the station sign and the route map do not need to comprise display-variable display panels.

Solar cells are used to obtain power from outdoor light. The eight successively disposed LCD panels are rewritten. The display device has secondary cells disposed,therein. For example, the power, which is consumed to rewrite display information once a day, can be supplied by the electromotive force of the solar cells. As long as only normal display-rewriting is done, the display device can continue to operate substantially semipermanently.

When display information is freely rewritten from outside by wireless communication, it is necessary to supply the communication circuit with power. In this case, the display device is configured to obtain more light from the solar cell panels since more power is needed. For this purpose, the panel size of the solar cells is adjusted so as to correspond to the average strength of the outdoor light or the average strength of illumination light.

The solar cell panel 84 are disposed above the display device 81 so as to have such a proper angle and a proper direction to receive solar light or illumination light. For example, it is preferred that the panel be fixed to the upper side of the display device 80 by a single supporter 85 or two supporters. It is preferred that the solar cell panel be of a semi-fixed type so as to be capable of freely modifying the panel surface position of the solar cells in order to receive effectively available luminous flux at an angle of about 90° C.

Rewriting of display information between a weekday mode and a weekend mode may be done after the last train and the passengers have gone both in the night of Friday and the night of Sunday. In this case, no power is practically consumed, and no unnecessary radio wave is generated during normal business hours. In this case, the timing for rewriting of display information may be automatically started by a timer circuit and a control program incorporated in the display device. Such automated operation may be performed for a half year to one year, for example. During such automated operation, display information may be arbitrarily be written from outside through the wireless function via the Internet or the like.

For example, the LCD panels may be installed in a station or the like to display advertisement. Or, it is possible to provide special information to transportation passengers in emergency. Even if a massive breakdown occurs in a commercial power supply network, the display device can use the built-in power source or the like to continuously perform display operation so as to provide passenger with necessary information for a certain period of time.

The display device 81 may be equipped with a function of making local communication and a function of being capable of downloading timetable data or the like, traffic information or other general information in real time.

### Example 2

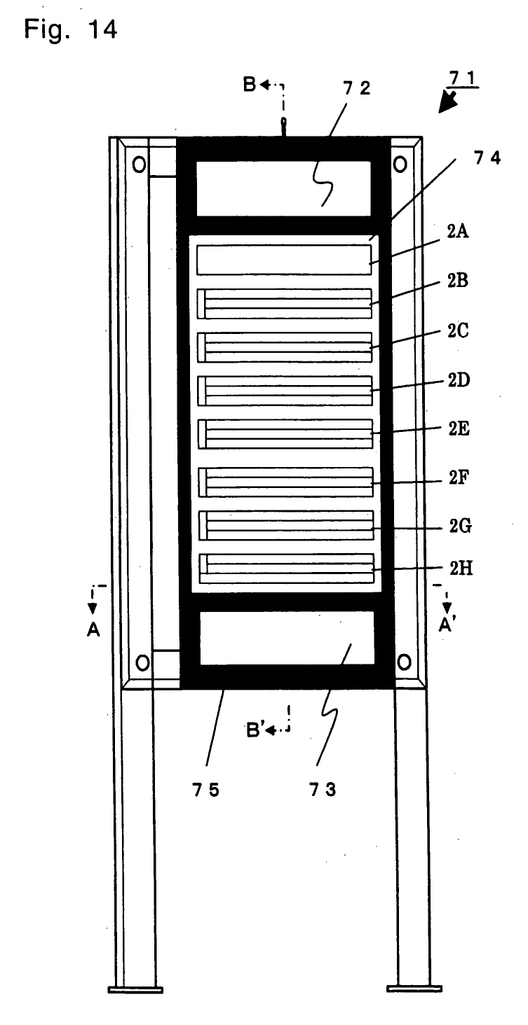

The display device 71 shown in FIG. 14 is designed to be used as a timetable for transportation. The display device has eight display panels of electronic paper, or eight liquid crystal display panels 2A to 2H having a memory effect (hereinbelow, referred to also as the panels) in this example, disposed on a central portion of the entire body thereof. This display device 71 is appropriate to be installed in a station, an airport, a general building, a hotel, an open space, an exhibition hall, a wedding center, an amusement park or the like to display premises information, departure times (arrival times) of transportation, a floor guide, a map of the premises or around the premises, or the like. It should be noted that the basic idea of a display information transmission system with an operation mode having a memory effect has been disclosed by JP-A-2003-316289 in the name of the applicants.

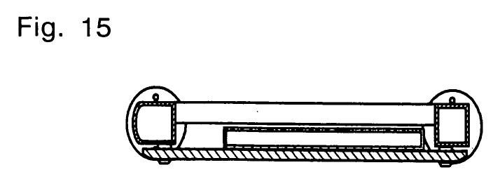

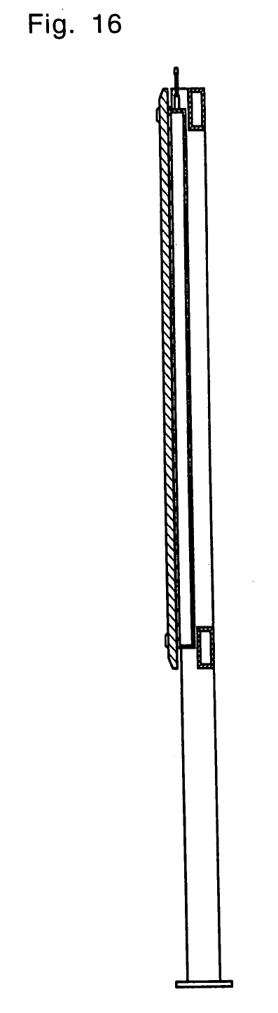

The display device shown in FIG. 14 is of a thin type and has a height of 1,900 mm, a width of 850 mm and a depth of 80 mm. This display device can be conveniently installed at an arbitrary place since it is easy to install the-device by an outer wall and since it is basically unnecessary to use a commercial power source. FIG. 15 is a cross-sectional view taken along line A-A′ in the front view of FIG. 14, and FIG. 16 is a cross-sectional view taken along the line B-B′. A front plate made of a transparent glass sheet is disposed on front sides on two lateral posts, and the display panels are disposed on the rear side of the front plate.

The display device is configured so that a dark color of ceramic coating is disposed around a combination of active areas to form a durable background area 75. The active areas are disposed at three positions of an upper position, a central position and a lower position inside the background area. The upper active area 72 and the lower active area 73 have semi-fixed information displayed therein. For example, a normal printed matter may be put on these areas. The central active area 74 has a plurality of display panels of electronic paper disposed so as to make information variable. The provision of more than three display panels can display a large volume of information, although the number of the display panels varies according to the volume of information. As described above, liquid crystal display panels having a memory effect are particularly preferably used because of low power consumption, high definition display, easy control or the like.

Electronic circuits, such as a power source, display panels, driving circuits, a communication circuit and a control circuit, are housed in a casing disposed on the rear side of the active areas. The display device can have a function of communicating with a remote place to wirelessly communicate with the control center in the remote place through an antenna disposed on the top portion thereof.

This example is characterized in that the display panels of electronic paper are disposed at plural positions, and that the display panels are combined with the printed panels to provide single meaningful display information as a whole. In this case, it is possible to reduce the power required for the entire device by performing display control for variable active area as described above.

Now, a case where such a display device 71 is used as a timetable in a station will be described. The central active area comprises liquid crystal display panels having a memory effect. The panel that is positioned at the top portion in the central active area is set whether the display information is for holidays or weekdays.

The top panel also displays a destination of the transportation line or both stations before and behind the current station. The top panel provides display in plural languages as required. For example, the top panel displays “Holiday Timetable”, “For DEF” and the like on holidays. The top panel displays “Weekday Timetable” and “For DEF” on weekdays. The trade name, the trademark, the logo and the like of the transportation, which displays information, may be also displayed to enhance visual recognition to passengers.

As described, the single display device 71 may be used with a mode wherein the timetables for weekdays is switched into the timetable for holidays and vice versa. Two similar display devices may be combined so that one of the display devices is set to display the timetable for holidays and the other display device is set to display the timetable for weekdays in order to display both timetables for “Holidays” and “Weekdays”. In this case, it is preferred that both display devices be designed so that one of the display devices is disposed to have the entire front side rotated by 180 deg. and that both display devices are combined with each other so as to be side by side. This method is preferred since it is not necessary to prepare another display device having different dimensions and designs.

The active area of each of the seven panels under the top panel may be divided into three rows in the horizontal direction to display the timetable for trains or the like. The timetable for transportation or the like every hour is displayed in each divided row. Hours may be indicated at the left end. The timetable may show the departure times of trains, buses, ships, airplanes or the like.

When the background colors of the respective panels having three rows are set to be different from one another, it is possible to increase the visual recognition by passengers so that the passengers can easily recognize in which part of the entire display the current time is located, and when the next train departs in the current time zone (in the horizontal direction). In this example, the background colors of the area displaying the departure times of trains in the respective divided rows are set to be “white, light blue and white”, “light blue, white and light blue”, “white, light blue and white” . . . “white, light blue, white (blank space)” in this order in the seven panels under the top panel. The leftmost area of the area for displaying the timetables in each of the divided rows serves as an hourly column where hours are indicated in outline characters on a blue background.

On holidays, the “light blue” portions are displayed in “orange”. The departure time of each train (indicated in minutes) is displayed in black on a white or light blue background (an orange background on holidays). The lower two panels may have right end portions set to have a white background so that footnotes, such as “Explanation of Symbols (Abbreviations of Destinations)” are displayed.

On holidays, the background colors may be set as “white, orange and white”, “orange, white and orange”, “white, orange and white” . . . “white, orange and white”. The left area of the area displaying the timetables in each of the divided rows displays outline characters on a deep orange background.

The hourly column may be set as “5, 6, 7”, “8, 9, 10”, “11, 12, 13”, “14, 15, 16”, “17, 18, 19”, “20, 21, 22”, “23, 0, (blank space)” in this order from the upper panel. Thus, it is possible to display the departure times from the first train to the last train. The last divided row has a blank space, and portions for displaying the departure times of trains or the like are set to have a white background.

When trains have different speeds on a line, train types may be shown by allotting black, blue and brown to local trains, rapid trains and express trains, respectively, for example. By adopting such color allocation, it is easy for passengers to visually recognize train types and to understand the timetable data.

The display is provided so that a pixel in a full dot matrix is “about 0.3 mm×about 0.3 mm” and that the gap between adjacent pixels is 0.01 mm. The display is provided by using a high density and high definition of chiral nematic liquid crystal display panels having 1,440 dots in width direction and 220 dots in vertical direction. For this reason, it is possible to realize extremely good and high quality display. Obviously, the pixel size, the aspect ratio of the panels, the number of total pixels and the like may be designed and manufactured so as to have a desired display performance as required in the range of applicable manufacturing techniques and materials. The panels thus designed may be incorporated in the display device according to the present invention.

The technique disclosed in JP-A-2003-315763 may be applied to the liquid crystal display panels having a memory effect. Even when each of the liquid crystal display panels comprises a combination of two display panels, it is possible to attain good multicolor information and to simplify the structure of the entire system by the dithering method. Three display panels may be combined to provide full color display.

When rewriting information, each of the panels is driven to rewrite information as stated above. By adopting such operation, it is possible to reduce the power simultaneously consumed in the entire system and to make the size and the capacity of the power source circuit compact.

Now, a case where the display device according to the present invention is applied to guide information in a building will be described. In this case, the display device is used as a guide plate installed at the inlet of a building or in the vicinity of an information disk in the building. In the active area of the display device described in connection with the above-mentioned example, the names of the corporations or the organizations on the each floors in the building are shown.

Or, the names of the corporations or the organizations may be displayed in alphabetical order. The entire active area may be partly allotted to a display area for specific information so that specific information can be displayed. Such information may be colored or bordered to be highlighted, increasing the visual recognition to passengers.

For example, the display device according to the present invention is appropriate to timely display an event to be held on a day basis or a weekly basis in the building or the local area, for example. For example, when a corporation or an organization in the building moves, it is possible to easily cope with the change in information caused by the move. This is because the display device uses a display-variable electronic paper display panel. Although the respective examples have been described about a case where eight successively disposed display panels are used, a smaller number of display panels may be used. For example, four successively disposed display panels may be used. When four successively disposed display panels are used as a timetable, the timetable for several hours, instead of the timetables for a full day, may be displayed, and information may be timely rewritten, for example. As described above, in accordance with the present invention, it is easy to perform rewriting.

### Example 3

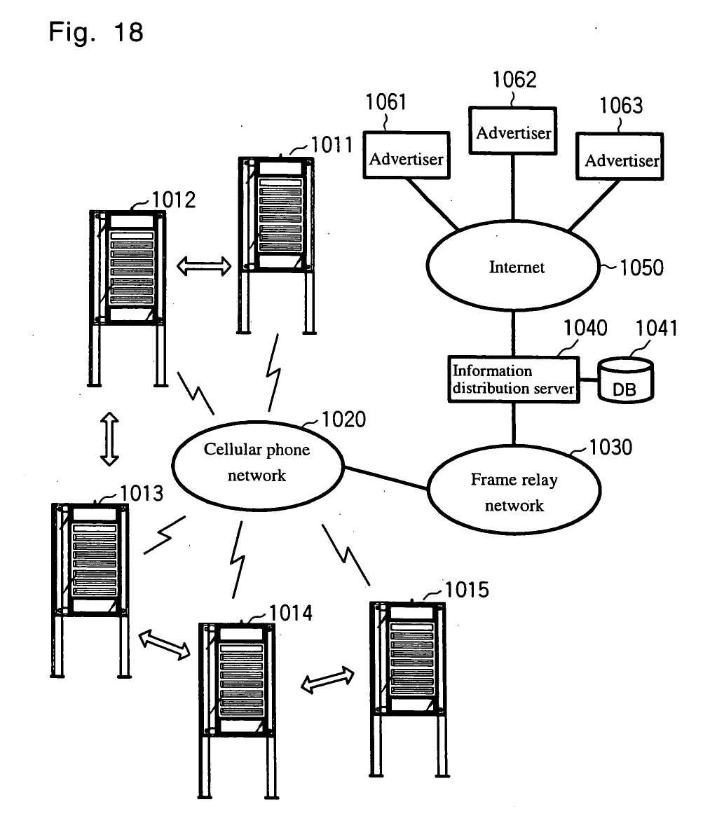

FIG. 18 is a block diagram showing an example of the structure of the information display system according to the present invention. Explanation will be made about a system, which comprises display devices capable of displaying the departure timetable for trains and advertising information. Terminal units 1061, 1062 and 1063, which are owned by the provider of the timetable or the advertiser, are connectable to an information distribution server (display control server) 1040 via the Internet 1050. Although only the three terminal units 1061, 1062 and 1063 are shown in FIG. 18, the number of the terminal units is not limited to three. The information distribution server 1040 is installed in an information provider for display or a company working as an agent for the information provider, for example. The terminal units 1061, 1062 and 1063 comprise personal computers or work stations, for example.

The information distribution server 1040 stores data in a database 1041 based on information transmitted from the terminal units 1061, 1062 and 1063 via the Internet 1050 and changes display data stored in the database 1041. Each of the terminal units 1061, 1062 and 1063 has a Web browser installed therein to browse a Web page. Each of the terminal units may comprise a PDA or a cellular phone. When each of the terminal units comprises a PDA or a cellular phone, a user may access the information distribution server 1040 via a telephone network instead of the Internet 1050.

The information distribution server 1040 transmits information to display devices 1011 to 1015 via a frame relay network 1030 or a cellular phone network 1020, for example. Although only the five display devices 1011 to 1015 are shown in FIG. 18, the number of the display devices in the system is not limited to five and may be arbitrarily set. For example, a cellular phone network operating company, which operates the cellular phone network 1020, or a company working as an agent for the cellular phone network operating company has a server installed therein to communicate with the information distribution server 1040 via the frame relay network 1030. The server is connected with a packet switch (hereinbelow, referred to as the switch) in a cellular phone network (in particular, a packet network) 1020. The switch transmits and receives data between itself and a base station in the cellular phone network 1020. The server may be configured so as to be connected to the packet network, not through the switch. There are many base stations existing in the cellular phone network 1020.

When the server, which communicates with the information distribution server 1040, has received, via the frame relay network 1030, information to display and information to specify the display device as the information destination, the server transmits the information to display to the display device as the information destination through the base station closest to the display device as the information destination. Such operation will be simply expressed by the phrase “the information distribution server 1040 transmits information to a display device via the cellular phone hetwork 1020” in some cases. When the server receives information from a display device through a base station, the server transmits the information to the information distribution server 1040 via the frame relay network 1030. Such operation will be simply expressed by the phrase “a display device transmits information to the information distribution server 1040 via the cellular phone network 1020” in some cases.

The data (display data), which correspond to the information currently displayed by the respective display devices 1011 to 1015, are stored so as to be mapped to the respective display devices 1011 to 1015 in the database 1041. When all display devices 1011 to 1015 display the same information, one kind of display data are stored in the database 1041.

The display data in the database 1041 may be of a bitmap format or a data compression format, such as JPEG or GIF. The display data may be of a file format, which is used by specific imaging application software. The system may be configured so that the database 1041 stores only text data, and the information distribution server stores data written in a certain display format (such as a title or a border). In the latter case, the information distribution server 1040 prepares display data by using text data stored in the database 1041 and data in the display format stored in itself. Display data are transmitted to the terminal units 1061, 1062 and 1063, being contained in a Web page, on change request from the terminal devices 1061, 1062 and 1063. From this point of view, it is preferred that the database 1041 store display data in the HTML format or the XML format along with display data written in any one of the above-mentioned data formats or only display data written in the HTML format or the XML format, instead of display data written in any one of the above-mentioned data formats.

The information distribution server 1040 forms a distribution control system, which prepares changed display data in response to a display information change command received from any one of the terminal units 1061, 1062 and 1063 and transmits the changed display data to the display devices 1011 to 1015 through the cellular phone network 1020. Each of the display devices 1011 to 1015 has a cellular phone adapter incorporated therein to be communicable with the information distribution server 1040 via the cellular phone network 1020. The cellular phone adapter is one which makes communication control for communication via the public cellular phone network.

In the system configuration shown in FIG. 18, each of the display devices 1011 to 1015 includes a local communication means. The display devices 1011 to 1015 can communicate with one another through their local communication means. An example of the local communication means is a bluetooth module, which makes communication in Bluetooth (trademark). A wireless LAN base station may be installed at a place, which is wirelessly communicable with the display devices 1011 to 1015. In that case, the local communication means comprises a wireless LAN module which makes communication with a display device through the wireless LAN base station.

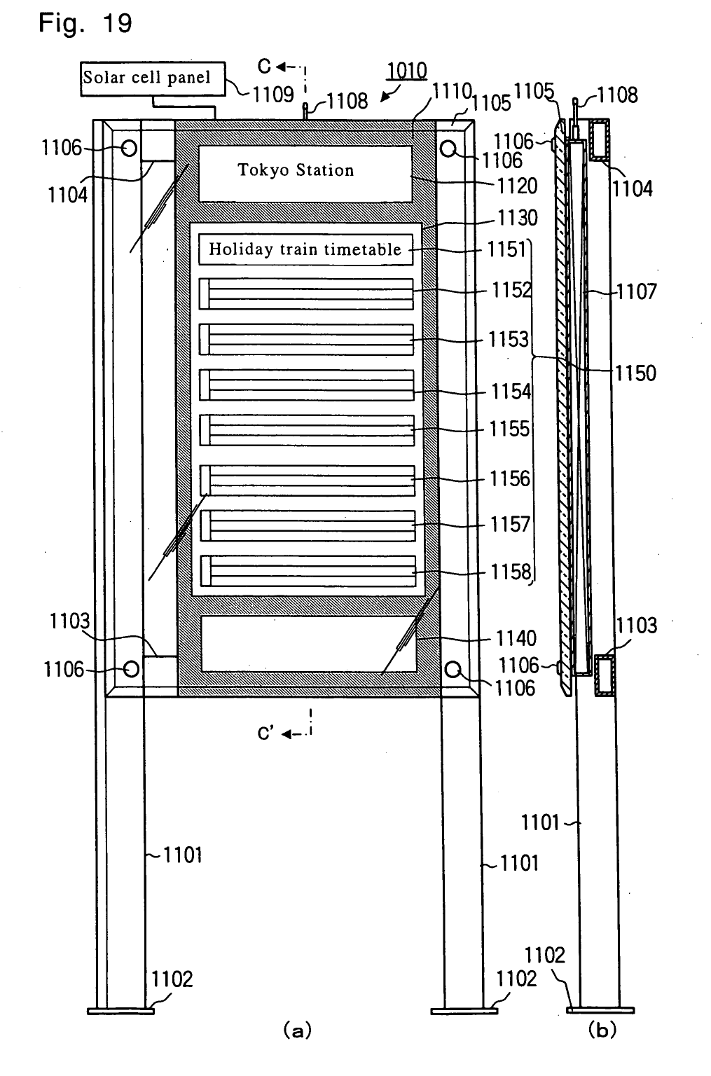

FIG. 19(A) is a front view schematically showing the display device 1010. FIG. 19(B) is a cross-sectional view taken along the line C-C′. The display device 1010 has the same structure as the display devices 1011 to 1015. The display device includes a rectangular frame, which comprises two metal posts 1101 and metal beams 1103 and 1104 coupled to the two posts. The display device has a transparent front glass sheet 1105 coupled to the posts 1101 by bolts 1106. Each of the posts 1106 has a bottom portion formed with a baseplate 1102 to install a casing on a flat surface, such as the ground or the platform surface of a station. The front glass sheet 1105 may be fixed on a wall surface, instead of being installed on the ground or the like to the post 1101. The front glass sheet may be disposed so as to be suspended from a ceiling or the like or be fit into a recess formed on a wall surface or the like.

The front glass sheet 1105 may have a transparent film disposed on a front side and/or a rear side for antireflection. It is preferred that the transparent film comprise a transparent fluorine film, such as a film commercially available under the name ARCTBP (trademark). The transparent film also serves as a protective film. A module 1107 comprises a metal casing with liquid crystal display panels, their peripheral circuits, power source circuits and the like housed therein.

As viewed in the front elevation, the front glass sheet 1105 has a dark color ceramic coating 1110 disposed on the rear side, the coating having cut-out portions formed at totally three portions (an upper display area 1120, a central display area 1130 and a lower display area 1140). The module 1107 has the liquid crystal display panels disposed in an area corresponding to the central display area 1130. Each of the upper display area 1120 and the lower display area 1140 has a printed panel disposed on the rear side on the front glass sheet 1105. The printed panel has a station name, a route map, an advertisement or the like shown thereon. Instead of such a printed panel, a liquid crystal display panel may be disposed in each of the upper display area 1120 and the lower display area 1140. In the area corresponding to the central display area 1130, liquid crystal display panels (hereinbelow, referred to also as the panels) 1151 to 1158 are disposed. In this example, the liquid crystal display panels 1151 to 1158 form a timetable display portion 1150. The front glass sheet 1105 has the liquid crystal display panels 1151 to 1158, and the module 1107 with circuit blocks (not shown) for communication control and display control disposed on the rear side. The module 1107 has an antenna 1108 disposed on an upper portion to communicate with a base station. FIGS. 19(A) and (B) show a solar cell panel 1109, which generates power for the module 1107.

The liquid crystal display panels 1151 to 1158 comprise liquid crystal panels having a memory effect, for example. The memory effect is a property of being capable of holding display information with the driving voltage being set at substantially 0 V. An example of the display panel having a memory effect is a cholesteric or chiral nematic liquid crystal display panel (hereinbelow, referred to also as CL-LCD).

A CL-LCD is driven, having a phase transition mode. The phase transition mode means that a display device is stable in at least two phases of a planer state wherein incident light is partly selectively reflected (hereinbelow, referred to as the PL state) and a focal conic state wherein incident light is scattered (hereinbelow, referred to as the FC state), and that a liquid crystal can be selectively transformed into the PL state or the FC state by applying a certain voltage across opposite electrodes.

The display panel having a memory effect may comprise, e.g., an antiferroelectric liquid crystal display panel (hereinbelow, referred to as “AF-LCD”). When monochromatic display having four gray scales is acceptable instead of color display, a microcapsule electrophoretic display panel may be utilized. However, it is preferred that each of the liquid crystal display panels in the module 1107 comprise a CL-LCD, which can reduce power consumption and display a multi-color image. Now, explanation will be made on a case where each of the liquid crystal display panels in the module 1107 comprises a CL-LCD.

In the timetable display portion 1150, each of the liquid crystal display panels (hereinbelow, referred to also as chiral nematic liquid crystal display panels) 1151 to 1158 has dimensions of 440 mm in width and 68 mm in length, for example. The chiral nematic liquid crystal display panels 1151 to 1158 are disposed so as to leave a spacing of about 25 mm between adjacent chiral nematic liquid crystal display panels.

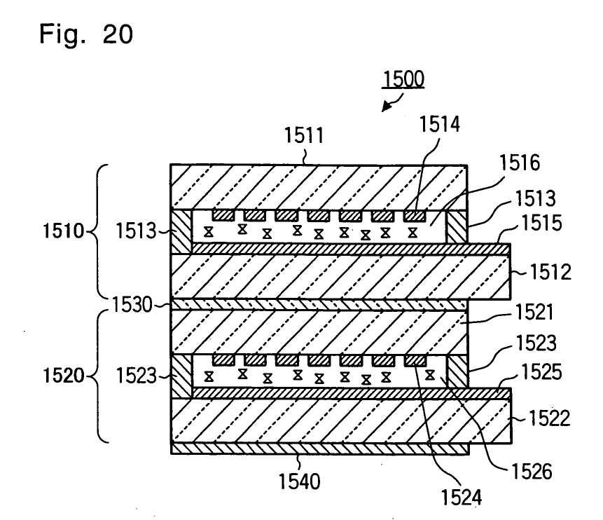

FIG. 20 is a schematic cross-sectional view showing a liquid crystal display panel 1500 which comprises two layers of CL-LCDs laminated therein. The liquid crystal display panel 1500 corresponds to each of the chiral nematic liquid crystal display panels 1151 to 1158 shown in FIG. 19 and each of the chiral nematic liquid crystal display panels disposed in the portions serving as the upper display area 1120 and the lower display area 1140. In order to drive a CL-LCD, it is usual to use passive matrix addressing. In a first layer 1510, a first substrate 1512 with row electrodes 1515 disposed thereon and a second substrate 1511 with column electrodes 1514 disposed thereon are disposed so as to confront each other so that the electrode surfaces on one of the substrates orthogonally overpass the electrode surfaces on the other substrate. The first substrate 1512 and the second substrate 1511 are bonded together through a peripheral seal 1513. The first substrate 1512 and the second substrate 1511 have a cell gap formed therebetween to house a chiral nematic liquid crystal layer 1516 therein.

The second substrate 1511 has a group of lead electrodes disposed thereon. The column electrodes 1514 on the second substrate 1511 are directly connected to respective related electrodes in the group of lead electrodes. The row electrodes on the first substrate 1512 are connected to respective related electrodes in the group of lead electrodes through transfer materials, such as conductive beads, contained in the periphery seal 1513. The group of lead electrodes may be formed on each of the first substrate 1512 and the second substrate 1511 without use of transfer materials.

In the second layer 1520, a first substrate 1522 with row electrodes 1525 formed thereon and the second substrate 1521 with column electrodes 1524 disposed thereon are disposed so as to confront each other so that the electrode surfaces on one of the substrate orthogonally overpass the electrode surfaces on the other substrate. The first substrate 1522 and the second substrate 1521 are bonded together through a peripheral seal 1523. The first substrate 1522 and the second substrate 1521 have a cell gap formed therebetween to house a chiral nematic liquid crystal layer 1526 therein.

The second substrate 1521 has a group of lead electrodes disposed thereon. The column electrodes 1524 on the second substrate 1521 are directly connected to respective related electrodes in the group of lead electrodes. The row electrodes 1525 on the first substrate 1522 are connected to respective related electrodes in the group of lead electrodes through transfer materials, such as conductive beads, contained in the peripheral seal 1523. The group of lead electrodes may be formed on each of the first substrate 1522 and the second substrate 1521 without use of transfer materials. The first substrate 1522 has a colored layer 1540 formed on a rear side thereof, the colored layer comprising applied lusterless black paint. The first layer 1510 and the second layer 1520 are bonded together by a transparent adhesive layer 1530.

Description will be make, taking the first layer 1510 as an example. By applying a voltage across a row electrode 1515 and a column electrode 1514 disposed so as to confront each other, the chiral nematic liquid crystal layer 1516 is driven to control the transition of its phase state, displaying information. A CL-LCD can display information without the use of a polarizer. The CL-LCD can hold information even if power is turned off after being set in a certain display state by applying a voltage to the group of lead electrodes on the second substrate 1511 once. An AF-LCD needs to have a holding voltage applied to hold a display state. The display panel having a memory effect may comprise an electrophoretic panel (see JP-A-2001-500172).

In the CL-LCD, it is possible to transfer a held display state into the other display state by applying a certain voltage again. In this time, it is preferred that a voltage required for next information be applied after having erased all the latest display information. In other words, it is preferred from the viewpoint of practical use that the latest display information be rewritten into-new information after the latest display information has been completely erased. It is usual to display desired information by bringing the entire chiral nematic liquid crystal layer into the PL state to display a selective reflection color, and by bringing the entire layer into the FC state to set the layer in a slightly scattering state to display a lusterless color (black paint) on the rear side (see, e.g., JP-A-2001-337314).

In this example, the CL-CLD has a two-layer structure, which uses chiral nematic liquid crystal display panels having selective reflective wavelengths in a complimentary color relationship. In this example, the CL-LCD is configured so that the respective selective reflection wavelengths of the liquid crystal cells in the two-layer structure are determined so as to emit four colors of white, black, blue and orange in this order from the front side. It is acceptable to display, e.g., other four colors, brown, dark blue, gray and light blue, in addition to the above-mentioned four colors. The is pixels corresponding to the dot matrix of the panel can freely modify display. The color data of the respective pixels of a color image may be preliminarily subjected to software processing to be transformed so as to produce image data suited to certain multi-color display in the chiral nematic liquid crystal display panel.

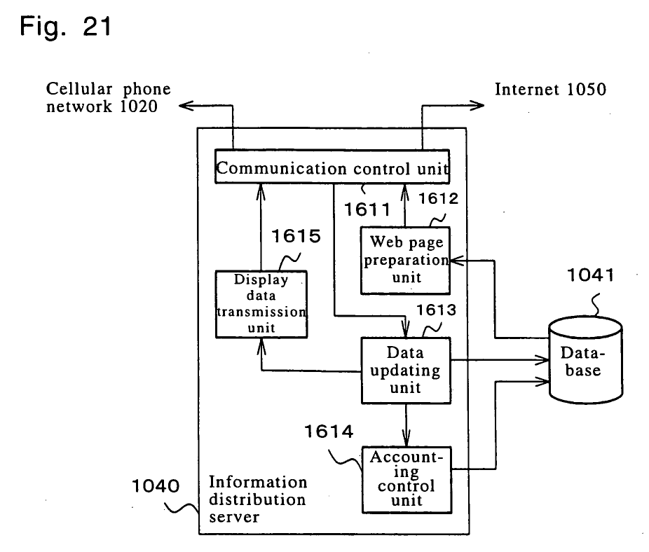

FIG. 21 is a block diagram showing an example of the functional structure of the information distribution server 1040 along with the database 1041. The database 1041, which serves as a memory unit, may be incorporated in the information distribution server 1040. A communication control unit 1611 performs not only protocol control and the like in communication via the Internet 1050 but also protocol and the like in communication with the server in the cellular phone network 1020 through the frame relay network 1030.

A Web page preparation unit 1612 prepares a Web page so that the operators at the terminal units 1061 to 1063 can input information indicating a changed portion in display information and amended data, and the Web page preparation unit outputs the Web page to the communication control unit 1611. Description will be made, taking a timetable or an advertisement as the display information as an example. For example, the Web page preparation unit 1612 prepares a Web page containing a timetable or the data of advertising information already stored in the database 1041, and provides the Web page to the terminal units 1061 to 1063 through the communication control unit 1611. Now, description will be made, taking, as an example, a case where the terminal unit 1061 and the information distribution server 1040 communicate each other.

The Web browser in the terminal unit 1061 displays the Web page on the display portion of the terminal unit 1061. When an operator inputs a change command (a changed portion and amended data on the changed portion) in the Web page, the Web browser transmits the change command to the information distribution server 1040. In the information distribution server 1040, the change command transmitted from the terminal unit 1061 is received by a data updating unit 1613 through the communication control unit 1611. The data updating unit 1613, which serves as a means for changing display information, changes the display information stored in the database 1041, according to the change command. The amended display data are output to a display data transmission unit 1615.

The display data transmission unit 1615 converts the data format of the display data into a data format acceptable to the display devices 1011 to 1015, if needed. For example, when the display devices 1011 to 1015 are configured to receive display data in the JPEG format, i.e., when the display devices have a function of converting data in the JPEG format into bitmap data, the display data transmission unit 1615 converts the data format of display data input from the data updating unit 1613, into the JPEG format. The display data, which have been subjected to data format conversion, are output to the communication control unit 1611. The communication control unit 1611 transmits the display data to the server in the cellular phone network 1020 through the frame relay network 1030.

When the data updating unit 1613 has changed display data, the data updating unit notifies an accounting control unit 1614 of the change. The database 1041 has memory areas allotted to the respective display devices 1011 to 1015 to serve as an accounting information memory for storing accounting data on the respective display devices or respective groups containing some of the display devices. For example, the respective display devices 1011 to 1015 installed in a station in a railroad company form a single group, or all display devices in a single railroad company form a single group. Obviously, the memory areas may be allotted to store accounting data corresponding to all of the respective display devices in a single railroad company.

The accounting system may comprise a system with basic charge and volume-based charge combined, for example. Specifically, the basic charge for one month or one year is fixed, and a certain amount of charge is added to the basic charge whenever a change in display data is made. The memory areas for storing the accounting data stores the accounting data indicating the total charge for a certain period of time (such as one month or one year). When the accounting control unit 1614 is notified by the data updating unit 1613 that a change in display data has been made, the value corresponding to a certain charge is added to the accounting data in the memory area. A person in charge in the information display provider outputs the accounting data stored in the memory area, from the memory area whenever the certain period of time has passed. The person charges the owner of the display devices or the renter of the display devices for a fee corresponding to the accounting data.

It should be noted that in the structure shown in FIG. 21, the Web page preparation unit 1612, the data updating unit 1613, the accounting control unit 1614 and the display data transmission unit 1615 may be realized the CPU of the information distribution server 1040, which operates according to a program. The communication control unit 1611 may be realized by a communication device and the CPU of the information distribution server 1040, which operates according to a program. The Web preparation unit 1612 and the communication control unit 1611 form a Web page transmission means for transmitting a Web page to the terminal units 1061 to 1063. The data updating unit 1613 is an example of the means for changing display information, which prepares amended display data. The display data transmission unit 1615 and the communication control unit 1611 form an amended-display-data transmission means, which transmits amended display data to the server.

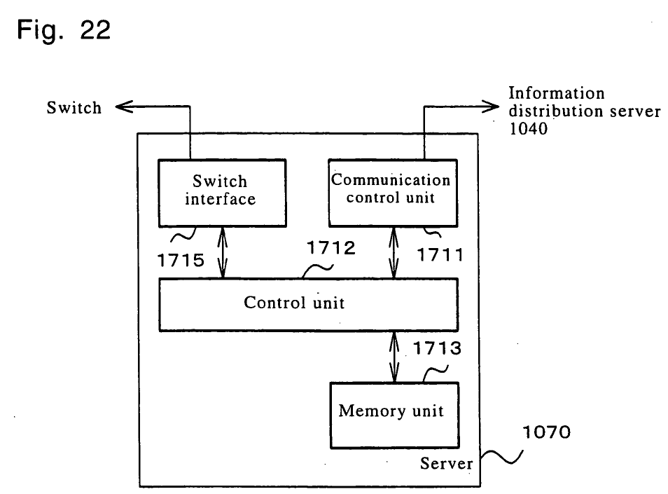

FIG. 22 is a block diagram showing an example of the construction of the serves in the cellular phone network 1020. A communication control unit 1711 performs, e.g., protocol control in communication with the information distribution server 1040 through the frame relay network 1030. A control unit 1712 receives, through the communication control unit 1711, the amended display data transmitted from the information distribution server 1040, and temporarily stores the received display data in a memory unit 1713. The memory unit 1713 has memory areas allotted therein so as to correspond to the respective display devices 1011 to 1015. The control unit 1712 stores the amended display data transmitted from the information distribution server 1040, in the memory area corresponding to the display device to display the amended display data. A command to designate what processing should be performed by the control unit of that display device is also stored in the memory unit 1713. Such a command is transmitted to the server 1070 from the terminal units 1061 to 1063 through the information distribution server 1040, for example.

A switch interface 1715 performs, e.g., protocol control in transmission of data to the switch. The switch interface 1715 serves as a gateway for connecting the server 1070 to the cellular phone network 1020.

In the structure shown in FIG. 22, the control unit 1712 may be realized by the CPU of the server 1070, which operates according to program. The communication control unit 1711 and the switch interface 1715 may be realized by a communication device and the CPU of the server 1070, which operates according to a program.

The respective display devices 1011 to 1015, which exist in the system, may be configured so that at a preset time, the respective display devices access to the server 1070 through the cellular phone network 1020 to download a command or display data stored in the memory unit 1713 of the server 1070. In that case, the display devices 1011 to 1015 may be configured so as to modify the preset time in response to a command after having been put in service.

When the display devices 1011 to 1015 are configured so as to access the server 1070 at a preset time, a user may set up a time window for performing preset communication (a time zone for the respective display devices to be allowed to access the server 1070). There is no limitation to the number of the time windows per day. The display devices 1011 to 1015 may transmit its own information (such as a temperature and a cell voltage detected by a build-in data logger) to the information distribution server 1040 to the server 1070, e.g., once a day, after having been put in service. When the occurrence of an unusual situation is detected, a system administrator is notified of it in order to take appropriate measures. When a user wants to amend display information, the user can output the information from the distribution server 1040. It is acceptable to charge a user for a fee corresponding to additional operation based on the number of communication via the frame relay network 1030. The system is configured so that no display data are transmitted in a normal state. The system is configured so that display data are transmitted to the display devices 1011 to 1015 only at the situation set by the user.

When there are too many display devices installed, the time windows for allowing the respective display devices to effect a display change may be preliminarily shifted one after another so that the respective display devices can receive display data from the distribution server 1070 one after another.

Each of the display devices 1011 to 1015 may transmit information to and receive information not only from the server side through a communication channel but also from an external device interface attached to the respective display devices 1011 to 1015 (such as an interface according to the USB (Universal Serial Bus) standard). In other words, the display devices may receive various kinds of commands from an external device connected through the interface or transmit various kinds of data to the external device through the interface.

Although this example is configured so that display data supplied to the display devices 1011 to 1015 are once stored in the server 1070, the display data may be supplied directly from the information distribution server 1040, not through the server 1070. In that case, the server 1070 is not needed. The display devices 1011 to 1015 directly communicate with the information distribution server 1040 via the cellular phone network 1020 and the frame relay net work 1030. Now, description will be made about a case where the distribution devices 1011 to 1015 communicate directly with the information distribution server 1040 through a transmission channel without the server 1070 existing.

In order to reduce the power consumption for running each of the display devices 1011 to 1015, the control system is divided into a power control system, a circuit for a main power source and a liquid crystal display panel driving system. When the main power switch disposed in each of the display devices 1011 to 1015 is turned on, only the power control system is energized (is supplied with power) in a normal state (information is displayed without any event occurring in connection with the control for each of the display devices 1011 to 1015). In other words, when the main power switch disposed in each of the display devices 1011 to 1015 is turned on, the power control system is constantly energized. If an event occurs in connection with the control for the display devices 1011 to 1015, the main power circuit is energized to be set in an active state. If the event in connection with the control for the display devices 1011 to 1015 also needs to rewrite display information on a liquid crystal display panel, the liquid crystal display panel driving system is also energized.

Each of the display devices 1011 to 1015 includes secondary cells 1401 in order that the display devices 1011 to 1015 can semipermanently run even without being supplied with power from outside. The solar cell panel 1109, which charges the secondary cells 1401 one by one, is installed so as to have the panel surface facing outward. The solar cell panel 1109 may comprise, e.g., one having an efficiency of 0.5 A/1,000 lux. When the solar cell panel comprises one having an efficiency of 0.5 A/1,000 lux, it is preferred that the maximum consumption current in the power control system constantly energized, be 500 μA or below and that the maximum consumption current be 1 A or below when the liquid crystal display panel driving system is also energized.

The power source system is not limited to a system where the secondary cells are charged by the solar cell panel. The power system may comprise a system where only primary cells are used. When only primary cells are used, the power source system comprises one pack of (27 primary cells comprising three cells connected in series)×(9 primary cells connected in parallel), each of the cells having 2.2 A (3 V), for example. One pack has dimensions of about 142 mm×156 mm×19 mm. When the primary cells are connected in series and parallel, the power source has an output of 19.8 Ah (an output of 9 V).

In a case where only primary cells are used and where each of the display devices comprises eight successively disposed panels coupled in series (such as panels as in the chiral nematic liquid crystal display panels 1151 to 1158), when rewriting of information is started by a semiautomatic timer once a day, the display devices can continuously run for about one year. When the power pack is exchanged for a new one in one year, the display device can continue automatic operation after that. The power pack may be easily exchanged through a cover provided in, e.g., a top surface of the casing of each of the display devices 1011 to 1015. When the frequency of rewriting is once a day, each of the display devices can be surely used with maintenance-free operation, e.g., for half a year or longer, or one year or longer. The type of and the number of the primary cells may be determined, according to a desired use condition in consideration of the nominal voltage, the discharge capacity, the output density, the self-discharge and variable factors under use environment.

In this example, the secondary cells and the solar cell panel are combined. The reason is as follows. It is difficult to maintain a required working voltage by supplying power only from the secondary cells since a voltage drop is caused by self-discharge in the secondary cells. In order to cope with this problem, each of the display devices is configured to charge the secondary cells with the solar cell panel. For example, the secondary cells comprise lithium polymer cells having an output of about 1,200 mAh at 7.4 V or about 3,450 mAh at 7.4 V. The rated output voltage is 7.4 V.

The specifications for the solar cell panel are set to have a rated output of 500 mA, for example. When outdoor light has about 1,000 lux, the nominal maximum output voltage (Vpm) is 10.0 V, and the nominal maximum operating current is 4.5 mA (both values are estimated values). Accordingly, when the frequency of rewriting is once a day, the display devices can substantially continuously run. For example, in a case where each of the display devices comprises eight successively disposed panels, when rewriting is automatically done once a day by a timer, each of the display devices can continuously run. In other words, it is possible to practically realize automatic operation in a continuous way. This power source system can be applied to the display devices 1011 to 1015 according to the present invention since it is possible to easily obtain light of about 1,000 lux even with general outdoor light.

If it is possible to more positively replenish the secondary cells with power by outdoor light, it is possible to increase the frequency of rewriting in the display devices 1011 to 1015. In other words, the display devices can continuously run with display information being rewritten more frequently without being supplied power from the commercial power supply.

When it is necessary to rewrite display information more frequently, it is acceptable to use a local memory, such as a USB memory, or wireless communication to input new display data in the display devices 1011 to 1015 from outside in order to rewrite information displayed on a display panel. When wireless communication is used, power is consumed in an amount corresponding to the number of communication, the time period for communication and the data volume to download. If the secondary cells are replenished with power by the electromotive force of the solar cell panel, the display devices can be caused to continuously run. If it is possible to obtain light of about several thousands of luces, it is possible to perform operation management using wireless communication in a substantially continuous way.

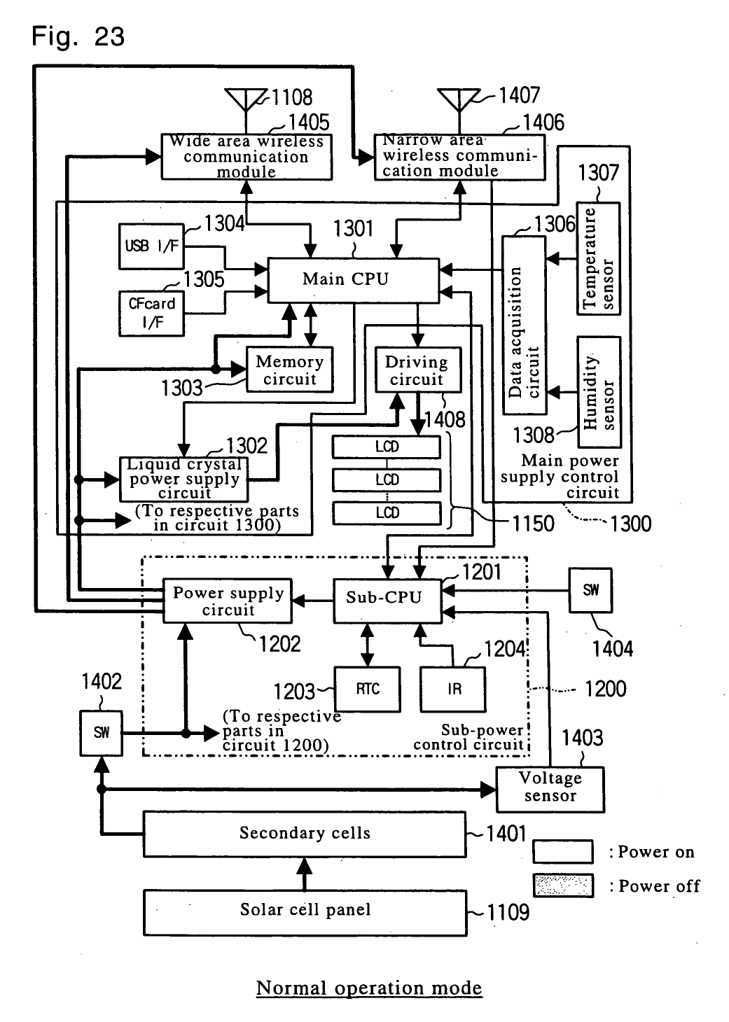

FIG. 23 is a block diagram showing an example of the circuit structure of the electric circuit blocks along is with a timetable display portion 1150 in each of the display devices 1011 to 1015. Although description will be made on the circuit structure of the display device 1011, the circuit structures of the display devices 1012 to 1015 are the same as the circuit structure of the display device 1011.

Although FIG. 23 shows three chiral nematic liquid crystal display panels (LCDs) and a single driving circuit 1408 as an example, all chiral nematic liquid crystal display panels actually include their corresponding driving circuits. The respective driving circuits are connected to a main CPU 1301. The main CPU 1301 provides the respective driving circuit with the display data of a display information to display on relevant chiral nematic liquid crystal display panels.

A wide area wireless communication module (such as a cellular phone adapter) 1405 communicates with a base station in the cellular phone network 1020 through an antenna 1108 and has a transmission distance of several kilometers or above. The wide area wireless communication module 1405 consumes more power in single communication than a narrow area wireless communication module 1406 described later since the wide area wireless communication module has a higher output for communication in a wider transmission range.

The main control unit 1301 is realized a microcomputer (MPU) for example, Hereinbelow, the main control unit will be referred to as the main CPU. When the wide range wireless communication module 1405 receives display data, the main CPU 1301 subjects the display data to data format conversion as required and stores the display data in a memory circuit 1303. The memory circuit 1303 comprises, e.g., a non-volatile flash memory (flash ROM). For this reason, the memory circuit 1303 does not need to be supplied power in the other periods of time than the period of time where display data to store are updated.

The main CPU 1301 provides the display data to the driving circuit 1408 at a certain timing to rewrite the display information on the chiral nematic liquid crystal display panels based on the display data. Rewriting is done as already described. It should be noted that in a case where the information displayed on the plural chiral nematic liquid crystal display panels is updated, when the driving circuit corresponding to a chiral nematic liquid crystal display panel serves to rewrite the chiral nematic liquid crystal display panel, the main CPU 1301 effects control of the driving circuits for the other chiral nematic liquid crystal display panels so as not to activate these driving circuits. In other words, in a case where there are a plurality of display panels having a memory effect (for example, four or more of display panels, or eight display panels as in this example), when the information displayed on one of the display panels is updated, the voltages, which are applied to display electrodes of all other display panels, are turned off, and the information displayed on the respective display panels is rewritten one by one. The display panels may be configured so that when the information displayed on a display panel is rewritten, the information displayed on the other display panels can be held because of the presence of a display function having a memory effect, with the result that the other display panels can be set to be practically prevented from being driven to perform rewriting operation accompanied by power consumption.

It is preferred that the display device 1011 have various kinds of sensors incorporated therein. In FIG. 23, a temperature sensor 1307, a humidity sensor 1308, and a voltage sensor 1403 are shown as examples of the sensors. The temperature sensor 1307 and the humidity sensor 1308 are disposed in the vicinity of the chiral nematic liquid crystal display panels to detect the temperature and the humidity around the chiral nematic liquid crystal display panels. The voltage sensor 1403 detects the output voltage from the secondary cells 1401. In this Example, the outputs from the temperature sensor 1307 and the humidity sensor 1308 are input into the main CPU 1301 through a data accretion circuit 1306. The output from the voltage sensor 1403 is input into a sub-CPU 1201.

In the display device 1011, the main CPU 1301 is connected to one or more interfaces for external devices (local interfaces). In the structure shown in FIG. 23, the main CPU is connected to a CF card interface 1305 containing a socket for plugging a CF (Compact Flash) card in the display device and a USB interface 1304 containing a USB connector. These two interfaces are examples of the interfaces for external device. The display device 1011 may have another interface incorporated therein. In Description, the word “interface” means an interface circuit.

In this example, a CF card or a USB memory can be connected to the display device 1011 since the CF card interface 1305 and the USB interface 1304 are incorporated in the display device 1011. For this reason, it is possible not only to provide various kinds of commands or display data to the main CPU 1301 from the information distribution server 1040 but also to provide commands or display data to the main CPU 1301 through a CF card or a USB memory. The commands or the display data provided to the main CPU 1301 are stored in the flash ROM in the memory circuit 1303.

The main CPU 1301 is also connected to a narrow area wireless communication module (such as a Bluetooth module) 1406. The narrow area wireless communication module 1406 is a module which communicates with the narrow area wireless communication modules 1406 of the other display devices 1012 to 1015 through an antenna 1407. The narrow area communication module 1406 is a wireless communication module having a low output, which has less power consumption in single communication than the wide range wireless communication module 1405.

The narrow area wireless communication module 1406 may include a CPU. When a main power switch 1402 is operated to be set in an ON state, the narrow area wireless communication module 1406 is constantly supplied with power as described later. The communication through the narrow area wireless communication module 1406 is called narrow area communication or local communication. The narrow area communication module 1406 may comprise one which has less power consumption than the wide area wireless communication module 1405 and can be driven over a long period of time by the same capacity as the wide area wireless communication module. Specific examples of the narrow area communication or the local communication include Bluetooth, wireless LAN infrared light communication, acoustic communication and communication using a proximity magnetic field, which have a transmission distance of about several centimeters to several tens of meters.

In this example, a main power circuit 1300 contains the main CPU 1301, the memory circuit 1303, a circuit portion connected to the main CPU 1301 (excluding the driving circuit 1408), the temperature sensor 1307 and the humidity sensor 1308. When the main power circuit is supplied with power, the wide area wireless communication module 1405 is also supplied with power. The driving circuit 1408 is contained in the liquid crystal display panel driving system. The main power circuit 1300 is a circuit, which is not supplied with power until power supply (energization) is started under the control of a power supply circuit 1202. The power supply circuit 1202 starts power supply to the circuit for the main power system when updating information on a chiral nematic liquid crystal display panel and communicating via the cellular phone network.

Secondary cells 1401 may comprise, e.g., nickel hydride cells, lithium-iron cells, lithium-iron-polymer cells or fuel cells. A solar cell panel 1109 is also disposed to receive light so as to generate power, charging the secondary cells one by one.

The display device 1011 includes a circuit for a sub power system 1200 serving as the power control system. The circuit for the sub power system 1200 includes the sub-CPU 1201. The sub-CPU 1201 receives an output signal from a power switch 1404 for the main control unit, an output signal from a clock circuit (real time clock) 1203, an output signal from an infrared light receiving circuit 204 and a signal from the voltage sensor 403, which are disposed in the display device 1011.

The display device 1011 includes the main power switch 1402. When the main power switch 1402 is operated to be set in an ON state, the power from the secondary cells 1401 is supplied to the circuit for the sub power system 1200. When the circuit for the sub power system 1200 is supplied with power, the power supply circuit 1202 provides the narrow area wireless communication module 1406 with power from the secondary cells 1401. When the sub-CPU 1201 sets the power supply circuit 1202 in an energization state (energized state), the power from the secondary cells 1401 is also supplied to the circuit for the main power system 1300 and the wide area wireless communication module 1405.

When the power switch for the main control unit 1404 is manually operated with power being supplied from the secondary cells 1401 to the sub-CPU 1201, the output signal based on the operation is input into the sub-CPU 1201. When the sub-CPU 1201 receives the output signal from the power switch for the main control unit 1404, the s sub-CPU sets the power supply circuit 1202 in the energized state (in such a state that the current from the secondary cells 1401 is also supplied to the circuit for the main power and the wide area wireless communication module 1405). Under such control, it is possible to set the circuit for the main power system 1300 and the wide area wireless communication module 1405 in the active state by operating the power switch for the main control unit 1404.

The clock circuit 1203 not only measures a current time but also outputs a time-up signal, as an output signal, to the sub-CPU 1201 when the current time coincides with a preset time-up time. Also when the sub-CPU 1201 receives the time-up signal from the clock circuit 1203, the sub-CPU sets the power supply circuit 1202 in the energized state. Under such control, the circuit for the main power system 1300 and the wide area wireless communication module 1405 can be set in the active state at the preset time in one day.

The infrared light receiving circuit 1204 may comprise, e.g., a circuit, which has a function of receiving an infrared light signal according to the IrDA (Infrared Data Association) standard. When the infrared light receiving circuit 1204 receives a preset start code through direct communication (communication with neither the wide area wireless communication module 1405 nor the narrow area wireless communication module 1406 being used) from an infrared light transmission circuit (not shown), which is activated by a person in charge or the like, the infrared light receiving circuit outputs an output signal to the sub-CPU 1201. Also when the sub-CPU 1201 receives the output signal is input from the infrared light receiving circuit 1204, the sub-CPU sets the power supply circuit 1202 in the energized state. Under such control, the circuit for the main power source 1300 and the wide area wireless communication module 1405 can be set in the active state when such a person operates a unit with the infrared light receiving circuit incorporated therein. It should be noted that the infrared light receiving circuit 1204 may comprise a light-electricity converter circuit and that the sub-CPU 1204 may be configured to recognize the start code based on an output signal from the infrared light receiving circuit 1204.

The voltage sensor 1403 detects the output voltage of the secondary cells 1401. When the output voltage of the secondary cells 1401 lowers to a predetermined voltage, the voltage sensor outputs an alarm signal. When the voltage sensor 1403 outputs the alarm signal, the sub-CPU 1201 sets the power supply circuit 1202 in the energized state. The sub-CPU 1201 may be configured so that the sub-CPU monitors the value of the output voltage of the secondary cells 1401 through the voltage sensor 1403 and that when the value of the output voltage of the secondary cells 1401 drops to the predetermined voltage, the sub-CPU sets the power supply circuit 1202 in the energized state. Under such control, when the output voltage of the secondary cells 1401 lowers to the predetermined voltage, the main CPU 1301 can display warning information on a chiral nematic liquid crystal display panel, for example.

When the narrow area wireless communication module 1406 receives a certain signal from any one of the other display devices 1012 to 1015, the narrow area wireless communication module 1406 outputs a command signal to the sub-CPU 1201, causing the sub-CPU to set the power supply circuit 1202 in the energized state. The sub-CPU 1201 sets the power supply circuit 1202 in the energized state in response to the command signal. However, the wide area wireless communication module 1405 is not set in a power supply state in this case. Hereinbelow, the state where the power supply circuit 1202 has been set in the energized state in response to the command signal from the narrow area wireless communication module 1406 will also be called a narrow area communication sate (narrow area communication mode). In the narrow communication mode, the main CPU 1301 transmits a request signal to the sub-CPU 1201, requesting to start power supply to the wide area wireless communication module 1405 in some cases. When the sub-CPU 1201 receives the request signal, the sub-CPU causes the power supply circuit 1202 to start power supply to the wide area wireless communication module 1405.

The main CPU 1301 sets a liquid crystal power supply circuit 1302 in the energized state only when updating information on a chiral nematic liquid crystal display panel. When the liquid crystal power supply circuit 1302 has been set in the energized state, the driving circuit 1408 is set in a power supply state.

In this example, the display device 1011 can hold display information even without being supplied power, since the display panels comprise chiral nematic liquid crystal display panels having a memory effect. In other words, when using display panels having a memory effect, the display device 1011 can be made practical because of being substantially maintenance-free in connection with power supply.

Although the chiral nematic liquid crystal display panels can hold display information without the display data being rewritten for a long period of time, it is preferred that the display data be rewritten (refreshed) every certain period of time, such as once a day or once a week. For example, even when the wide area wireless communication module 1405 has received no amended display data in the power supply period, the main CPU 1301 provides the driving circuit 1408 with display data stored in the memory circuit 1303, rewriting the display information on the chiral nematic liquid crystal display panels based on the display data. Although it is supposed that unless amended display data have been received, there is no change in the display information before and after rewriting, it is possible to perform such operation to return the display information to the corrected one if the display information on a chiral nematic liquid crystal panel has been changed for some reason.

Although it is preferred that the antenna 1108 be incorporated in the display device 1011, the antenna is exposed from the display device 1011 when the casing is made of metal. In that case, it is preferred that the antenna 1108 be protected with a cover made of, e.g., a resin.

When the main CPU 1301 has a USB memory or a CF card plugged therein, and when power supply is started, the main CPU receives detection signals of the temperature sensor 1307 and the humidity sensor 1308 from the data acquisition circuit 1306 immediately after acquiring display data or a command from the USB memory or the CF card. The values that are indicated by the detection signals may be written in the USB memory or the CF card. The status information corresponding to the detection value of the voltage sensor 1403 transmitted from sub-CPU 1201 may be written in the USB memory or the CF card.

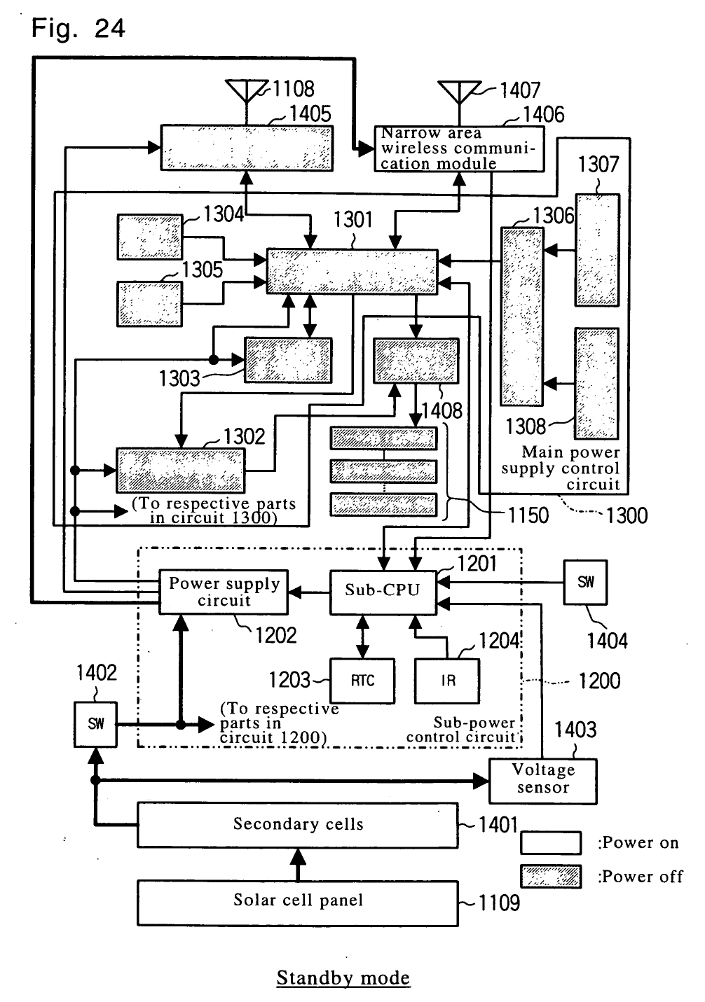

FIG. 24 is a block diagram showing an example of the circuit structure of the electric circuit blocks along with the timetable display portion 1150 in the display device 1011. The contents shown in this figure are the same as those shown in FIG. 23. It should be noted that in FIG. 24, the shaded blocks are blocks, to which no power is supplied. The state shown in FIG. 24 corresponds to a state wherein the power supply circuit 1202 has not been set in the energized state. Hereinbelow, the state shown in FIG. 24 will be also called a standby state (standby mode), and the state shown in 23, i.e., the state with power being supplied to all blocks will also be called a normal operation state (normal operation mode).

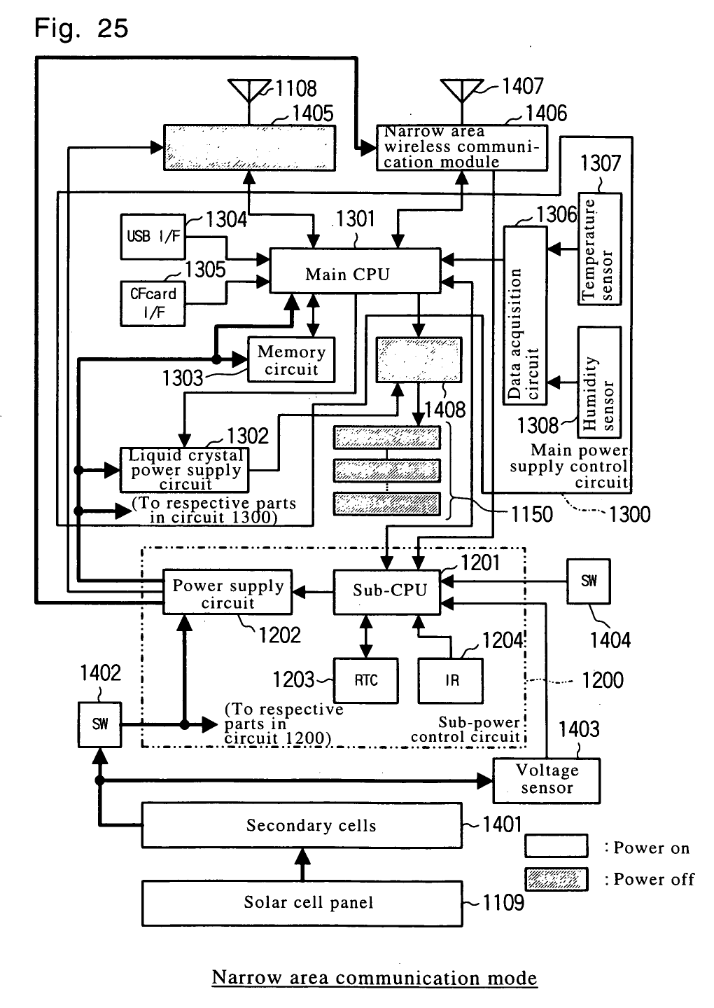

FIG. 25 is a block diagram showing an example of the circuit structure of the electric circuit blocks along with the timetable display portion 1150 in the display device 1011. The contents shown in this figure are the same as those shown in FIG. 23. It should be noted that in FIG. 25, the shaded blocks are blocks, to which no power is supplied. The state shown in FIG. 25 corresponds to a state wherein the power supply circuit 1202 has been set in the energized state in response to the command signal from the narrow area wireless communication module 1406, i.e., in the narrow area communication mode.

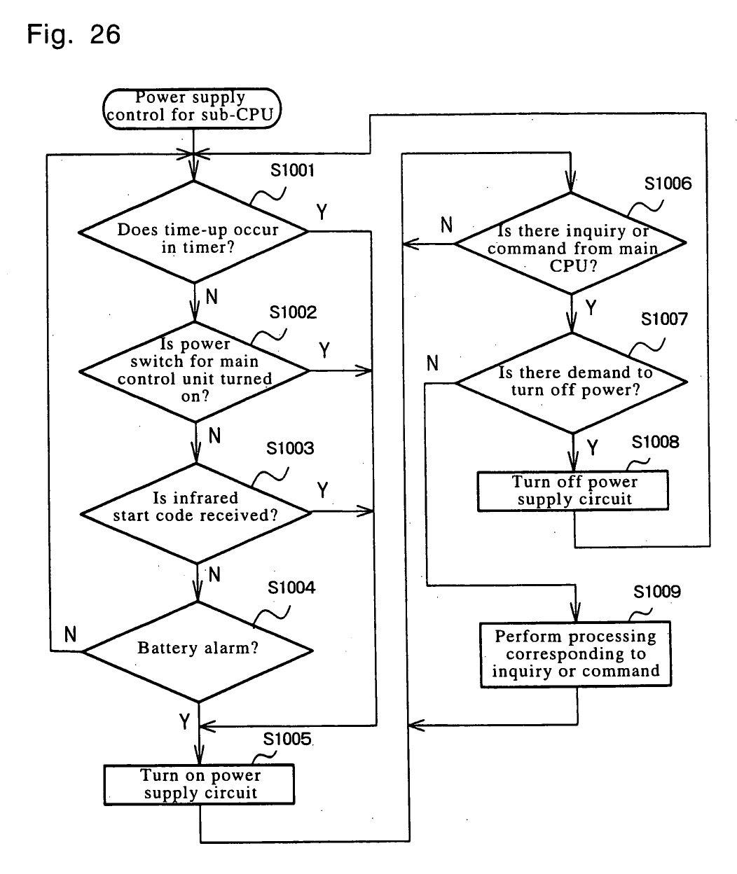

Now, the operation example of the sub-CPU 1201 in the circuit for the sub power system (power control system) 1200 will be described, referring to the flowchart in FIG. 26. In the example shown in FIG. 26, when the clock circuit 1203 notifies the sub-CPU 1201 of time up after power supply has been started by the main power switch 1402 (Step S1001), the sub-CPU turns on the power supply circuit 1202 (sets the power supply circuit in the energized state) (Step S1005). Also when an output signal is output from the power switch for the main control unit 1404 (Step S1002), the sub-CPU 1201 turns on the power supply circuit 1202 (Step S1005). Also when the sub-CPU has recognized through the infrared light receiving circuit 1204 that the start code has been transmitted from the infrared light transmission circuit (Step S1003), the sub-CPU turns on the power supply circuit 1202 (Step S1005).

Also when an alarm signal has been output from the voltage sensor 1403 (Step S1004), the sub-CPU 1201 turns on the power supply circuit 1202 (Step S1005). It should be noted that also when in Step S1004, the sub-CPU 1201 has recognized, based on the value of the output voltage of the secondary cells 1401 obtained through the voltage sensor 1403, that the value of the output voltage of the secondary cells 1401 has lowered to a predetermined voltage, the sub-CPU turns on the power supply circuit 1202. In that case, the sub-CPU 1201 holds the alarm status indicating that the value of the output voltage of the secondary cells 1401 has lowered.

In a case where the sub-CPU receives an inquiry or a command from the main CPU 1301 after that (Step S1006), when the command is a command to turn off power (Step S1007), the sub-CPU 1201 turns off the power supply circuit 1202 (sets the power supply circuit in the deenergized state) (Step S1008). Then, the process returns to Step S1001. By processing of Step S1008, the circuit for the main power system 1300 and the wide area wireless communication module 1405 are set in the deenergized state.

When the sub-CPU receives an inquiry from the main CPU 1301, or when the command received from the main CPU 1301 is not a command to turn off power, the sub-CPU 1201 performs the processing corresponding to the received inquiry or command (Step S1009). Then, the process returns to Step S1006. Examples of the inquiry include an inquiry on the cause of start, an inquiry on the alarm status, and an inquiry on the cause of time-up in the clock circuit 1203. Examples of the processing corresponding to the command include processing to transmit the cause of start to the main CPU 1301, processing to transmit the alarm status to the main CPU 1301, processing to set a current time in the clock circuit 1203 and processing to set the time-up time in the clock circuit 1203.

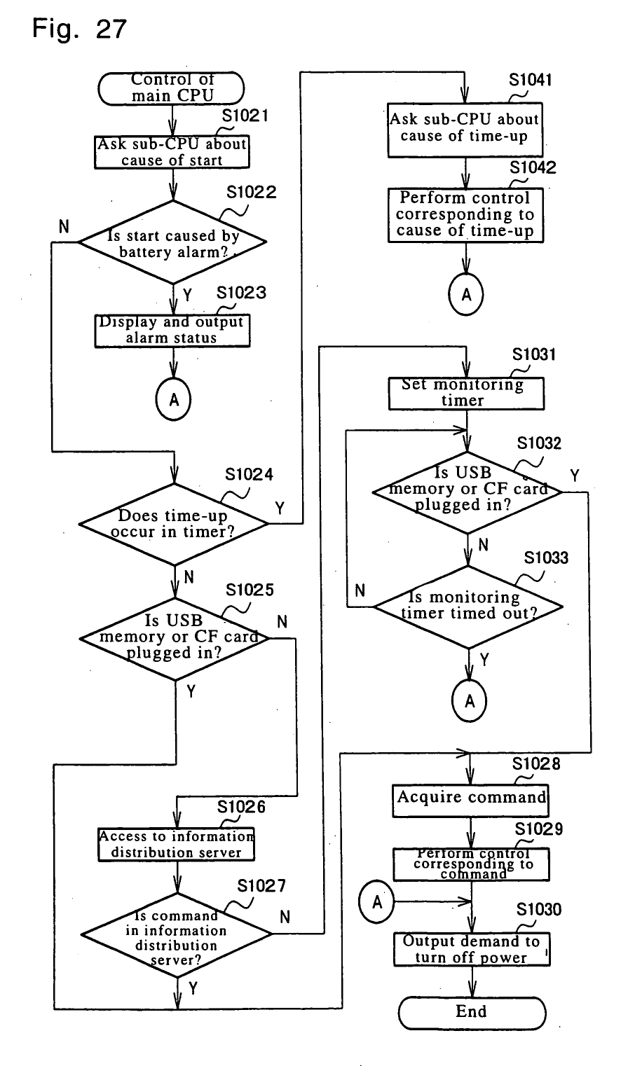

FIG. 27 is a flowchart showing the operation of the main CPU 1301, which is performed since the power supply to the circuit for main power system 1300 has started. In the example shown in FIG. 27, the main CPU 1301 first asks the sub-CPU 1201 about the cause of start, i.e., why the power supply to the circuit for the main power system 1300 has been started (Step S1021). The sub-CPU 1201 transmits the cause of start in Step S1009. Although description will be made on the operation of the main CPU 1301 included in the display device 1011, the operation of the main CPU 1301 in each of the other display devices 1011 to 1015 is the same as that of the main CPU 1301 included in the display device 1011.

When the main CPU 1301 is notified by the sub-CPU 1201 that the cause of start is an alarm signal (containing a case where the value of the output voltage of the secondary cells 1401 has lowered to the predetermined voltage), i.e., when the main CPU is notified that the cause of start is reception of a battery alarm (Step S1022), the main CPU displays an alarm status or a certain warning information in characters as warning, on a chiral nematic liquid crystal display panel. Additionally, the main CPU transmits the alarm status to the information distribution server 1040 through the wide area wireless communication module 1405 or outputs the alarm status in a USB memory or a CF card (Step S1023). Then, the process moves to Step S1030.

It is preferred that the main CPU 1301 ask the sub-CPU 1201 about the alarm status even in the cases other than the case where the power supply to the circuit for the main power system 1300 has started because the alarm signal has been output from the voltage sensor 1403 or because the value of the output voltage of the secondary cells 1401 has lowered to the predetermined voltage.

When the sub-CPU 1201 notifies the main CPU 1301 that the cause of start is reception of the time-up signal from the clock circuit 1203 (Step S1024), the main CPU performs the processing in Step S1041.

When the sub-CPU 1201 notifies the main CPU 1301 that the cause of start is not reception of the time-up signal from the clock circuit 1203, i.e., that the cause of start is reception of the output signal from the power switch for the main control unit 1404 or reception of the start code from the infrared light transmission circuit (Step S1024), the main CPU performs the processing of Step S1025. Also when the narrow area wireless communication module 1406 provides the sub-CPU 1201 with a demand signal to set the power supply circuit 1202 in the energized state, the circuit for the main power system 1300 is activated (power supply starts), although the control of the main CPU 1301 in that case will be described later.

In Step S1025, the main CPU 1301 checks through the USB interface 1304 or the CF card interface 1305 whether a USB memory or a CF card has been plugged in the display device. When a USB memory or a CF card has been plugged in the display device, the main CPU 1301 reads out a command from the USB memory or the CF card (Step S1028). When the main CPU fails to read out a command, it is determined as being “N” in Step S1025. When the main CPU has read out a command, the main CPU performs the control corresponding to the read-out command (Step S1029). Then, the main CPU provides the sub-CPU 1201 with a command to turn off power (Step S1030), ending the operation.

When neither a USB memory nor a CF card has not been plugged in the display device, or when no command is not read out through a plugged memory or card, the main CPU 1301 commands the wide area wireless communication module 1405 to access the information distribution server 1040 (Step S1026). As commanded, the wide area wireless communication module 1405 communicates with a base station through the antenna 1108 to acquire, via the cellar phone network 1020, a command stored in the information distribution server 1040. When no command is stored in the information distribution server 1040, the wide area wireless communication module 1405 cannot acquire any command. When the wide area wireless communication module 1405 has acquired a command, the wide area wireless communication module outputs the acquired command to the main CPU 1301. When the wide area wireless communication module has acquired no command from the information distribution server, the wide area wireless communication module notifies the main CPU 1301 of it.

When the main CPU 1301 receives a command from the wide area wireless communication module 1405, the main CPU performs the control corresponding to the acquired command (Steps S1027, S1028 and S1029). The main CPU provides the sub-CPU 1201 with a command to turn off power (Step S1030), ending the operation.

When the wide area wireless communication module 1405 has notified the main CPU 1301 that the wide area wireless communication module has failed to acquire a command, the main CPU first sets the monitoring timer (Step S1031). The main CPU attempts to read out a command from a USB memory or a CF card until the monitoring timer times out (Steps S1032 and S1033). In a case where before the monitoring timer times out, a USB memory or a CF card has been plugged in the display device, and the wide area wireless communication module has read out a command from the USB memory or the CF card (Steps S1032 and S1028); the main CPU performs the control corresponding to the read-out command (Step S1029). Then, the main CPU provides the sub-CPU 1201 with a command to turn off power (Step S1030), ending the operation. When the monitoring timer has timed out, the main CPU provides the sub-CPU 1201 with a command to turn off power (Step S1030). The processing of Step S1031 to Step S1033 can improve operability since a maintenance person or the like can operate the power switch for the main control unit 1404 before plugging a USB memory or a CF card in the display device, when the main CPU 1301 is caused to read out a command from the USB memory or the CF card. In, e.g., a case where the power switch for the main control unit 1404 is an erroneously operated during the processing of Steps S1031 to S1033 and S 1030, it is possible to prevent the circuit for the main power system 1300 from being energized for a long period of time.

In Step S1041, the main CPU 1301 asks the sub-CPU 1201 about the cause of time-up. Then, the main CPU 1301 performs the control corresponding to the cause of time-up transmitted from the sub-CPU 1201 (Step S1042). In this example, the clock circuit 1230 includes plural timers (for example, five timers). In the clock circuit 1230, the respective timers may be set at different time-up times. For example, the timers may be used so that when a first timer has timed up, first processing (such as refreshing the chiral nematic liquid crystal display panels) is performed, and that when a second timer has timed up, second processing (such as outputting the alarm status) is performed.

When a start is caused by a time-up signal from the clock circuit 1203, the main CPU 1301 performs the processing according to the processing contents stored in the memory circuit 1303 unlike in the case where a start is caused by receipt of an output signal from the power switch for the main control unit 1404 or where a start code has been transmitted from the infrared light transmission circuit. In other words, when a start is caused by a time-up signal from the clock circuit 1203, the main CPU 1301 performs neither to read out a data from a USB memory or a CF card nor to access the information distribution server 1040. The processing contents, which are performed when each of the timers in the clock circuit 1203 has timed up, are stored in the flash ROM contained in the memory circuit 1303.

Then, the main CPU provides the sub-CPU 1201 with a command to turn off power (Step S1030).

Under the above-mentioned control, the circuit for the main power system 1300 can be caused to perform the preset processing at a preset time in a day. In response to operation by a maintenance person or the like, the circuit for the main power 1300 can be activated to input a command from a USB memory, a CF card or the information distribution server 1040, into the main CPU 1301. As is clear from the above-mentioned description, when a maintenance person or the like wants to acquire a command from the information distribution server, he or she may operate the power switch for the main control unit 1404 or provide a start code to the display device 1011 from a unit with the infrared light transmission circuit incorporated therein, without plugging a USB memory or a CF card in the display device 1011.

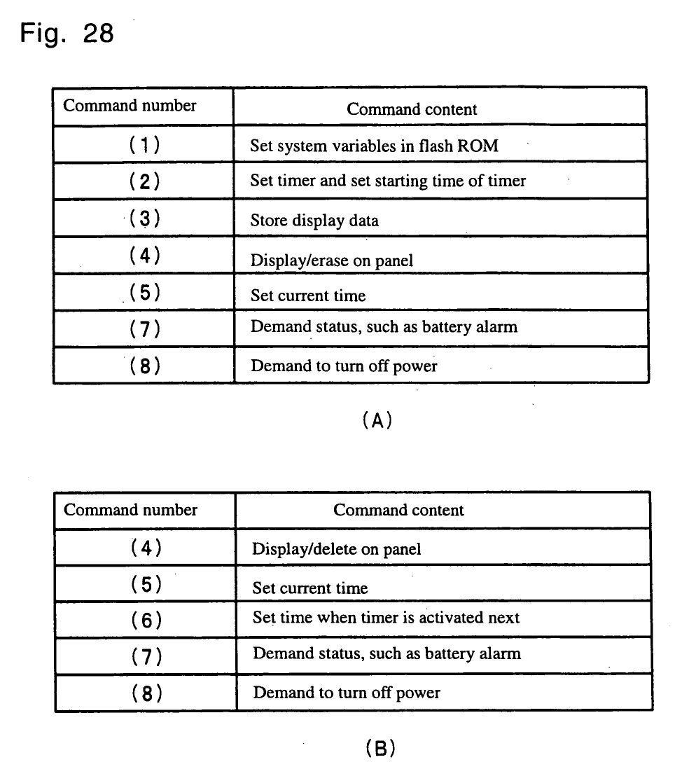

Now, examples of the commands used in this example will be described. FIG. 28(A) shows commands, which are used when the start of the circuit for the main power system 1300 is caused by an output signal from the power switch for the main control unit 1404 or an output from the infrared light transmission circuit 1204. Specifically, the commands that are listed as examples in FIG. 28(A) are provided to the main CPU 1301 from the information distribution server 1040, a USB memory or a CF card.

(1) A command to “set system variables in flash ROM” is a command to set, e.g., the number of the chiral nematic liquid crystal display panels or the number of dots of the panels in the flash ROM. When the main CPU 1301 receives the command in item (1), the data specified by the command are written in the flash ROM in the processing of Step S1029.

(2) A command to “set timers, and set starting times in timers” is a command to activate a timer contained in the clock circuit 1203 included in the sub-CPU 1201 or to set a time-up time in the activated timer. When the main CPU 1301 receives the command in item (2), the main CPU transmits that command to the sub-CPU 1201 in the processing of Step S1029. The sub-CPU 1201 activates the designated timer or sets the designated time-up time in the activated timer in the processing of Step S1009.

(3) A command to “store display data” is a command to store display data in the memory circuit 1303. When the main CPU 1301 receives the command in item (3), the main CPU stores display data in a flash ROM in the memory circuit 1303 in the processing of Step S1029. The command in item (3) is accompanied by the display data.

(4) A command to “display or delete display data” is a command to update information on a chiral nematic liquid crystal display panel with display data stored in the memory circuit 1303 or to erase information on a chiral nematic liquid crystal display panel. When the main CPU 1301 receives the command in item (4), the main CPU not only causes the liquid crystal display panel driving system to be energized but also causes the driving circuit 1408 to update or erase information on a chiral nematic liquid crystal display panel.

(5) A command to “set current time” is a command to reset the current time, based on which the clock circuit included in the sub-CPU 1201 measures. When the main CPU 1301 receives the command in item (5), the main CPU transmits the command to the sub-CPU 1201 in the processing of Step S1029. The sub-CPU 1201 resets the current time for the clock circuit 1203 in the processing of Step S1009. The command in item (5) is accompanied by time data.

(7) A command to “demand status, such as battery alarm” is a command demanding to transmit a status. When the main CPU 1301 receives the command in item (5), the main CPU not only receives detection signals of the temperature sensor 1307 and humidity sensor 1308 from the data acquisition circuit 1306 in the processing of Step S1029 but also enquires a status, such as an alarm status, of the sub-CPU 1201. In response to the enquiry, the sub-CPU 1201 transmits its held status to the main CPU 1301 in the processing of Step S1009. The main CPU 1301 acquires the status and detection values based on the detection signals of the temperature sensor 1307 and the humidity sensor 1308 in the processing of Step S1029. When the main CPU has received a command from a USB memory or a CF card, the main CPU writes the detection values and the status in the USB memory or the CF card. When the main CPU has received a command from the information distribution server 1040, the main CPU transmits the detection values and the status to the information distribution server 1040 through the wide area wireless communication module 1405.

When the information distribution server 1040 has received the respective detection values and the status from the display device 1011, the information distribution server stores the detection values in the memory area allotted for each display device in the database 1041. The detection values stored in the memory area are output from the memory area by a person in charge in the information display provider or the like. In other words, a person in charge in the information display provider or the like may display information on a display portion connected to the information distribution server 1040 or print out information by a printer. If a detection value appears to be an abnormal value, a maintenance person is sent to a place where a relevant display device is installed.

When the detection values and the status have been written in the USB memory or the CF card, a maintenance person or the like, who has plugged the USB memory or the CF card in the display device 1011, unplugs the USB memory or the CF card. He or she plugs the USB memory or the CF card in the wireless terminal unit carried by him or her, and he or she transmits the contents of the USB memory or the CF card to the information distribution server 1040 from the wireless terminal unit. Or, he or she brings back the USB memory or the CF card to a place where the information distribution server 1040 is installed, and he or she inputs the detection values and the status to the information distribution server 1040 from the USB memory or the CF card. Also when the detection values and the status have been input through the USB memory or the CF card, the information distribution server 1040 performs the same processing as a case where the detection values and the status have been received from the display device 1011 via the cellular phone network 1020.

A command to “turn off power” in item (8) shown in FIG. 28(A) is not a command, which is input from the information distribution server 1040, a USB memory or a CF card. This command is independently issued to the sub-CPU 1201 by the main CPU 1301. The processing in connection with the command to “turn off power” in item (8) is performed as already described.

FIG. 28(B) shows commands, which are used when the start of the circuit for the main power system 1300 is caused by receipt of a time-up signal from the clock circuit 1203. When the start is caused by receipt of a time-up signal from the clock circuit 1203, any one of the commands in items (4) to (8) is used. It should be noted that a command to “set time when timer is activated next” in item (6) is a command, which sets a timer at the time when a time-up should be activated after a current time.

When the start is caused by receipt of a time-up signal from the clock circuit 1203, the main CPU 1301 performs processing according to the processing contents stored in the memory circuit 1303 so as to correspond to the causes of time-up. For this reason, the memory circuit 1303 has the processing contents corresponding to the command in items (4) to (7) stored so as to be mapped with the causes of time-up. It should be noted that the phrase “correspond to the causes of time-up” specifically means to correspond to the plural timers in the clock circuit 1203. The command to “turn off power” in item (8) does not need to be stored in the memory circuit 1303 since this command is independently issued by the main CPU 1301.

In this example, when a start is caused by receipt of a time-up signal from the clock circuit 1203, the main CPU 1301 neither read out data from a USB memory or a CF card nor accesses the information distribution server 1040. The main CPU 1301 may be configured to perform such processing. In that case, e.g., a command to “access server” may be defined, and the processing contents corresponding to this command may be stored in the memory circuit 1303.

The commands listed in FIG. 28 are examples, and any other commands may be defined.

When the command, which is acquired in the control corresponding to a command, is a command to “display or delete display data” in item (4), the main CPU 1301 turns on the liquid crystal power supply circuit 1302 (sets the liquid crystal power supply circuit in the energized state to feed power to the driving circuit 1408). When the command to “display or delete display data” demands to “erase”, the driving circuit 1408 is caused to update the display information on a chiral nematic liquid crystal display panel with data for erasure. When the command to “display or delete display data” demands to “display”, the driving circuit 1408 is caused to update the display information on a chiral nematic liquid crystal display panel with relevant display data stored in the memory circuit 1303. Then, the main CPU turns off the liquid crystal power supply circuit 1302 (set the liquid crystal supply circuit in the deenergized state to the energize the driving circuit 1408). When an acquired command is a command other than the command to “display or delete display data”, the main CPU 301 performs the processing as already described, referring to FIG. 28.

By the control stated above, it is possible to use the display device as described below. Specifically, a maintenance person or the like feeds power to a circuit for the main control system 1300 with the main power switch 402 turned on by plugging a USB memory or a CF card with a command stores therein, in the display device 1011 and by depressing the power switch for the main control unit 1404. For a maintenance person or the like feeds power to the circuit for the main power system 1300 by plugging a USB memory or a CF card with a command stored therein, in the display device 1011 and by transmitting a start code to the display device 11 from a unit with the infrared light transmission circuit incorporated therein. Then, the main CPU 1301 is caused to effect control so as to correspond to the command stored in the USB memory or the CF card. In accordance with such use, it is possible to promptly change display information when a change in the display information is suddenly required.

Now, a method for updating the display information on the display device 1011 through the information distribution server 1040 will be described as an example. Description will be made about a case where the terminal unit 1061 is used. When rewriting of the display information on the display device 1011, i.e., when a change in the departure timetable or advertising information is required, a person in charge in the railway company or a person in charge in the advertising company connects the terminal unit 1061 to the information distribution server 1040 via the Internet 1050. Then, the web browser of the terminal unit 1061 downloads a web page for allowing the operator of the terminal unit 1061 to input a change command. The first page is a page for inputting an ID or a password for example. The ID or the password that allows the operation for changing the display information on the display device 1011 has been issued to the operator of the terminal unit 1061. The ID or the password is stored in the information distribution server 1040 so as to correspond to the display device 1011. When a specific ID or a specific password is input in the terminal unit 1061 and when the specific ID or password has transmitted to the information distribution server 1040 from the terminal unit 1061, the operator of the terminal device 1061 is allowed to change the display information on only the specific display device 1011.

The ID or the password may correspond to the plural display devices. For example, a single ID or a single password may be issued to the plural display devices installed in a single station, or a single ID or a single password may be issued to a single railroad company. In these cases, an operator of the terminal unit 1061 can perform operation for changing the display information on the plural display devices.

The web page preparation unit 1612 in the information distribution server 1040 reads out, from the database 1041, the display data with respect to the display device 1011 corresponding to the ID or the password transmitted from the terminal unit 1061. Then, the web page preparation unit prepares a web page containing the read-out display data and transmits the web page to the terminal unit 1061. When a single ID or a single password has been issued to the plural display devices, the web page preparation unit 1612 provides the terminal unit 1061 with a web page for specifying a desired display device, the display information on which the operator wants to amend. The web page preparation unit causes the operator to specify his or her desired display device.

When the operator at the terminal unit 1061 has inputted an updated data in the web page, and when he or she makes an input indicating that he or she affirm the operation, the web browser of the terminal unit 1061 transmits the data indicating a changed portion and the updated data to the information distribution server 1040. In the information distribution server 1040, the data updating unit 1613 receives the data indicating the changed portion and the updated data through the communication control unit 1611 and rewrites the relevant portion in the display data stored in the database 1041, with the updated data. In other words, the data updating portion prepares the amended display data and stores the amended display data in the database 1041.

When the information distribution server 1041 is accessed by the display device 1011 via the cellar phone network 1020, the information distribution server transmits the display data (updated display data) stored in the database 1041 along with the command to “store display data” and the command to “display/delete on panel”, to the display device 1011.

As described above, the circuit for the main power system 1300 in the display device 1011 has started at the time that the information distribution server 1041 transmits the display data to the display device 1011. When the wide area wireless communication module 1405 has transmitted the command to “store display data” in item (3) through the antenna 1108, the main CPU 1301 stores the display data accompanied by the command, in the memory circuit 1303. In other words, the main CPU updates the memory contents of the memory circuit 1303 with the newly received display data. When the main CPU 1301 receives the command to “display/delete on panel”, the main CPU provides the display data to the driving circuit 1408, causing the driving circuit to rewrite the display information on a chiral nematic liquid crystal display panel based on the display data stored in the memory circuit 1303.

As described above, in this example, the display control system provided by the information distribution server 1040 transmits amended display data to the display device 1011 via the cellar phone network 1020 in response to access from the display device 1011. Accordingly, it is possible to easily change the information displayed on the display device 1011 and to reduce the cost required for changing display information. It is also possible to realize a versatile system, which can transmit display data from a single display control system to many display devices.

In the flowchart shown as an example in FIG. 27, when a start is caused by receipt of a time-up signal from the clock circuit 1203, the main CPU 1301 does not perform the processing of accessing the information distribution server 1040. However, it is preferred that when a start is caused by receipt of a time-up signal from the clock circuit 1203, the main CPU may be configured to perform the processing of accessing the information distribution server 1040. In that case, also when a start is caused by receipt of a time-up signal from the clock circuit 1203, the main CPU 1301 performs the processing of Steps S1026 to S1029 in FIG. 27. Then, the display device 1011 can access the information distribution server 1040 regularly (such as once in a day). If updated display data has been stored in the database 1041, the display device can download the updated display data through the information distribution server 1040 to update display information.

Although description has been made about the display device 1011 as an example, the other display devices 1012 to 1015 operate in the same way as the display device 1011 when the display information on the other display devices is updated.

### Example 4

In Example 3, each of the display devices 1011 to 1015 downloads updated display data from the information distribution server 1040. However, the display devices 1011 to 1015 may be configured so that display data, which have been downloaded from the information distribution server 1040 by another display device, are received by that display device by local communication network.

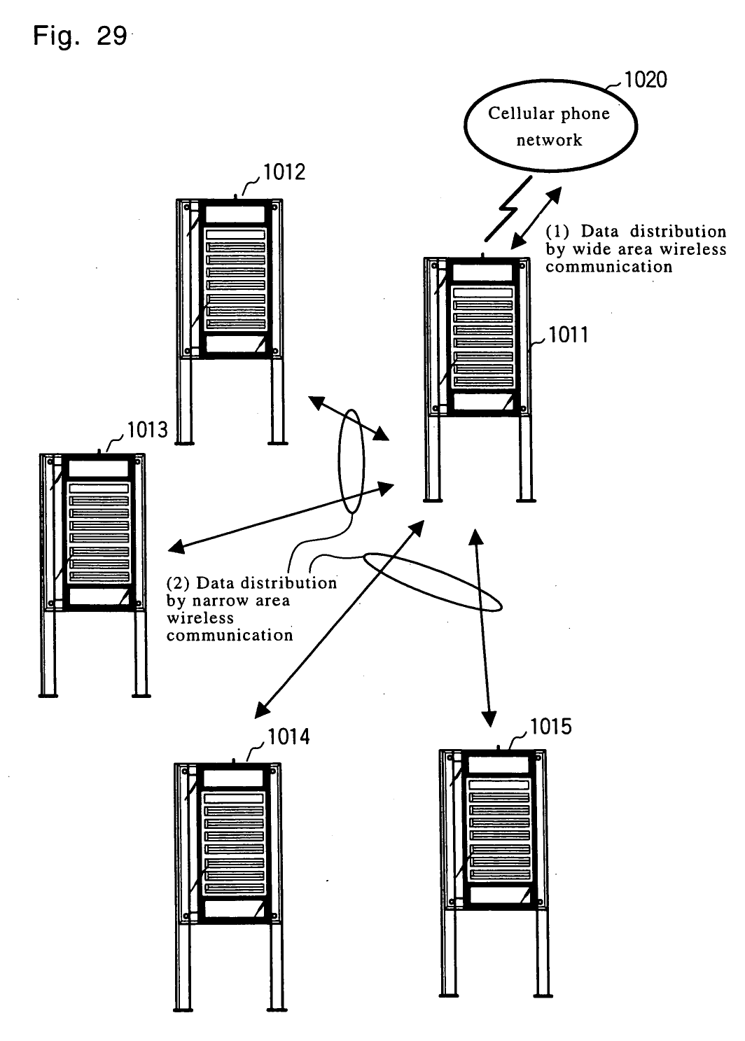

FIG. 29 is a block diagram showing an example of the structure of the information display system according to this example (the second embodiment). Although FIG. 29 shows only the display devices 1011 to 1015 and the cellar phone network 1020, the entire structure of the information display system is the same as the structure shown in FIG. 18. FIG. 29 also shows that the display device 1011 downloads display data from the information distribution 1040 and distributes the display data to the other display devices via local communication network.

The structure of the display device 1011 shown in FIG. 29 may be the same as the structure shown in FIG. 23. The structure of the display devices 1012 to 1015 shown in FIG. 29 is the same as the structure shown in FIG. 23 except that the wide area wireless communication module 1045 and the antenna 1108 are removed.

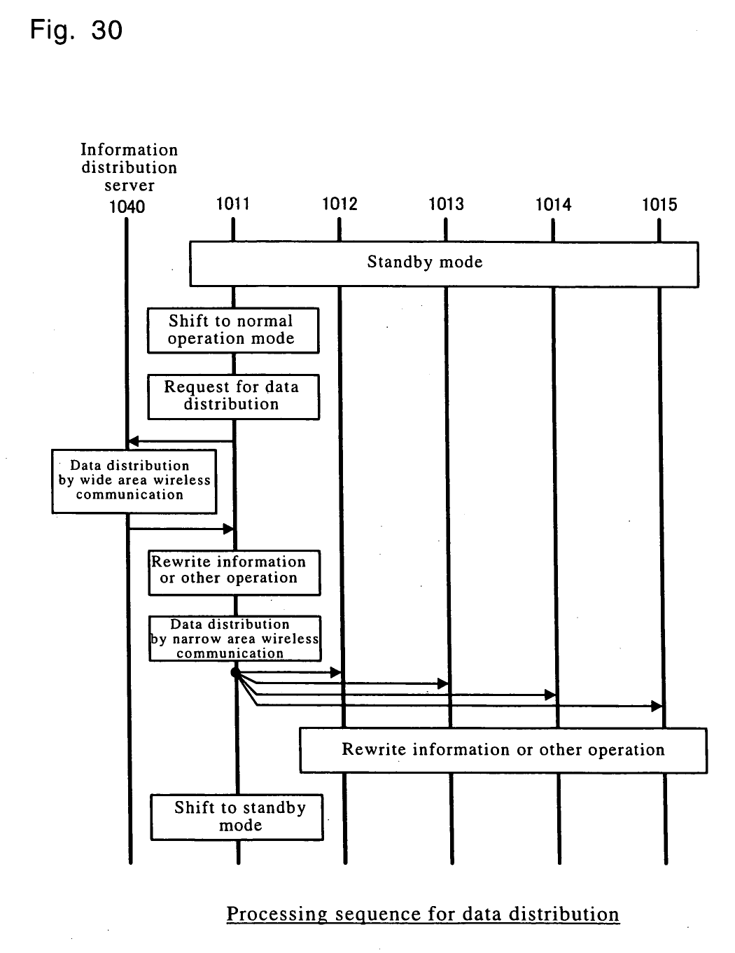

FIG. 30 is a sequence diagram showing the processing wherein the display device 1011 downloads display data from the information distribution server 1040 and distributes the display data to the other display devices via the local communication network. FIG. 30 shows that the circuit for the main power system 1300 in the display device 1011 among the display devices 1011 to 1015 in a standby mode is started and that the display device 1011 has sifted to the normal operation mode. The circuit for the main power system 1300 in the display device 1011 is started based on a time-up signal from the clock circuit 1203 for example.

The main CPU 1301 in the display device 1011 commands the wide area wireless communication module 1405 to access the information distribution server 1040. In response to the command, the wide area wireless communication module 1405 communicate with a base station through the antenna 1108 to acquire a command stored in the information distribution server 1040 via the cellar phone network 1020. In other words, the main CPU 1301 requests the information distribution server 1040 to distribute data. This processing is the same as the processing of Step S1026 in Example 3 (see FIG. 27).

FIG. 30 shows, as an example, a case where the wide area wireless communication module 1045 in the display device 1011 has received display data, a command to “store display data” and a command to “display/delete on panel” from the information distribution server 1040 through the antenna 1108. The main CPU 1301 in the display device 1011 causes the memory circuit 1303 to store the display data accompanying the respective commands. The main CPU 1301 also provides display data to the driving circuit 1408 to rewrite the display information on a chiral nematic liquid crystal display panel based on the display data stored in the memory circuit 1303.

Then, the main CPU 1301 demands the narrow area wireless communication module 1406 to transmit the display data, the command to “store display data” and the command to “display/delete on panel” to the other display devices 1012 to 1015. The narrow area wireless communication module 1406 transmits the display data, the command to “store display data” and the command to “display/delete on panel” to the other display devices 1012 to 1015 through the antenna 1407.

When the narrow area wireless communication module 1406 in each of the other display devices 1012 to 1015 has received the commands and the like from the narrow area wireless communication module 1406 in the display device 1011, the narrow area wireless communication module outputs a command signal to the sub-CPU 1201 to set the power supply circuit 1202 in the energized state. In response to the command signal, the sub-CPU 1201 sets the power supply circuit 1202 in the energized state is The narrow area wireless communication module 1406 in each of the display devices 1012 to 1015 provides the main CPU 1301 with the display data, the command to “store display data” and the command to “display/delete on panel” received from the display device 1011. The main CPU 1301 in each of the display devices 1012 to 1015 causes the memory circuit 1303 to store the display data accompanying the command to “store display data” and the command to “display/delete on panel”. The main CPU 1301 also provides the display data to the driving circuit 1408 to rewrite the display information on a chiral nematic liquid crystal display panel based on the display data stored in the memory circuit 1303.

After that, the main CPU 1301 in the display device 1011 provides the sub-CPU 1201 with a command to turn off power. In response to the command to turn off power, the sub-CPU 1201 turns off the power supply circuit 1202 (sets the power supply circuit in the deenergized state). As a result, the display device 1011 returns to the standby mode. The main CPU 1301 in each of display devices 1012 to 1015 also provides the sub-CPU 1202 with a command to turn off power.

In this example, it is sufficient that there is only one display device capable of performing wide area wireless communication in the system and that the other display devices have no ability to perform wide area wireless communication. Accordingly, it is possible to reduce the costs required for the display devices 1012 to 1015. In this example, it is possible to reduce the power required for the display devices 1012 to 1015 in comparison with Example 3 since the power required for narrow area wireless communication is generally lower than the power required for wide area wireless communication.

In this example, it is sufficient that the display devices 1012 to 1015 are communicable with at least the display device 1011 via wide area wireless communication network. Although explanation of this example has been made about a case where there is only one display device capable of performing wide area wireless communication in the system, this type of display device may be installed at plural locations. Even when each of the display devices 1011 to 1015 is configured to be capable of performing wide area communication, i.e., even when each of display devices includes the wide area wireless communication module 1405, it is possible to perform the processing according to this example shown in FIG. 30. In other words, it is possible to perform the processing according to this example shown in FIG. 30 even by the system structure of Example 3.

### Example 5

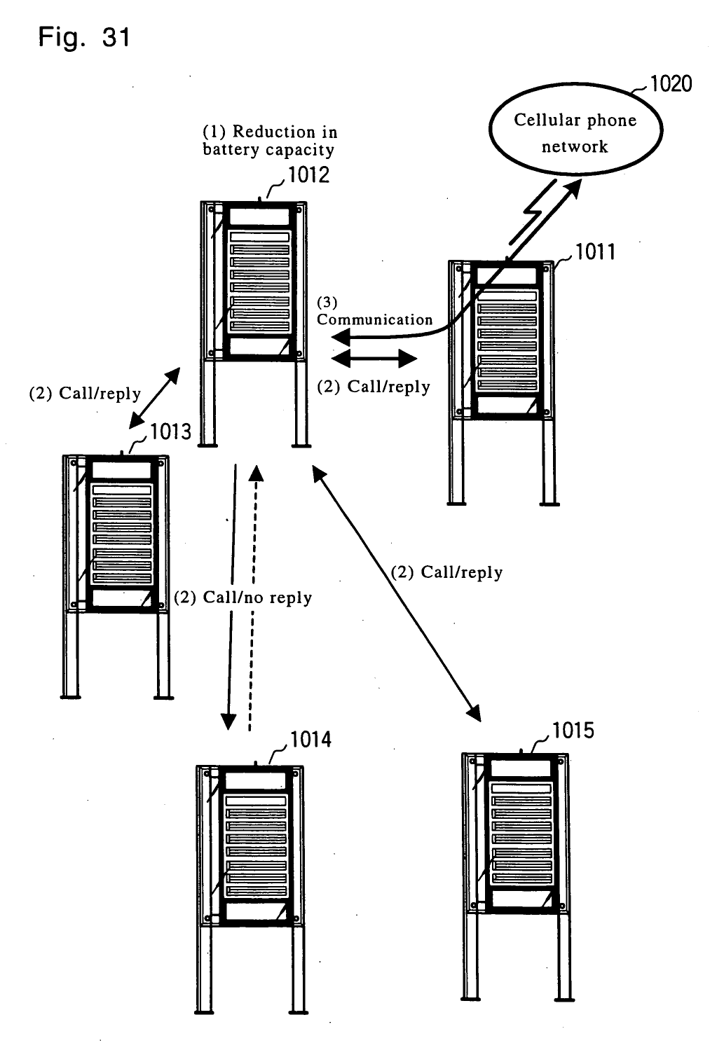

FIG. 31 is a block diagram showing an example of the structure of the information display system according to Example 5. Although FIG. 31 shows only the display devices 1011 to 1015 and the cellar phone network 1020, the entire structure of the information display system is the same as the structure shown in FIG. 18. FIG. 31 also shows that an abnormal situation (specifically, a drop in battery capacity) has occurred in the display device 1012. It is also shown that in order to notify the information distribution server 1040 of the occurrence of the abnormal situation, the display device 1012 has used the narrow area wireless communication network attempting to find out a display device communicable with the information distribution server 1040. It is also shown that the display device 1011, which is communicable with the information distribution server 1040, has used the wide area wireless communication network to notify the information distribution server 1040 that the abnormal situation has occurred in the display device 1012.

The display device 1011 shown in FIG. 31 may have the structure of the display device shown in FIG. 23. The structure of each of the display devices 1012 to 1015 shown in FIG. 31 has the same structure as the structure of the display device shown in FIG. 23 except that the wide area wireless communication module 1405 and the antenna 1108 are removed.

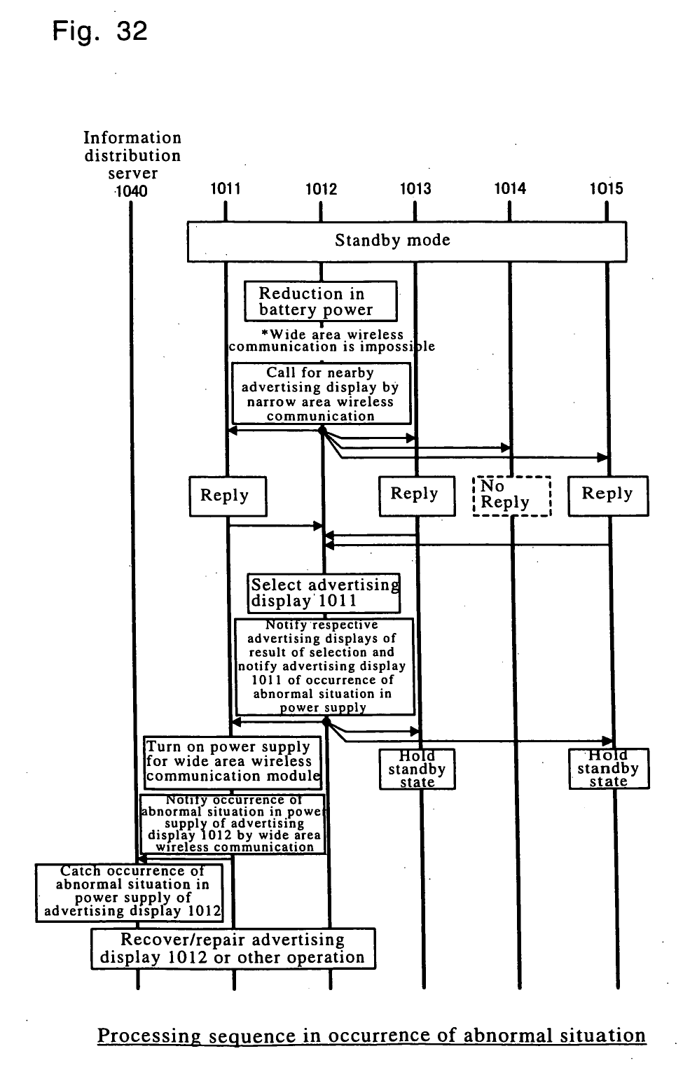

FIG. 32 is a sequence diagram showing an example of the processing wherein the display device 1012 uses the narrow area wireless communication network to find out a display device communicable with the information distribution server 1040 and also an example of the processing wherein the display device 1011 uses the wide area wireless communication network to notify the information distribution server 1040 of the occurrence of the abnormal situation in the display device 1012.

In the display device 1012, the voltage sensor 1403 outputs an alarm signal, e.g., when the output voltage of the secondary cells 1401 has lowered to a predetermined voltage. When the voltage sensor 1403 has output such an alarm signal, the sub-CPU 1201 sets the power supply circuit 1202 in the energized state. The sub-CPU 1201 holds an alarm status indicating that the value of the output voltage of the secondary cells 1401 has lowered.

After that, the main CPU 1301 asks the sub-CPU 1201 about why a start is caused. In this example, the sub-CPU 1201 provides the main CPU 1301 with a data, which indicates that the start is caused by output of an alarm signal from the voltage sensor 1403, i.e., there is a possibility that the battery capacity lowers (a reduction in the battery capacity).

In this example, when the main CPU 1301 receives a data indicating a reduction in the battery capacity, the main CPU commands the narrow area wireless communication module 1406 to ask the other display devices 1011 and 1013 to 1015 whether or not to be capable of performing wide area wireless communication. In response to the command, the narrow area wireless communication module 1406 transmits, through the antenna 1407, a command to the other display devices 1011 and 1013 to 1015, asking whether or not to be capable of performing wide area wireless communication. In other words, the narrow area wireless communication module calls for the other display devices 1011 and 1013 to 1015. FIG. 32 shows, as an example, that the narrow wireless communication module 1406 in the display device 1012 transmits the command to the other display devices locating in the neighborhood thereof. The display devices 1011 and 1013 to 1015 are the display devices locating in the neighborhood of the display device 1012.

In each of the display devices 1011 and 1013 to 1015, when the narrow area wireless communication module 1406 has received the command, the sub-CPU 1201 is provided with a command signal to set the power supply circuit 1202 in the energized state. In response to the command signal, the sub-CPU 1201 sets the power supply circuit 1201 in the energized state. However, in the display device 1011, the power supply circuit 1202 does not start supplying power to the wide area wireless communication module 1405. Then, the narrow area wireless communication module 1406 in each of the display devices 1011 and 1013 to 1015 provides the main CPU 1301 with the command received from the display device 1012.

The display device 1011 is capable of performing wide area wireless communication. The main CPU 1301 in the display device 1011 provides the narrow area wireless communication module 1406 with a data indicating that the display device 1011 is communicable with wide area wireless communication. The narrow area wireless communication module 1406 transmits a data to the display device 1012. In FIG. 32, it is shown that the transmission of the data indicating that the display device 1011 is capable of performing wide area wireless communication is indicated as “Reply”.

Each of the display devices 1013 to 1015 is not capable of performing wide area wireless communication. The main CPU 1301 in each of display devices 1013 to 1015 provides the narrow area wireless communication module 1406 with a data indicating that it is impossible to perform wide area wireless communication. The narrow area wireless communication module 1406 transmits the data to the display device 1012. However, FIG. 32 shows a case where the display device 1014 has sent no reply for some reason.

In the display device 1012, the narrow area wireless communication module 1406 provides the main CPU 1301 with the data received from the display devices 1011, 1013 and 1015. The main CPU 1301 selects the display device 1011 based on the data input from the narrow area wireless communication module 1406. In other words, the main CPU 1301 recognizes that the display device 1011 is capable of performing wide area wireless communication. Accordingly, the main CPU commands the narrow area wireless communication module 1406 to provide the display devices 1011, 1013 and 1015 with a data indicating that the display device 1011 has been selected. In response to the command, the narrow area wireless communication module 1406 transmits the data to the display devices 1011, 1013 and 1015. The main CPU 1301 receives the alarm status from the sub-CPU 1201. Then, the main CPU commands to the narrow area wireless communication module 1406 to transmit the alarm status to the display device 1011. In response to the command, the narrow area wireless communication module 1406 transmits the alarm status to the display devices 1011.

In the display device 1011, when the narrow area wireless communication module 1406 has received the alarm status, the narrow area wireless communication module requests the sub-CPU 1201 to start power supply to the wide area wireless communication module 1405. In response the request, the sub-CPU 1201 causes the power supply circuit 1201 to start power supply to the wide area wireless communication module 1405. The sub-CPU 1201 also provides the main CPU 1301 with the alarm status received from the display device 1012.

In the display device 1011, the main CPU 1301 commands the wide area wireless communication module 1405 to access the information distribution server 1040 in order to transmit the alarm status of the display device 1012 to the information distribution server. In response the command, the wide area wireless communication module 1405 communicates with a base station through the antenna 1108 to transmit the alarm status of the display device 1012 to the information distribution server 1040 via the cellular phone network 1020.

When the information distribution server 1040 has received the alarm status of the display device 1012, the information distribution server stores the received alarm status in the memory area allotted to the display device 1012 in the database 1041. The alarm status stored in the memory area is output from the memory area by a person in charge in the information display provider or the like. In other words, the person in charge in the information display provider or the like displays the relevant information on a display portion connected to the information distribution server 1040 or prints out relevant information by a printer. According to the output alarm status, a maintenance person is sent to the place where the display device 1012 is installed. The maintenance person recovers or repairs the power system of the display device 1012.

In each of the display devices 1013 and 1015, the narrow area wireless communication module 1406 is supposed to receive, from the display device 1012, a data indicating that the relevant display device has not been selected. The narrow area wireless communication module 1406 notifies the sub-CPU 1201 that the relevant display device has not been selected. The sub-CPU 1201, which has notified of it, holds the standby mode for the relevant display device.

As described above, the display device 1012 can transmit the alarm status to the information distribution server 1040 even without having a function of performing wide area wireless communication.

Although description has been made about a case where the data to be transmitted to the information distribution server 1040 by the display device 1011 is the alarm status, the alarm status is one example, and the data to be transmitted to the information distribution server is not limited to the alarm status. Other data (status information), which can be controlled by the display devices 1012 to 1015, may be transmitted to the information distribution server 1040 by the display device 1011.

In this example, it is sufficient that there is a only one display device capable of performing wide area wireless communication in the system and that the other display devices cannot perform wide area wireless communication. In this example, it is possible to reduce the power required for the display devices 1012 to 1015 in comparison with Example 3 since the power required for narrow area wireless communication is generally lower than the power required for wide area wireless communication.

Although explanation of Example 4 has been made about a case where there is only one display device capable of performing wide area wireless communication in the system, this type of system may be installed at plural locations. Even when each of the display devices 1011 to 1015 is configured to be capable of wide area communication, i.e., even when each of the display devices includes the wide area wireless communication module 1405, it is possible to perform the processing shown in FIG. 32.

The present invention can be appropriately applied to such a case that information is provided to many persons or persons in a distant place by display devices, or information displayed in display devices is changed from time to time.

The display devices are not limited to display devices to display a departure timetable and advertising information. For example, the display devices are not limited to be installed in stations of a railroad company, and the display devices may be used to display information, such as the departure and arrival times for vehicles in transportation, or advertising information in an airport or a harbor. The present invention is also applicable to a display device displaying only a departure timetable or a display device displaying only advertising information. The present invention can be applied not only to the display devices 1011 to 1015 installed in stations but also a display device, which is installed in an airport, a general building, a hotel, a hospital, a plaza, an exhibition hall, a wedding center, an amusement park or the like.

The present invention is also applicable to display product information at a gas station (a refueling point for transportation), a department store, a convenience store, a restaurant or the like. The present invention is also applicable to display various kinds of guidance information or serves information or the like at a hotel, a hospital, a serves company such as a financial institution, an administrative institution, a school, a ceremonial hall, a game arcade or the like.

The present invention is also applicable to display notification or entertainment information at an exhibition hall, a convention hall, a museum, an art museum, a theater, a film theater, a concert hall, a library, a company or the like.

The present invention is also applicable to a display device, which is installed at an outdoor place, such as a park or a road, to convey information, such as advertising information or warning information, to the general public.

As described above, the information display system according to the present invention can be used not only in the application of a timetable but also in an application where information is visually conveyed to plural persons and display information is changed from time to time.

Although the display devices are configured so as to have specific information visually recognized by an unspecified number of the general public in each of the above-mentioned embodiments, the display devices may be configured to provide information to the target users that have been prespecified.

Although explanation of each of the above-mentioned embodiments has been made a case where the wide area wireless communication network, which serves as a transmission channel in communication between a display device and the other display devices existing away therefrom, comprises a cellar phone network, the wide area wireless communication network may be a different wireless communication network from a cellar phone network as long as the display devices can access the information distribution server 1040 by wireless communication.

What is claimed is:

1. A display device comprising a power supply unit, a display panel having a memory effect, a driving circuit for driving the display panel, an interface unit for acquiring a command and a display data input from outside, a main control unit for activating the driving circuit based on the command and the display data acquired by the interface unit, and a power supply control unit for controlling power supply from the power supply unit to the driving circuit;
wherein the power supply control unit
(a) starts power supply from the power supply unit to the driving circuit when the driving circuit rewrites display information on the display panel, and
(b) stops power supply from the power supply unit to the driving circuit after the display information on the display panel has been updated.

2. The display device according to claim 1, wherein the power supply unit includes a secondary cell and a solar cell for charging the secondary cell.

3. The display device according to claim 1 or 2, wherein the interface unit includes a local interface unit for reading out a data from a memory medium and a wireless communication interface unit for receiving the command and the display data via a wireless transmission channel.

4. The display device according to any one of claims 1 to 3, wherein the power supply control unit includes a timer circuit, which outputs a signal demanding to start power supply to the main control unit when reaching a preset time-up time or when receiving a start code by infrared light communication.

5. The display device according to any one of claims 1 to 4, wherein the display panel comprises a chiral nematic liquid crystal display panel.

6. The display device according to any one of claims 1 to 5, wherein the display data comprise a data relating to a timetable for transportation.

7. The display device according to any one of claims 1 to 6, wherein the display panel comprises plural display panels, which are connected to one another in series.

8. A display device comprising a power supply unit, a display panel having a memory effect, a driving circuit for driving the display panel, a first wireless communication unit for performing communication of a command and a display data via a first wireless communication network, a second wireless communication unit for performing communication of a command and a display data via a second wireless communication network, a main power supply control unit for activating the driving circuit based on the command and the display data received by the first and/or second wireless communication unit, and a sub-power supply control unit for controlling power supply from the power supply unit to the respective units;
wherein the sub-power supply control unit is constantly powered on and supplies power or stop power supply to the first and/or second wireless communication unit according to an operation mode.

9. The display device according to claim 8, wherein the first wireless communication unit has a higher output than the second wireless communication unit.

10. The display device according to claim 8 or 9, wherein the operation mode includes:
(a) a normal operation mode wherein the display panel, the driving circuit, the main power supply control unit, and the first and second wireless communication units are powered on;
(b) a standby mode wherein the display panel, the driving circuit, the main power supply control unit, and the first wireless communication unit are powered off while the second wireless communication unit is powered on; and
(c) a narrow area communication mode wherein the 20 display panel, the driving circuit and the first wireless communication unit are powered off while the main power supply control circuit and the second wireless communication unit are powered on.

11. An information display system comprising display devices defined in any of claims 8 to 10 and an information distribution server for distributing a command and a display data to the display devices via the first wireless communication network;
wherein a first display device can communicate with a second display device through the second wireless communication network to realize communication with the information distribution server through the second display device when being difficult to communicate with the information distribution server via the first wireless communication network.
